(19) United States
(12) Patent Application Publication
(10) Pub. No.: US 2024/0202089 A1
(43) Pub. Date: Jun. 20, 2024

(54) GENERATING AND STORING AGGREGATED METRICS FOR DIFFERENT AGGREGATION GRANULARITIES FOR DIFFERENT PERIODS OF TIME FOR MONITORING OF NETWORK ELEMENTS OF A SOFTWARE-DEFINED NETWORK

(71) Applicant: VMware LLC, Palo Alto, CA (US)

(72) Inventors: Minjal Agarwal, Santa Clara, CA (US); Shivraj Shahajirao Sonawane, Pune (IN); Ashutosh Gupta, San Jose, CA (US); Ranganathan Rajagopalan, Fremont, CA (US); Rajiv Mordani, Fremont, CA (US)

(21) Appl. No.: 18/378,476

(22) Filed: Oct. 10, 2023

(30) Foreign Application Priority Data
Dec. 15, 2022 (IN) 202241072696
Dec. 15, 2022 (IN) 202241072697
Dec. 15, 2022 (IN) 202241072698

(51) Int. Cl. G06F 11/30; G06F 9/455; G06F 11/32

(52) U.S. Cl. CPC G06F 11/3006; G06F 9/45558; G06F 11/324; G06F 2009/45595

(57) ABSTRACT

Some embodiments provide a novel method of presenting operational data from several network elements in a software-defined network (SDN). An operational data aggregator of the SDN receives a first request to view metric data for a first time period prior to a current time. The operational data aggregator presents the a first group of sets of aggregated metrics created for the first time period. The operational data aggregator also receives a second request to view metric data for a second time period prior to the current time. The operational data aggregator presents a second group of sets of aggregated metrics created for the second time period. The first group of sets of aggregated metrics has at least one aggregated metric set that is at a different aggregation granularity than all other sets of aggregated metrics in the second group of sets of aggregated metrics.

### BACKGROUND

An edge gateway segregates an internal network from an external network. Edge gateways are often implemented as hardware appliances using application specific integrated circuits (ASICs) or as software appliances executing on computers with commodity central processing units (CPUs). As the edge gateway serves as the ingress and egress node of a network to let traffic in and out of the network, monitoring the edge gateway's health is critical. For instance, it is critical to monitor the CPU usage of an edge gateway to ensure that the edge gateway does not get overloaded with traffic (which can lead to the edge gateway dropping traffic).

In some cases, edges execute on host computers along with virtual machines (VMs) that perform edge services. These edges are implemented by machines executing on these host computers. To monitor the health of these edges, the health of the machines implementing the edges are monitored. Health of other network elements can also be monitored to ensure that these network elements and the overall network are performing optimally. Hence, methods and systems are needed for collecting and storing operational data for network elements of a network in order to monitor the health of the network elements.

### BRIEF SUMMARY

Some embodiments provide a novel method of providing operational data for network elements in a software-defined network (SDN). The method deploys a framework for collecting operational data for a set of network elements in the SDN. The framework of some embodiments includes an interface for different client applications to use in order to configure the framework to collect and aggregate the operational data based on different collection and aggregation criteria that satisfies different requirements of the different client applications. The method also deploys data collectors in the SDN that the framework configures to collect operational data from the set of network elements in the SDN.

In different embodiments, the different collection and aggregation criteria includes (1) different collection criteria for collecting different types of operational data for the different client applications, (2) different aggregation criteria for aggregating the operational data differently for the different client applications, (3) different storage criteria for storing aggregated operational data for the different client applications, or (4) a combination thereof. For example, the framework can allow different client applications to only specify different aggregation criteria. Alternatively, the framework can allow the different client applications to specify both different aggregation criteria and different storage criteria. In some embodiments, collection, aggregation, and/or storing criteria is the same for all client applications, meaning that client applications cannot specify different criteria for each of collecting, aggregating, and storing. For example, the framework can allow different client applications to specify different collection and aggregation criteria, but aggregated operational data for each client application is stored according to a same set of storing criteria.

Different collection criteria can include different types of operational data to collect for different network elements in the SDN. For instance, while a particular metric type is required for collecting for a first client application, it may not be required for a second client application. Hence, the first client application would have requirements to collect metrics of that particular type, while the second client application would not require that metrics of that particular type be collected for it. Different aggregation criteria can include different ways or methods of aggregating collected operational data. For example, one client application can require that all metrics be averaged over a specific time period, while a different client application can require that all metrics are taken to be the maximum value of that metric over a specific period of time (e.g., of three metrics collected during a particular time period are valued at 20, 30, and 50, the aggregated metric for these three values would be 50 since the requirements require using the maximum value). different storage criteria can include different time periods for storing different aggregation levels of operational data, or different databases for storing different aggregation levels of operational data. For example, a first client application can require that three particular aggregation levels of the operational data are stored for three particular time periods, while a second client application can require that the same three particular aggregation levels of operational data be stored for three different particular time periods than required by the first client application.

In some embodiments, a client application can include several application instances that implement the client application. Requirements of the different client applications in some embodiments includes functional requirements (also referred to as operational requirements) of the different client applications. In some embodiments, the set of network elements is a set of managed network elements that is managed by at least one of a set of network managers and a set of network controllers of the SDN. These network managers and network controllers can manage and control the entire SDN and its network elements. The set of managed network elements in some embodiments includes at least one of managed software network elements executing on host computers and managed hardware network elements in the SDN. For example, the set of network elements can include logical forwarding elements (LFEs) implemented on host computers, software physical forwarding elements (PFEs) implemented on host computers, and/or hardware standalone PFEs (e.g., edge devices or appliances) in the SDN. In some embodiments, the data collectors are deployed as plugins on the host computers and hardware PFEs in the SDN.

The interface of some embodiments includes a parser for receiving collection and aggregation criteria for each client application and a translator for translating the collection and aggregation criteria for each client application into a set of collection and aggregation rules for each client application. The parser can receive different criteria from different client applications specified in intent-based Application Programming Interface (API) requests which are then parsed. Once parsed and the criteria has been extracted, the translator can translate the criteria into rules that the framework can use to collect, aggregate, and store operational data for the different client applications. In some embodiments, the framework further includes a storage for storing each set of collection and aggregation rules created for each client application.

In some embodiments, the framework includes a volatile memory for storing the collected operational data until the collected operational data has been aggregated, and at least one non-volatile (i.e., stable) time-series database (TSDB) for storing aggregated operational data. Once collected raw operational data has been aggregated, it can be deleted from the volatile memory. Storing only aggregated operational data in the non-volatile TSDB allows for efficiently using the space of the TSDB. In some embodiments, all aggregated operational data for all client applications is stored in a single TSSB. In such embodiments, the TSDB can be organized such that each aggregation level of operational data for each client application is stored in its own separate table. In other embodiments, different aggregated operational data for different client applications is stored in different TSDBs.

Some embodiments provide a novel method of storing operational data for network elements in an SDN. At metrics manager of a framework for collecting, aggregating, and storing the operational data for the SDN, the method receives, during a particular time period, a primary set of metrics collected from at least one SDN network element, and stores the first set of metrics in a volatile memory. The metrics manager uses a set of aggregation rules to aggregate the primary set of metrics into a secondary set of aggregated metrics. The metrics manager stores the secondary set of aggregated metrics in a non-volatile memory to use to monitor performance of the at least one SDN network element.

The non-volatile memory is in some embodiments a TSDB of the framework. The volatile memory is a local memory of the framework used for storing the primary metrics rather than storing them in the TSDB. In some embodiments, the receiving and using operations are performed in order to store different primary sets of metrics and to store different secondary sets of aggregated metrics.

In some embodiments, the particular set of aggregation rules is received from an interface of the framework that defines the particular set of aggregation rules from a particular set of aggregation criteria for a particular client application. As discussed previously, an API request can be sent to a data consumer interface specifying the aggregation criteria, and a parser and translator can parse the API request to extract the aggregation criteria and translate it into the aggregation rules. These aggregation rules are used by the metrics managers of the framework. In some embodiments, the translator sends the aggregation rules directly to the metrics managers. In other embodiments, the translator stores the aggregation rules in a database, and the metrics managers retrieve any aggregation rules it needs to aggregate metrics.

The metrics manager of some embodiments receives the primary set of metrics from a set of one or more metrics collectors operating on at least one of host computers and edge devices in the SDN. As discussed previously, a metrics collector may be deployed as a plugin on each host computer and/or each hardware physical forwarding element (e.g., an edge device) in the SDN to collect metrics for the host computer or edge device on which it is deployed. In some embodiments, a first subset of the primary set of metrics is received from a first metrics collector and a second subset of the primary set of metrics is received from a second metrics collector. This first metrics collector may operate on a particular host computer while the second metrics collector operates on a particular edge device. In other embodiments, the primary set of metrics is entirely received from a particular metrics collector operating on either a host computer or an edge device.

In some embodiments, the secondary set of aggregated metrics is smaller than the primary set of metrics such that the primary set of metrics is aggregated into the secondary set of aggregated metrics in order to efficiently store metrics for the at least one SDN network element in the non-volatile memory. By storing a smaller set of metrics in the non-volatile memory, space is saved in the memory and the framework works more efficiently.

The time periods for which primary metrics are received and stored in the volatile memory are specified in the aggregation rules. For example, a particular time period specified in a particular set of aggregation rules can specify how long the metrics manager is to store the primary metrics in the volatile memory and how long the metrics manager is to wait to aggregate the metrics according to the aggregation rules. In some embodiments, the particular time period is a first time period, and the particular set of aggregation rules also specifies a second time period. In such embodiments, the metrics manager stores the secondary set of aggregated metrics in the non-volatile memory for the second time period. After the second time period, the metrics manager uses the particular set of aggregation rules to aggregate the secondary set of aggregated metrics into a tertiary set of aggregated metrics and stores the tertiary set of aggregated metrics in the non-volatile memory.

In some embodiments, the metrics manager deletes the secondary set of aggregated metrics from the non-volatile memory after aggregating the secondary set of aggregated metrics into the tertiary set of aggregated metrics. Because the tertiary set of aggregated metrics is based on the secondary set of aggregated metrics, the secondary set of aggregated metrics in some embodiments is not always necessary to store after storing the tertiary set of aggregated metrics. Hence, the secondary set of aggregated metrics can be deleted from the non-volatile memory. However, in other embodiments, the metrics manager stores the secondary set of aggregated metrics in the non-volatile memory even after storing the tertiary set of aggregated metrics in the non-volatile memory. In these embodiments, the particular set of aggregation rules specifies that some or all aggregation levels of metrics (i.e., both the secondary and tertiary sets of aggregated metrics) are to be stored, so that the metrics manager does not delete the secondary set of aggregated metrics from the non-volatile memory.

The secondary set of aggregated metrics (and, in some embodiments, the tertiary set of aggregated metrics) is stored in the non-volatile memory for use by a user to view in a UI in order to monitor the performance of the at least one SDN network element. As discussed previously, a user can request to view metrics in a UI in order to analyze the metrics and monitor the performance of the at least one SDN network element.

Some embodiments provide a novel method of presenting operational data from several network elements in an SDN. An operational data aggregator of the SDN receives a first request to view metric data for a first time period prior to a current time. The operational data aggregator presents the a first group of sets of aggregated metrics created for the first time period. The operational data aggregator also receives a second request to view metric data for a second time period prior to the current time. The operational data aggregator presents a second group of sets of aggregated metrics created for the second time period. The first group of sets of aggregated metrics has at least one aggregated metric set that is at a different aggregation granularity than all other sets of aggregated metrics in the second group of sets of aggregated metrics.

In some embodiments, before the receiving and presentation operations, the operational data aggregator presents a set of one or more time controls in a UI to allow a user to specify a time period for which the user requests to view the metric data. In such embodiments, presenting the first group of sets of aggregated metrics includes presenting the first group of sets of aggregated metrics after the user specifies the first time period using the set of time controls. Presenting the second group of sets of aggregated metrics then also includes presenting the second group of sets of aggregated metrics after the user specifies the second time period using the set of time controls. For example, the UI can present a time control or filter for the user, and the user can specify to view metrics for the previous week. Each set of aggregated metrics that is associated with the previous week is then presented in the UI by the operational data aggregator.

Presenting the first group of sets of aggregated metrics in some embodiments includes first presenting one selectable control for each set of aggregated metrics in the first group of sets of aggregated metrics. In such embodiments, a user's selection of any particular selectable control for any particular set of aggregated metrics in the first group of sets of aggregated metrics results in presenting operational data for the particular set of aggregated metrics. For instance, the UI can present a selectable control for each aggregated metric set in order for the user to select which set the user wishes to view operational data. Upon selection of any of those selectable controls, the UI can present the selected operational data.

In some embodiments, the first and second requests are received successively, and the first and second time periods are defined by reference to current times at which the first and second requests are received. For example, the first and second requests can be received within one hour of each other. The first time period can specify a one month period from the current time at which the first request is received, and the second time period specifies a one week period from the current time at which the second request is received. So, when the first request is received at the top of that hour window, the user requesting to view metrics within the previous month will be presented with any aggregated metric sets for the previous month currently stored at the time the user made the first request.

When the second request is received at the bottom of that hour window, the user requesting to view metrics within the previous week will be presented with any aggregated metric sets for the previous week currently stored at the time the user made the second request. During that one hour window, some aggregated metric sets from the last week may have been deleted from storage because some embodiments store metrics for different lengths of time based on their aggregation granularity. Hence, the time at which the user makes the request and the time period for which the user is requesting metrics are both important for which sets of aggregated metrics are going to be presented to the user.

The operational data aggregator of the SDN of some embodiments includes (1) a metrics query server for receiving the first and second requests and presenting the first and second groups of sets of aggregated metrics, and (2) a set of one or more metrics managers for creating different sets of aggregated metrics based on each other and based on raw metric data collected for the plurality of network elements in the SDN. In some embodiments, the raw metric data is collected by a set of one or more metrics collectors operating on at least one of host computers and edge devices in the SDN.

At least a subset of the raw metric data is collected periodically (i.e., using a pull model) such that for a first metric type for a particular network element, a new raw metric of the first metric type is collected by a particular metrics collector for the particular network element at regular intervals. Another method for collecting metrics can be a push model. For instance, for a second metric type for the particular network element, the particular metrics collector receives a new raw metric of the second metric type each time the second metric type for the particular network element changes in value. In some embodiments, the particular network element is a particular edge device of the SDN, and the particular metrics collector operates on the particular edge device to collect the raw metric data associated with the particular edge device.

The first and second groups of sets of aggregated metrics in some embodiments are stored in a TSDB such that different sets of aggregated metrics aggregated at different aggregation granularities are stored in the TSDB for different lengths of time according to their aggregation granularity. For example, first aggregation-level metrics can be stored for a first length of time, while second aggregation-level metrics are stored for a longer, second length of time. At least a subset of the first and second sets of aggregated metrics is aggregated from collected raw metric data, and the raw metric data is alternatively stored in a volatile memory separate from the TSDB. Not storing raw metrics in the non-volatile TSDB uses the space of the TSDB more efficiently than if the raw metrics were also stored in the TSDB.

In some embodiments, different sets of aggregated metrics in the first and second groups of sets of aggregated metrics are stored in different TSDBs according to their aggregation granularity. For example, first aggregation-level metrics can be stored in a first TSDB, while second aggregation-level metrics are stored in a different, second TSDB. This may be done for organization of the aggregated metrics. In other embodiments, if all aggregated metrics are stored in one TSDB, each aggregation level can have a separate table in the TSDB for organization and easier deletion of each aggregation level.

The preceding Summary is intended to serve as a brief introduction to some embodiments of the invention. It is not meant to be an introduction or overview of all inventive subject matter disclosed in this document. The Detailed Description that follows and the Drawings that are referred to in the Detailed Description will further describe the embodiments described in the Summary as well as other embodiments. Accordingly, to understand all the embodiments described by this document, a full review of the Summary, Detailed Description, the Drawings, and the Claims is needed. Moreover, the claimed subject matters are not to be limited by the illustrative details in the Summary, Detailed Description, and Drawings.

### BRIEF DESCRIPTION OF THE DRAWINGS

The novel features of the invention are set forth in the appended claims. However, for purposes of explanation, several embodiments of the invention are set forth in the following figures.

FIG. 1 illustrates an example SMN for which some embodiments of the invention are implemented.

FIG. 2 illustrates another example SMN for which some embodiments of the invention are implemented.

FIG. 3 illustrates an example configuration of a management plane, a control plane, and a data plane.

FIG. 4 illustrates an example CCP of a control plane that configures PFEs in an SMN.

FIG. 5 conceptually illustrates a process of some embodiments for collecting metrics on a host computer.

FIG. 6 illustrates an example health metrics server for collecting and storing metrics and for computing health scores.

FIG. 7 conceptually illustrates a process of some embodiments for computing a health score for a composite component

FIG. 8 conceptually illustrates a process of some embodiments for computing a health score for an SMN based on its control-plane, data-plane, and management-plane components.

FIG. 9 illustrates an example logical network for which metrics may be collected and for which health scores may be computed.

FIG. 10 illustrates an example of logical components of logical networks defined across a shared set of physical forwarding elements.

FIG. 11 conceptually illustrates a process of some embodiments for computing a health score for a logical network.

FIG. 12 conceptually illustrates a process of some embodiments for computing a health score for an LFE.

FIGS. 13A-D illustrate example UIs and information presented to a user regarding the health of a composite component.

FIG. 14 illustrates an example UI to view a particular LFE's health over a period of time.

FIG. 15 conceptually illustrates a process of some embodiments for monitoring the health of a composite component and modifying the computation of the composite component's health score.

FIGS. 16A-B illustrate example UIs for modifying weights used in a health score computation.

FIGS. 17A-B illustrate example UIs for modifying techniques used in normalized metric value computation.

FIGS. 18A-B illustrate example UIs for modifying which metrics are included in a health score computation.

FIG. 19 illustrates an example metrics collection system for collecting, storing, and presenting metrics for a user.

FIG. 20 conceptually illustrates a process of some embodiments for storing and aggregating metrics for an SDN and/or its components.

FIG. 21 illustrates example metrics tables for storing raw and aggregated metrics for a particular PFE.

FIG. 22 illustrates a TSDB that includes a primary node and secondary nodes for storing metrics.

FIG. 23 illustrates an example metrics collection framework for collecting, aggregating, and storing metrics for different applications that require different aggregation criteria.

FIG. 24 conceptually illustrates a process of some embodiments for aggregating metrics at a metrics collection framework in an SDN including several network elements.

FIG. 25 conceptually illustrates a process of some embodiments for storing metrics for network elements of an SDN at a framework that collects, aggregates, and stores metrics for the SDN.

FIG. 26 conceptually illustrates a process of some embodiments for efficiently storing metrics for an SDN that includes several network elements by performing periodic rollups of metrics.

FIG. 27 illustrates a metrics manager that aggregates metrics at various aggregation levels and stores different aggregation level metrics for different periods of time.

FIG. 28 illustrates the communication between a user and a metrics query server through a UI for querying metrics.

FIG. 29 conceptually illustrates a process of some embodiments for providing SDN metrics to a user through a UI.

FIG. 30 illustrates an example UI presenting CPU utilization metrics requested by a user.

FIG. 31 illustrates another example UI presenting memory usage metrics requested by a user.

FIG. 32 illustrates an example UI presenting multiple aggregation levels of metrics for a user-specified time period.

FIGS. 33A-C illustrate an example UI presenting selectable controls for several sets of aggregated metrics of varying aggregation granularity for a user to select to view metrics.

FIG. 34 conceptually illustrates an electronic system with which some embodiments of the invention are implemented.

### DETAILED DESCRIPTION

In the following detailed description of the invention, numerous details, examples, and embodiments of the invention are set forth and described. However, it will be clear and apparent to one skilled in the art that the invention is not limited to the embodiments set forth and that the invention may be practiced without some of the specific details and examples discussed.

Some embodiments provide a novel method of providing operational data for network elements in a software-defined network (SDN). The method deploys a framework for collecting operational data for a set of network elements in the SDN. The framework of some embodiments includes an interface for different client applications to use in order to configure the framework to collect and aggregate the operational data based on different collection and aggregation criteria that satisfies different requirements of the different client applications. The method also deploys data collectors in the SDN that the framework configures to collect operational data from the set of network elements in the SDN.

In different embodiments, the different collection and aggregation criteria includes (1) different collection criteria for collecting different types of operational data for the different client applications, (2) different aggregation criteria for aggregating the operational data differently for the different client applications, (3) different storage criteria for storing aggregated operational data for the different client applications, or (4) a combination thereof. For example, the framework can allow different client applications to only specify different aggregation criteria. Alternatively, the framework can allow the different client applications to specify both different aggregation criteria and different storage criteria. In some embodiments, collection, aggregation, and/or storing criteria is the same for all client applications, meaning that client applications cannot specify different criteria for each of collecting, aggregating, and storing. For example, the framework can allow different client applications to specify different collection and aggregation criteria, but aggregated operational data for each client application is stored according to a same set of storing criteria.

Different collection criteria can include different types of operational data to collect for different network elements in the SDN. For instance, while a particular metric type is required for collecting for a first client application, it may not be required for a second client application. Hence, the first client application would have requirements to collect metrics of that particular type, while the second client application would not require that metrics of that particular type be collected for it. Different aggregation criteria can include different ways or methods of aggregating collected operational data. For example, one client application can require that all metrics be averaged over a specific time period, while a different client application can require that all metrics are taken to be the maximum value of that metric over a specific period of time (e.g., of three metrics collected during a particular time period are valued at 20, 30, and 50, the aggregated metric for these three values would be 50 since the requirements require using the maximum value). different storage criteria can include different time periods for storing different aggregation levels of operational data, or different databases for storing different aggregation levels of operational data. For example, a first client application can require that three particular aggregation levels of the operational data are stored for three particular time periods, while a second client application can require that the same three particular aggregation levels of operational data be stored for three different particular time periods than required by the first client application.

In some embodiments, a client application can include several application instances that implement the client application. Requirements of the different client applications in some embodiments includes functional requirements (also referred to as operational requirements) of the different client applications. In some embodiments, the set of network elements is a set of managed network elements that is managed by at least one of a set of network managers and a set of network controllers of the SDN. These network managers and network controllers can manage and control the entire SDN and its network elements. The set of managed network elements in some embodiments includes at least one of managed software network elements executing on host computers and managed hardware network elements in the SDN. For example, the set of network elements can include logical forwarding elements (LFEs) implemented on host computers, software physical forwarding elements (PFEs) implemented on host computers, and/or hardware standalone PFEs (e.g., edge devices or appliances) in the SDN. In some embodiments, the data collectors are deployed as plugins on the host computers and hardware PFEs in the SDN.

Some embodiments provide a novel method of storing operational data for network elements in an SDN. At metrics manager of a framework for collecting, aggregating, and storing the operational data for the SDN, the method receives, during a particular time period, a primary set of metrics collected from at least one SDN network element, and stores the first set of metrics in a volatile memory. The metrics manager uses a set of aggregation rules to aggregate the primary set of metrics into a secondary set of aggregated metrics. The metrics manager stores the secondary set of aggregated metrics in a non-volatile memory to use to monitor performance of the at least one SDN network element.

The non-volatile memory is in some embodiments a TSDB of the framework. The volatile memory is a local memory of the framework used for storing the primary metrics rather than storing them in the TSDB. In some embodiments, the receiving and using operations are performed in order to store different primary sets of metrics and to store different secondary sets of aggregated metrics.

In some embodiments, the particular set of aggregation rules is received from an interface of the framework that defines the particular set of aggregation rules from a particular set of aggregation criteria for a particular client application. As discussed previously, an API request can be sent to a data consumer interface specifying the aggregation criteria, and a parser and translator can parse the API request to extract the aggregation criteria and translate it into the aggregation rules. These aggregation rules are used by the metrics managers of the framework. In some embodiments, the translator sends the aggregation rules directly to the metrics managers. In other embodiments, the translator stores the aggregation rules in a database, and the metrics managers retrieve any aggregation rules it needs to aggregate metrics.

Aggregating metrics in some embodiments is performed by taking a larger first data set of N data tuples and producing a smaller, second data set of M data tuples. In such embodiments, M is less than N. This aggregation may be performed by combining a subset of two or more data tuples in the first data set to produce one data tuple in the second data set. Combining the subset of two or more data tuples may be performed by performing a statistical computation that summarizes the subset of data tuples. Such a statistical computation can be a mean operation (averaging all of the values into a single value), a median operation (taking the middle value as the aggregated value) , or a mode operation (taking the value seen the most amount of time as the aggregated value). Combining the subset of two or more data tuples can also be performed by taking the maximum or minimum value as the aggregated value, or computing a sum of all values.

In some embodiments, the secondary set of aggregated metrics is smaller than the primary set of metrics such that the primary set of metrics is aggregated into the secondary set of aggregated metrics in order to efficiently store metrics for the at least one SDN network element in the non-volatile memory. By storing a smaller set of metrics in the non-volatile memory, space is saved in the memory and the framework works more efficiently. The time periods for which primary metrics are received and stored in the volatile memory are specified in the aggregation rules. For example, a particular time period specified in a particular set of aggregation rules can specify how long the metrics manager is to store the primary metrics in the volatile memory and how long the metrics manager is to wait to aggregate the metrics according to the aggregation rules. In some embodiments, the particular time period is a first time period, and the particular set of aggregation rules also specifies a second time period. In such embodiments, the metrics manager stores the secondary set of aggregated metrics in the non-volatile memory for the second time period. After the second time period, the metrics manager uses the particular set of aggregation rules to aggregate the secondary set of aggregated metrics into a tertiary set of aggregated metrics and stores the tertiary set of aggregated metrics in the non-volatile memory.

In some embodiments, the metrics manager deletes the secondary set of aggregated metrics from the non-volatile memory after aggregating the secondary set of aggregated metrics into the tertiary set of aggregated metrics. Because the tertiary set of aggregated metrics is based on the secondary set of aggregated metrics, the secondary set of aggregated metrics in some embodiments is not always necessary to store after storing the tertiary set of aggregated metrics. Hence, the secondary set of aggregated metrics can be deleted from the non-volatile memory. However, in other embodiments, the metrics manager stores the secondary set of aggregated metrics in the non-volatile memory even after storing the tertiary set of aggregated metrics in the non-volatile memory. In these embodiments, the particular set of aggregation rules specifies that some or all aggregation levels of metrics (i.e., both the secondary and tertiary sets of aggregated metrics) are to be stored, so that the metrics manager does not delete the secondary set of aggregated metrics from the non-volatile memory.

The secondary set of aggregated metrics (and, in some embodiments, the tertiary set of aggregated metrics) is stored in the non-volatile memory for use by a user to view in a UI in order to monitor the performance of the at least one SDN network element. As discussed previously, a user can request to view metrics in a UI in order to analyze the metrics and monitor the performance of the at least one SDN network element.

Some embodiments provide a novel method of efficiently storing metrics for a software-defined network (SDN) that includes several network elements. A metrics manager of a set of one or more metrics managers executing in the SDN stores, in a TSDB, a first set of metrics associated with a particular network element of the SDN. The first set of metrics includes metrics of a particular set of one or more metric types collected during a first period of time. The metrics manager also stores in the TSDB a second set of metrics associated with the particular network element. The second set of metrics includes metrics of the particular set of metric types collected during a second period of time. After storing the first and second sets of metrics for a particular time interval, the metrics manager aggregates the first and second sets of metrics into a third set of metrics associated with the particular network element of the SDN. The third set of metrics indicates average metric values for the particular network element for the first and second periods of time. Then, the metrics manager deletes the first and second sets of metrics from the TSDB and stores the third set of metrics in the TSDB in order to efficiently utilize space in the TSDB.

To aggregate the first and second sets of metrics into the third set of metrics, the metric manager in some embodiments averages, for each metric type in the set of metric types, each metric of the metric type in the first and second sets of metrics into a single metric to indicate an average metric value of the metric type for the particular network element for the first and second periods of time. In order to consolidate the metrics of each type for the particular network element stored in the TSDB, the metrics manager computes an average of each metric type for storing. By storing the higher aggregation-level metrics (i.e., the third set of metrics) and deleting the lower aggregation-level metrics (i.e., the first and second metrics) from the TSDB, the metrics manager saves space in the TSDB.

When the first and second sets of metrics are stored in the TSDB, the first and second sets of metrics are used by a user in some embodiments to monitor performance of the particular network element. Then, after deleting the first and second sets of metrics from the TSDB and storing the third set of metrics in the TSDB, the third set of metrics is used by the user to monitor the performance of the particular network element. When a user requests to view metrics for the particular network element, the highest aggregation level metrics that are currently stored are provided to the user because all lower aggregation-level metrics have been deleted from the TSDB. In some embodiments, the particular set of metric types being aggregated by the metrics manager can include performance metrics, non-performance metrics, or a combination of both. Any suitable quantitative metrics can be aggregated and stored by a metrics manager in order to present to a user for analysis or monitoring of one or more network elements of an SDN.

Some embodiments provide a novel method of presenting operational data from several network elements in an SDN. An operational data aggregator of the SDN receives a first request to view metric data for a first time period prior to a current time. The operational data aggregator presents the a first group of sets of aggregated metrics created for the first time period. The operational data aggregator also receives a second request to view metric data for a second time period prior to the current time. The operational data aggregator presents a second group of sets of aggregated metrics created for the second time period. The first group of sets of aggregated metrics has at least one aggregated metric set that is at a different aggregation granularity than all other sets of aggregated metrics in the second group of sets of aggregated metrics.

In some embodiments, before the receiving and presentation operations, the operational data aggregator presents a set of one or more time controls in a UI to allow a user to specify a time period for which the user requests to view the metric data. In such embodiments, presenting the first group of sets of aggregated metrics includes presenting the first group of sets of aggregated metrics after the user specifies the first time period using the set of time controls. Presenting the second group of sets of aggregated metrics then also includes presenting the second group of sets of aggregated metrics after the user specifies the second time period using the set of time controls. For example, the UI can present a time control or filter for the user, and the user can specify to view metrics for the previous week. Each set of aggregated metrics that is associated with the previous week is then presented in the UI by the operational data aggregator.

Presenting the first group of sets of aggregated metrics in some embodiments includes first presenting one selectable control for each set of aggregated metrics in the first group of sets of aggregated metrics. In such embodiments, a user's selection of any particular selectable control for any particular set of aggregated metrics in the first group of sets of aggregated metrics results in presenting operational data for the particular set of aggregated metrics. For instance, the UI can present a selectable control for each aggregated metric set in order for the user to select which set the user wishes to view operational data. Upon selection of any of those selectable controls, the UI can present the selected operational data.

In some embodiments, the first and second requests are received successively, and the first and second time periods are defined by reference to current times at which the first and second requests are received. For example, the first and second requests can be received within one hour of each other. The first time period can specify a one month period from the current time at which the first request is received, and the second time period specifies a one week period from the current time at which the second request is received. So, when the first request is received at the top of that hour window, the user requesting to view metrics within the previous month will be presented with any aggregated metric sets for the previous month currently stored at the time the user made the first request. When the second request is received at the bottom of that hour window, the user requesting to view metrics within the previous week will be presented with any aggregated metric sets for the previous week currently stored at the time the user made the second request. During that one hour window, some aggregated metric sets from the last week may have been deleted from storage because some embodiments store metrics for different lengths of time based on their aggregation granularity. Hence, the time at which the user makes the request and the time period for which the user is requesting metrics are both important for which sets of aggregated metrics are going to be presented to the user.

The operational data aggregator of the SDN of some embodiments includes (1) a metrics query server for receiving the first and second requests and presenting the first and second groups of sets of aggregated metrics, and (2) a set of one or more metrics managers for creating different sets of aggregated metrics based on each other and based on raw metric data collected for the plurality of network elements in the SDN. In some embodiments, the raw metric data is collected by a set of one or more metrics collectors operating on at least one of host computers and edge devices in the SDN. At least a subset of the raw metric data is collected periodically (i.e., using a pull model) such that for a first metric type for a particular network element, a new raw metric of the first metric type is collected by a particular metrics collector for the particular network element at regular intervals. Another method for collecting metrics can be a push model. For instance, for a second metric type for the particular network element, the particular metrics collector receives a new raw metric of the second metric type each time the second metric type for the particular network element changes in value. In some embodiments, the particular network element is a particular edge device of the SDN, and the particular metrics collector operates on the particular edge device to collect the raw metric data associated with the particular edge device.

The first and second groups of sets of aggregated metrics in some embodiments are stored in a TSDB such that different sets of aggregated metrics aggregated at different aggregation granularities are stored in the TSDB for different lengths of time according to their aggregation granularity. For example, first aggregation-level metrics can be stored for a first length of time, while second aggregation-level metrics are stored for a longer, second length of time. At least a subset of the first and second sets of aggregated metrics is aggregated from collected raw metric data, and the raw metric data is alternatively stored in a volatile memory separate from the TSDB. Not storing raw metrics in the non-volatile TSDB uses the space of the TSDB more efficiently than if the raw metrics were also stored in the TSDB.

In some embodiments, different sets of aggregated metrics in the first and second groups of sets of aggregated metrics are stored in different TSDBs according to their aggregation granularity. For example, first aggregation-level metrics can be stored in a first TSDB, while second aggregation-level metrics are stored in a different, second TSDB. This may be done for organization of the aggregated metrics. In other embodiments, if all aggregated metrics are stored in one TSDB, each aggregation level can have a separate table in the TSDB for organization and easier deletion of each aggregation level.

In some embodiments, metrics that are collected and stored as described above can be used to compute health scores for a network and/or its components. For instance, some embodiments provide a novel method for computing one health score for a single composite element comprised of several elements to provide an indication of the health of the single composite element. In some embodiments, the health score is computed to quantify the health of an entire software managed network (SMN) deployed in a software-defined datacenter (SDDC). For example, a single health score may be computed for both the control-plane components and the data-plane components of an SMN to express the overall health of the SMN. In other embodiments, one health score is computed for the control-plane components to express the health of the control plane of the SMN, while another health score is computed for the data-plane components to express the health of the data plane of the SMN.

Other embodiments compute one health score quantifying the health for one logical distributed element defined in an SDDC, such as a logical forwarding element (LFE). An SDDC may include logical switches, logical routers, logical gateways, etc., each of which are implemented by one or more physical forwarding elements (PFEs), e.g., software switches, hardware switches, software routers, hardware routers, software gateways, hardware gateways, etc. Different embodiments include one or more of (1) one logical component implemented by one physical component, (2) one logical component implemented by multiple physical components, and (3) multiple logical components implemented by multiple physical components. In some embodiments, one health score is computed for one LFE implemented by multiple PFEs in an SMN.

In some embodiments, for an SMN or an SDDC, one health score is computed to quantify the health of a logical network or a logical sub-network of the SMN or SDDC. For a logical network that includes multiple logical components implemented by multiple physical components, one health score is computed to express the health of all logical and physical components of the logical network. In some embodiments, a health score is computed for all logical and physical components of a logical sub-network that is part of a larger logical network.

Some embodiments, instead of computing health scores, compute anomaly scores (also referred to as penalty scores), which may be values within a range of 1 to 100, with a high anomaly score being a poor score and a low anomaly score being a good score. Any embodiment or process described below may be performed using only health scores, only anomaly scores, or a combination of both health scores and anomaly scores. Any suitable value range of health scores and anomaly scores may be used.

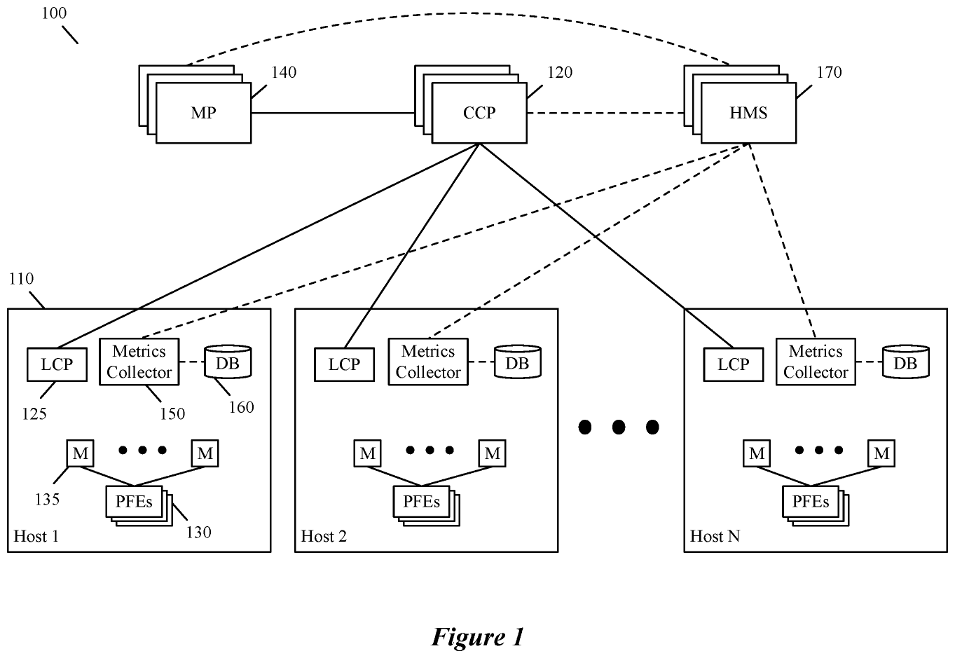

FIG. 1 illustrates an example SMN 100 of an SDDC. The SMN 100 includes hosts 110. Each host 110 includes one or more PFEs 130 and one or more machines 135. The PFEs 130 executing on the hosts 110 are configured to implement a conceptual data plane through which the PFEs 130 exchange data messages with each other. In some embodiments, the PFEs 130 are configured to implement one or more LFEs (not shown), and the data plane is implemented by one LFE or by a set of related LFEs, e.g., by a set of connected logical switches and logical routers. In some embodiments, the SMN 100 has several components (e.g., servers, VMs, host computer modules, etc.) that implement the control plane through which the PFEs 130 are configured to implement a data plane. These control-plane components include a central control plane (CCP) 120 that includes a set of controllers, and local control-plane (LCP) modules 125 operating on the hosts 110. In some embodiments, the SMN 100 also includes one or more standalone PFE devices, such as hardware switches and routers. In such embodiments, an LCP module operates on each standalone PFE device. The CCP 120 of the control plane operates on one host in the SMN 100, and one LCP module operates on each other host computer 110 and hardware PFE 130 in the SMN 100.

The SMN 100 of some embodiments also includes a management plane (MP) implemented by a set of management servers 140. The MP interacts with and receives input data from users, which is relayed to the CCP 120 to configure the PFEs 130. In some embodiments, the MP also receives input data from hosts in the SMN 100 and/or PFEs in the SMN 100, and, based on that input data, manages the control plane. In some embodiments, the management servers 140 process the input data before providing it to the control-plane components 120 and 125. In other embodiments, the management servers 140 provide the input data to the control-plane components 120 and 125 directly as it is given to the management servers 140. The management servers 140 also in some embodiments receive data from PFEs 130 and/or LFEs of the SMN 100, such as topology data, and the management servers 140 use this data to configure the CCP 120. In some embodiments, the hosts 110 also include local management-plane (LMP) modules (not shown). In such embodiments, the management servers 140 communicate with the LMP modules to configure the CCP 120 and the LCP modules 125.

As discussed above, the control plane (i.e., the CCP 120 and the LCP modules 125) configures the PFEs 130 to implement a data plane. The configured PFEs 130 may also implement one or more LFEs to implement the data plane. Hence, in order to monitor the health of the SMN, metrics associated with the control-plane components and the data-plane components should be collected, quantified, and monitored. Some embodiments include a set of one or more health management servers (HMS) 170 to compute one health score for both control-plane components and data-plane components. This one health score indicates the overall health of the SMN 100. Alternatively, other embodiments compute one health score for the control-plane components and another, separate health score for the data-plane components. These separate health scores indicate the overall health of the control plane and the data plane, separately. In some embodiments, one health score is computed for the control-plane components 120 and 125, the data-plane components 130 (and LFEs in some embodiments), and the management-plane components 140. And, in other embodiments, separate health scores are computed for the control-plane, data-plane, and management-plane components to indicate the health of the planes separately.

In some embodiments, the metrics associated with the control-plane, data-plane, and management-plane components are collected at each host 110 by a metrics collector 150, for use by the HMS 170. In some embodiments, each host 110 includes a database 160 for the metrics collector 150 to store the metrics of its host 110. The metrics collectors 150 of some embodiments only store their host's metrics in their local database 160, while, in other embodiments, the metrics collectors 150 send each other metrics collected on their host such that each database 160 on each host 110 in the SMN 100 stores all metrics for the SMN 100. In some embodiments, the HMS 170 collects these metrics associated with the control-plane, data-plane, and/or management-plane components from each database 160 on each host 110 in the SMN 100. In other embodiments, the metrics collectors 150 send the metrics directly to the HMS 170.

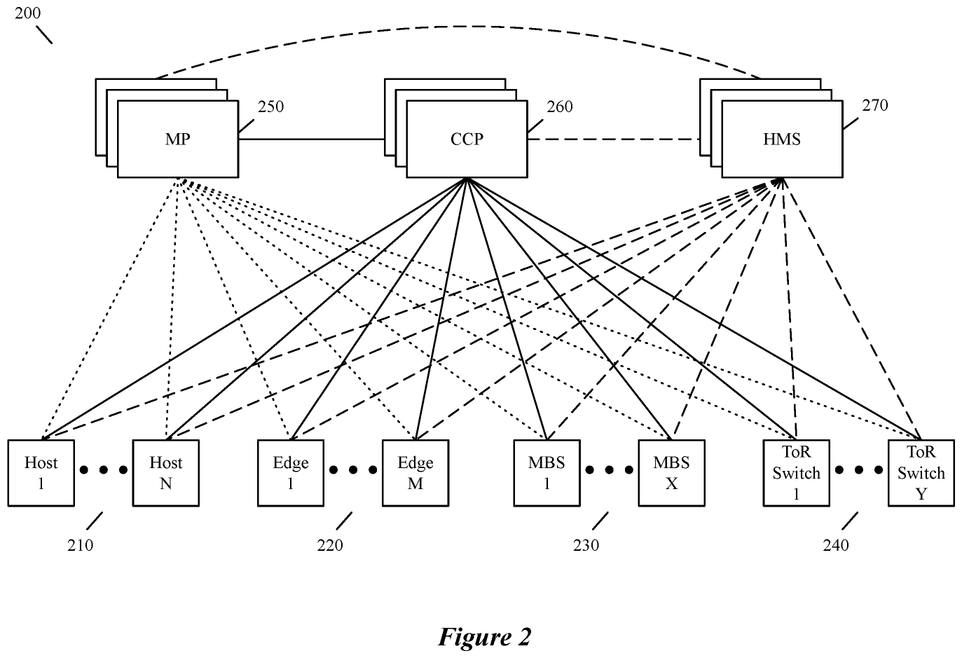

The example SMN 100 illustrates hosts 110 for which metrics are collected. FIG. 2 illustrates another SMN 200 for collecting metrics and computing health scores. In this example, the SMN 200 includes hosts 210, edge appliances 220, middlebox services (MBS) 230, and Top of Rack (ToR) switches 240. The SMN 200 may include any number of these types of components. The SMN 200 also includes a management plane 250, a CCP 260, and an HMS 270. The hosts 210 may include any components described for the hosts 110 of FIG. 1, such as LCP modules, LMP modules, databases, and metrics collectors. In some embodiments, the edge appliances 220, middlebox services 230, and ToR switches 240 also include metrics collectors for collecting metrics, which send the metrics to the HMS 270. In other embodiments, one or more network managers (not shown) collect metrics for the edge appliances 220, middlebox services 230, and ToR switches 240 to send to the HMS 270. The HMS 270 collects metrics for all components of the SMN 200 (i.e., the hosts 210, edge appliances 220, middlebox services 230, ToR switches 240, management-plane servers 250, and CCP 260) to compute one or more health scores that quantify the health of the SMN 200.

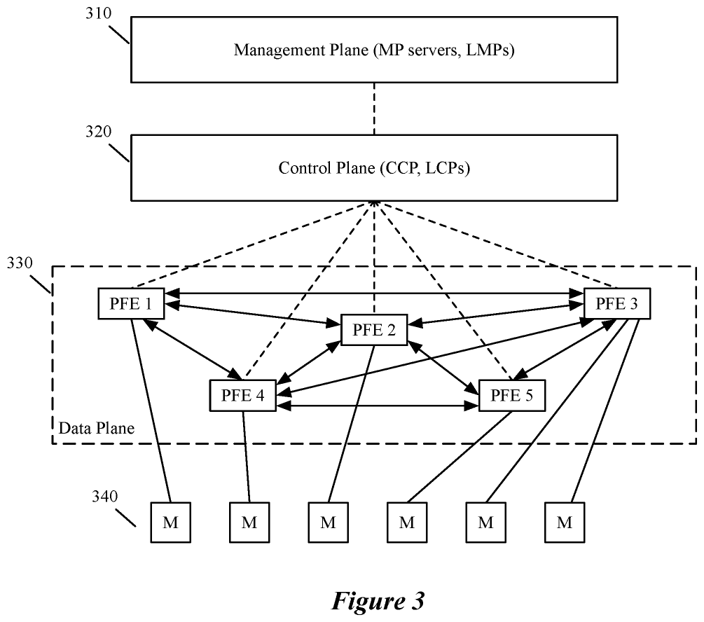

As discussed previously, the management plane configures the control plane, and the control plane configures PFEs to implement the data plane. FIG. 3 illustrates the configuration of these planes. The management plane 310, consisting of management-plane servers and LMP modules, configures the CCP and LCP modules of the control plane 320. Using the configuration provided by the management plane 310, the control plane 320 configures PFEs to implement the data plane 330. The example data plane 330 includes 5 PFEs that communicate with each other. For instance, PFE 1 communicates with PFEs 2, 3, and 4, and PFE 2 communicates with PFEs 1, 3, 4, and 5. The datapaths through which the PFEs communicate implement the data plane 330. The PFEs also communicate with machines 340, i.e., source and destinations of data messages exchanged between the PFEs implementing the data plane 330.

To quantify the health of the management plane 310, the control plane 320, and the data plane 330, various metrics for each plane must be collected. For the management plane 310, metrics may include the system memory, CPU (central processing unit), disk, and configuration maximum. These metrics are associated with the host on which the management plane 310 operates, and may be maintained and collected by the operating system (OS). In some embodiments, the management plane 310 includes a persistence store where the configuration data for the management plane 310 is stored. Metrics for the persistence store may include its read and write rate, its latency in reading and writing, and its CPU and memory usage. The persistence store in some embodiments is clustered and replicated. In such embodiments, metrics for the persistence store include whether all replicas of the persistence store are running, and whether it is running at a reduced capacity (e.g., one replica out of three are down). The management plane 310 of some embodiments includes a web-server hosting a REST (Representational State Transfer) API (Application Programming Interface) server that lets a user set and read the configuration for the management plane 310. Metrics for this web-server may include its runtime status (whether it is up and alive), its CPU and memory usage, its connection status to the persistence store, its connection status to the SMN's CCP, its API rate per second, its API latency per API, and if/how many concurrent API calls the web-server receives.

Other metrics related to the management plane 310 include (1) how much time (i.e., latency) intent takes to realize after an API call is processed, (2) if/how many pending intents are queued (i.e., waiting to be processed), (3) the management plane 310's connection to the web-server interface, (4) the latency in API calls to the web-server interface, inventory updates rate of the management plane 310, (5) whether the management plane 310's RBAC (Role-Based Access Control) service is up and running, and (6) whether the management plane 310's trust manager service (e.g., a sign in security service) is up and running. In some embodiments the management plane 310 includes management-plane servers and LMP modules, and metrics for the management plane 310 also include whether the management-plane servers are connected to the LMP modules. All of the metrics for the management plane 310 may be monitored and collected by metrics collectors operating on hosts in the SMN, network managers operating in the SMN, and/or any suitable application or module for collecting management-plane metrics.

For the control plane 320, metrics may include metrics of its system resources, such as memory, CPU, and disk, which are maintained and collected by the OS. Metrics may also include whether the CCP of the control plane 320 is connected to the management plane 310, and whether the CCP is connected to all hosts (i.e., to all LCP modules) in the SMN. Other metrics associated with the control plane 320 include the control plane 320's span calculations speed and distributing, e.g., a calculation of which hosts the control plane 320 spans and the speed at which the CCP distributes the span calculation to its LCP modules. All of the metrics for the control plane 320 may be monitored and collected by metrics collectors operating on hosts in the SMN, network managers operating in the SMN, and/or any suitable application or module for collecting control-plane metrics.

In some embodiments, a metrics collector sits on the appliance for which it is collecting metrics. For example, if the PFEs 1-5 are hardware PFEs, such as edge devices (also referred to as edge appliances), the PFEs can each run a metrics collector to collect metrics associated with that PFE. In some embodiments, a metrics collector on a PFE pulls metrics, meaning that it retrieves values for any metrics to collect for the PFE. This pulling of metrics can be performed periodically. Alternatively, a push model for collecting data can be implemented, meaning that the metrics collector receives metrics' values without having to request or retrieve them itself. For example, if a PFE's connection to the CCP fails or goes down, the metrics collector on that PFE can be notified of this connection status at the time it happens and record this information and its associated timestamp as a metric for the PFE. If the PFE's connection to the CCP fails and comes back up in between two consecutive periodic pulls of metrics, the metrics collector would miss this information and the connection failure would not be recorded. This interrupt driven model for the metrics collector ensures that all transitions are recorded for different types of metrics, and the tight integration of the metrics collector with the pipeline stages of the PFE allows the metrics collector to efficiently record all metrics for the PFE.

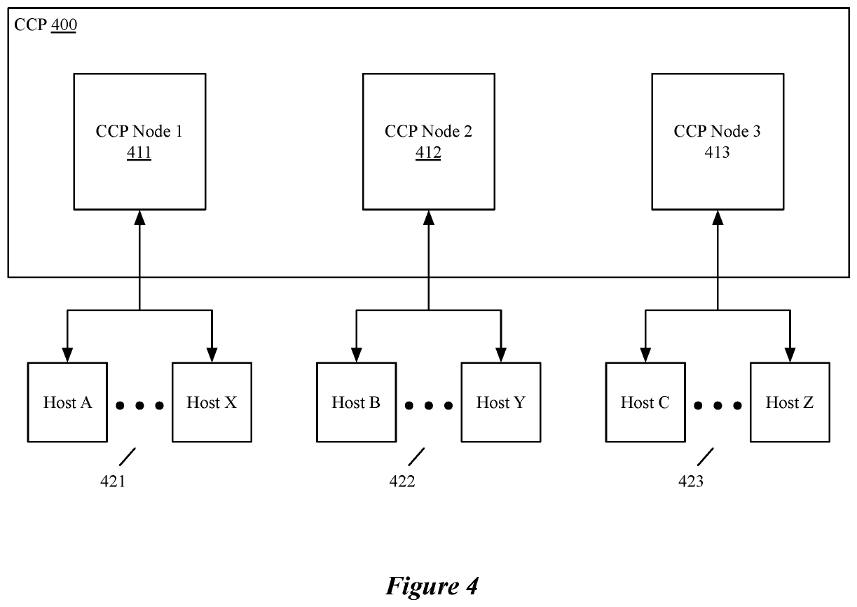

In some embodiments, metrics related to the control plane may also include the CCP's cluster health of the control plane, such as the health of all CCP nodes of the CCP, and sharding the hosts of the SMN across the CCP nodes. FIG. 4 illustrates an example CCP 400 with three CCP nodes 411, 412, and 413. Each CCP node 411-413 is coupled to one or more hosts 421, 422, and 423, respectively, such that an LCP module executing on a host communicates with its coupled CCP node in order to communicate with the CCP. A CCP may include any number of CCP nodes, and each CCP node may communicate with any number of hosts. In such embodiments where a CCP consists of multiple CCP nodes, the health of all CCP nodes of the CCP, i.e., whether all CCP nodes are up and running, may be used as a metric for the control plane. The distribution of hosts 421-423 among the CCP nodes 411-413, i.e., the sharding of the hosts among the CCP nodes, may also be used as a metric for the health of the control plane. For example, it may be defined that an even distribution of hosts among CCP nodes produces a better metric than an uneven distribution, indicating that an overloaded CCP node may result in a failure of that CCP node.

Referring back to FIG. 3, metrics for the data plane 330 include any metrics associated with the PFEs implementing the data plane and their datapaths, metrics associated with any LFEs implemented by the PFEs, and metrics associated with the hosts on which the PFEs operate. Data-plane metrics may also include metrics of its system resources, such as memory, CPU, disk, and network (e.g., packets per second, drops, throughput, etc.) which are maintained and collected by the OS. Metrics for the data plane 330 also include (1) control-plane 320 connectivity (e.g., whether the hosts of the PFEs are connected to the CCP), (2) management-plane 310 connectivity (e.g., whether the hosts of the PFEs are connected to the management plane 310), and (3) connectivity to other hosts (e.g., whether PFEs on one host are connected to PFEs on other hosts). In some embodiments, the configuration maximum of the data plane 330 is used as a metric, such as the maximum number of logical elements permitted for the network. Failures on realization and pending realization may also be considered as metrics for the data plane 330. Important processes used by data path forwarding elements executing on hosts may also be used for metrics. Examples of such processes are NestDB (an embedded persistent or in-memory database), Iked (Internet Key Exchange Daemon), and FRR (Free Range Routing). All metrics for the data plane 330 may be monitored and collected by metrics collectors operating on hosts in the SMN, and/or any suitable application or module for collecting data-plane metrics.

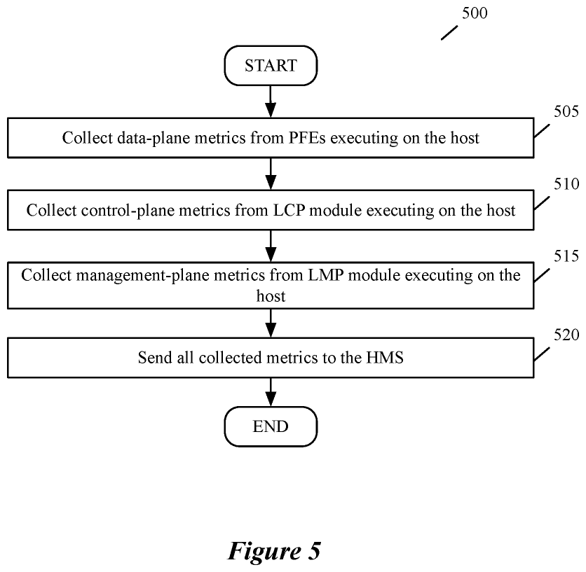

In some embodiments, metrics associated with the control-plane, data-plane, and management-plane components are collected at each host computer of an SMN. FIG. 5 conceptually illustrates a process 500 for collecting such metrics. The process 500 may be performed by a metrics collector operating on a host, such as any of the metric collectors 150 of FIG. 1. In some embodiments, this process 500 is performed periodically, such that metrics are collected and stored at regular time intervals, e.g., every five seconds, every five minutes, etc. Collecting metrics periodically ensures that the health of the SMN may be regularly quantified and monitored to understand the overall health of the SMN and how its health changes over time.

The process 500 begins by collecting (at 505) data-plane metrics from PFEs executing on the host. The metrics collector collects any metrics related to the PFEs operating on its host, and any metrics associated with LFEs implemented by those PFEs. Examples of data-plane metrics include: (1) a number of data messages exchanged per second, (2) a number of dropped data messages per second, (3) a number of bytes per second, (4) a number of data message errors per second, (5) a number of data message errors per second, (6) throughput percentage, (7) latency, etc. Next, the process 500 collects (at 510) control-plane metrics from the LCP module executing on the host. The metrics collector may collect any metrics associated with the control plane, and, more specifically, the LCP module, such as its connection status to the CCP. Examples of control-plane metrics also include: (1) if and when a local data plane of a host disconnects from the CCP, (2) Bidirectional Forwarding Detection (BFD) misses of a transport node (e.g., a host) and BFD statuses with other transport nodes, (3) edge cluster peer status, (4) edge-agent health (which manages high availability and failover), etc.

Then, the process 500 collects (at 515) management-plane metrics from the LMP module executing on the host. The metrics collector may collect any metrics associated with the LMP, such as its connection status to the management-plane servers, and metrics related to the data exchanged between the LMP module and the management-plane servers. In some embodiments, there is no LMP module executing on the host, and, in such embodiments, the metrics collector may collect management-plane metrics form the LCP module (which connects to the CCP configured by the management-plane servers), or the metrics collector may not collect any metrics for the management plane.

In embodiments in which the metrics collector does not collect management-plane metrics, network managers in the SMN may instead collect metrics for the management plane and send the metrics to the HMS. In different embodiments, steps 505, 510, and 515 are performed in a different order than described above or are performed at the same time. After collecting all metrics, the process 500 sends (at 520) all of the collected metrics to the HMS. Then, the process 500 ends. In some embodiments, the metrics collector sends the metrics over to the HMS to be stored at the HMS. In other embodiments, the metrics collector also stores the collected metrics in its own database on the host. Once the metrics are sent to the HMS, the HMS may use the metrics to quantify the health of the data plane, control plane, and management plane.

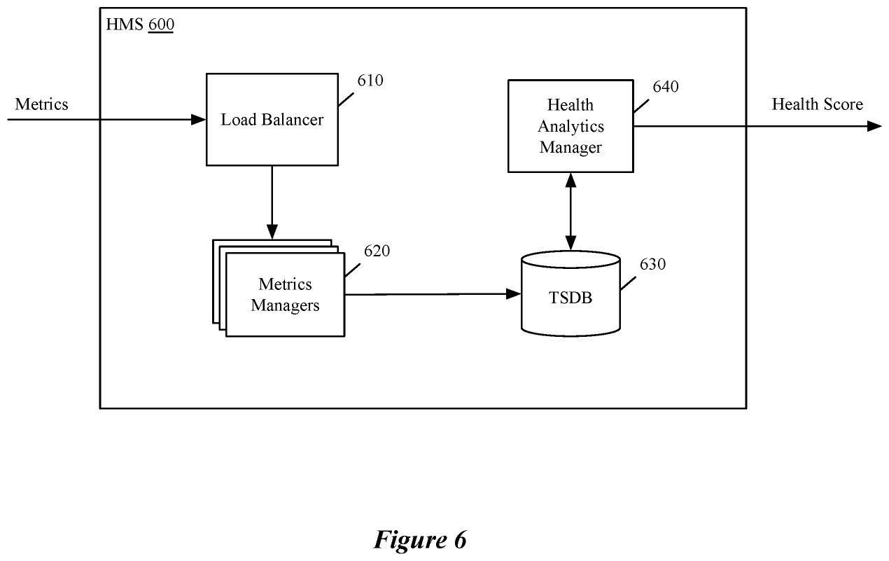

FIG. 6 illustrates an example HMS 600 and its components that use metrics to quantify the health of composite components. In some embodiments, the HMS 600 includes a load balancer 610, a set of metrics managers 620, a time-series database (TSDB) 630, and a health analytics manager 640. When the HMS 600 receives metrics from metrics collectors, network managers, and/or other applications and modules, the metrics are received at the load balancer 610. The load balancer 610 distributes the metrics among the set of metrics managers 620. In some embodiments, the load balancer 610 ensures that all metrics for a particular component (e.g., a particular PFE, a particular LFE, or a particular plane) are sent to one metrics manager 620, such that metrics for that component are processed by the same metrics manager 620. The load balancer 610 of some embodiments receives metrics collected at regular intervals, so the load balancer 610 must send related metrics collected at different times to the same metrics manager.

After receiving the metrics from the load balancer 610, each of the metrics managers 620 process the metrics to store in the TSDB 630. In some embodiments, the metrics managers 620 perform periodic rollups on the metrics. For example, a metrics manager 620 may receive the same latency metric for a particular network element every five seconds. The metrics manager 620 may store these metrics in a local memory until an aggregation timer fires. Once the timer fires, the metrics manager 620 aggregates (i.e., averages) all of these latency metrics up to five minutes, and stores the five-minute level metrics in the TSDB 630. For example, a metrics manager may average 20 memory usage metrics for a host collected at five-second intervals into one memory usage metric for that host. In some embodiments, the metrics managers 620 aggregate metrics even further and retrieve metrics from the TSDB 630 once another aggregation timer fires. For example, the metrics manager 620 may aggregate five-minute metrics up to one-hour metrics, and then one-hour metrics up to one day. In doing so, the TSDB 630 does not store smaller increment metrics for an extended period of time, saving storage space in the TSDB 630.

The TSDB 630 stores the metrics (and the aggregated metrics) from the metrics managers 620. In some embodiments, where periodic rollups of metrics are performed, the TSDB 630 deletes smaller increment metrics after they have been aggregated. For instance, if a set of five-minute metrics are aggregated to one-hour metrics, the TSDB 630 may delete the five-minute metrics. In some embodiments, the TSDB 630 stores different aggregation level metrics in separate tables, such that, when lower-level aggregation metrics are to be deleted, the TSDB 630 deletes the entire table instead of individual rows of one larger table.

Using the metrics stored in the TSDB 630, the health analytics manager 640 of some embodiments computes various health scores for various composite components of the SMN. For instance, the health analytics manager 640 may compute a health score for the data-plane and control-plane components, for a particular LFE, and for a particular logical network or logical sub-network. The health analytics manager 640 retrieves any necessary metrics for computing a health score, computes the health score, provides the health score to a user (e.g., through a UI), and stores the health score in the TSDB 630. In some embodiments, the health analytics manager 640 retrieves a set of health scores for a particular composite component from the TSDB 640 to provide to the user for monitoring the health of the composite component over time.

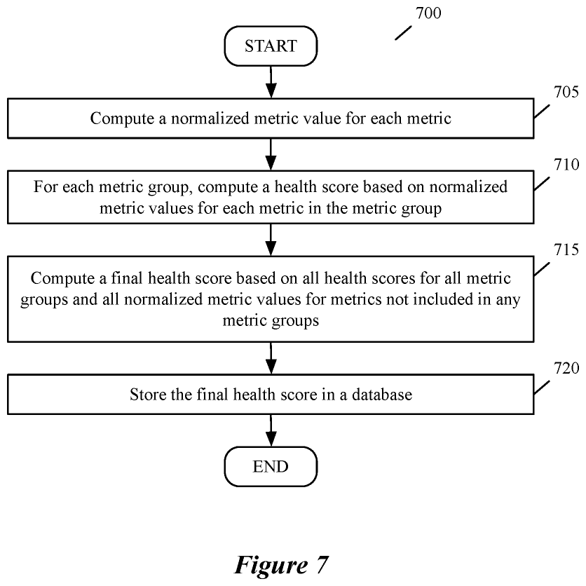

FIG. 7 conceptually illustrates a process 700 of some embodiments for computing a health score for a composite component. This process 700 may be performed by the health analytics manager of an HMS, such as the health analytics manager 640 of FIG. 6. The process 700 may be performed to compute one health score to express the overall health of a composite component, such as for an SMN (based on its control, data, and/or management-plane components), an LFE, a logical network, or a logical sub-network. The process 700 begins by computing (at 705) a normalized metric value for each metric. For numerical metrics, the health analytics manager of some embodiments takes the value of the collected metric and divides it by a maximum value of that metric in order to compute a normalized value for that metric.

For example, the health analytics manager may receive a metric specifying the number of data messages per second processed by a particular PFE of the SMN, such as 50 data messages per second. If the maximum value for that metric is 100 data messages per second, the normalized metric value for that metric is 0.5 (in embodiments where normalized metric values are on a 0 to 1 scale). As another example, the health analytics manager may use a metric specifying a host's connectivity to CCP metric, which may be a value of 1 for “YES” or 0 for “NO.” The maximum value for this metric is 1, so if the host is connected to the CCP, the normalized metric value is 1, and if the host is not connected to the CCP, the normalized metric value is 0. In some embodiments, the maximum value for a metric is determined by the health analytics manager. In other embodiments, the maximum value for a metric is determined by a user or administrator.

In some embodiments, the health analytics manager computes normalized metric values using rules and thresholds. For example, for a storage usage metric for a particular network element, a rule may be defined such that when the storage usage reaches 60%, the normalized metric value for the metric is 50 (in embodiments where normalized metric values are valued on a 1 to 100 scale). Another rule may be defined for this metric such that when the storage usage reaches 90%, the normalized metric value drops to a value of 10. Any suitable threshold or rule may be defined for any metric. In other embodiments, a standard deviation technique for computing normalized metric values may also be used, such that when a collected metric falls outside of the metric's standard deviation, the normalized metric value drops. For example, for a disk-usage metric, if the collected disk usage is outside the standard deviation range for the metric, the normalized metric value is 75, i.e., if the mean of the disk usage is 50, the standard deviation is 2, and the recorded disk usage is 56, the normalized metric value for that metric is 75. In some embodiments, all normalized metric values are computed using one technique. In other embodiments, different normalized metric values are computed using different techniques.

Next, the process 700 computes (at 710) a health score for each metric group based on normalized metric values for each metric in the metric group. In some embodiments, a user or administrator defines metric groups in order to group subsets of metrics and weigh some subsets of metrics differently than other subsets of metrics. For instance, a subset of metrics associated with a particular PFE may be defined as a metric group. Conjunctively, or alternatively, a subset of metrics associated with a particular metric type, such as storage usage, may be defined to be part of a metric group. A metric group may consist of only individual metrics as members, or may also include another metric group as a members. For example, members of a disk metric group may include latency metrics, disk error metrics, and partition disk-usage metrics. Members of an edge appliance group may include a disk metric group, a CPU metric group, and a memory metric group. Members of an edge health group may include an edge appliance metric group and CCP connection status metrics. Metric groups may be defined using any suitable criteria, and may be modified at any time.

In some embodiments, the health analytics manager computes these secondary health scores (i.e., secondary to the final, primary health score for the composite component) for metric groups by summing the normalized metric values of the group's members based on weights assigned to the metrics by users and/or administrators. Other embodiments use the normalized metric values differently to compute the secondary health scores. The weights assigned to each metric of some embodiments, when added together, sum to 100% (when the weights are values within a range of 0% to 100%). The weights in other embodiments, when added together, sum to 1 (when the weights are values within a range of 0 to 1). For example, a first metric may have a normalized metric value of 80 and have an assigned weight of 40%, and a second metric may have a normalized metric value of 60 and have an assigned weight of 60%. Summing these normalized metric values based on their assigned weights results in an overall health score of 68.

The health analytics manager computes a separate, secondary health score for each metric group using the subset of metrics included in the metric group. For example, a user may define a control-plane metric group that includes all metrics related to the control plane. The health analytics manager would then compute a health score for the control-plane metric group. In some embodiments, if a first metric group includes a second metric group as a member, the second metric group's health score is computed first, and the health score for the first metric group is computed using the health score for the second group and normalized metric values of any other members. For example, if the user defines the control-plane metric group and an LCP-module metric group that includes all metrics related to the LCP modules, then the LCP-module metric group would be a member of the control-plane metric group. The health analytics manager would first compute a health score for the LCP-module metric group and use that health score and normalized metric values for other control-plane metrics to compute the control-plane metric group health score. In some embodiments, no metric groups have been defined, and the process 700 proceeds from step 705 to step 715.

Then, the process 700 computes (at 715) a final health score for the component based on all health scores for all metric groups and all normalized metric values for metrics not included in any metric groups. The health analytics manager may sum these values based on weights assigned to the metric groups and the metrics. The health analytics manager may also combine these values in any suitable way to generate the final health score. In the example of computing an overall health score for an SMN based on control-plane and data-plane components, a user may define a control-plane metric group and a data-plane metric group. In order to compute the final health score, the health analytics manager sums the health scores of these two metric groups based on weights assigned to the groups.

Alternatively, if the user only defines a control-plane metric group and not a data-plane metric group, the health analytics manager sums the health score of the control-plane metric group with the normalized metric values of the data-plane component metrics using weights assigned to the control-plane metric group and the data-plane component metrics. Once the final health score is computed, the process 700 stores (at 720) the final health score for the composite component in a database. The health analytics manager stores the health score in the TSDB of the HMS. In some embodiments, the health analytics manager also stores the normalized metric values for the metrics, the secondary health scores computed for the metric groups, and the weights assigned to the metrics and the metric groups. Then, the process 700 ends.

In some embodiments, the health analytics manager performs this process 700 for a particular composite component periodically based on a defined time interval, e.g., every five minutes, and each health score is stored in the TSDB. A user or administrator may define the time interval at which the health score is computed for the component.

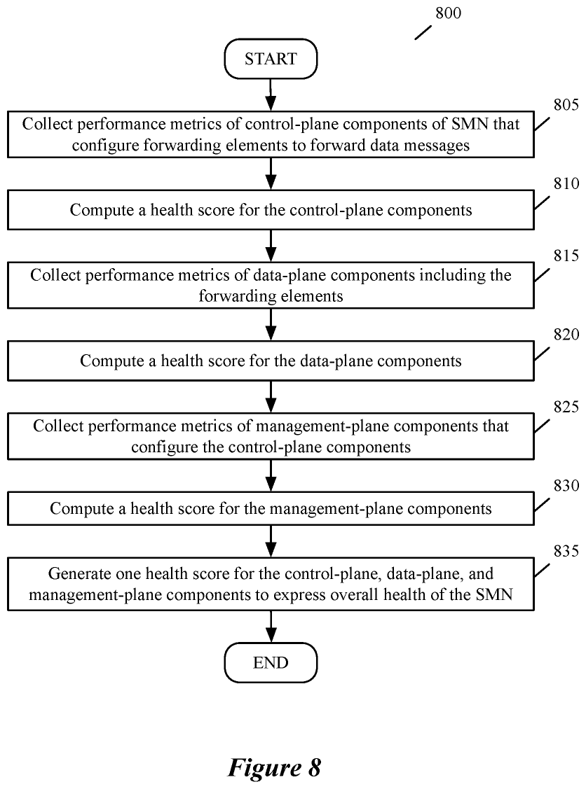

FIG. 8 conceptually illustrates a process 800 for computing a health score for an SMN based on its control-plane, data-plane, and management-plane components. This process 800 may be performed by a health analytics manager of an HMS, such as the health analytics manager 640 of FIG. 6. In some embodiments, this process 800 is performed using only data-plane and control-plane component metrics to express the overall health of the SMN. In other embodiments, the process 800 also uses management-plane component metrics to express the SMN's overall health. Any health score computations may be computed using the process 700 of FIG. 7.

The process 800 begins by collecting (at 805) performance metrics of control-plane components of the SMN that configure forwarding elements to forward data messages. The health analytics manager collects the control-plane component metrics from a TSDB, such as the TSDB 630 of FIG. 6, or any other suitable database. The forwarding elements in some embodiments are the PFEs executing on hosts in the SMN and hardware PFEs executing in the SMN. In other embodiments, the forwarding elements are the LFEs implemented by the PFEs in the SMN. In some embodiments, the performance metrics from the control-plane components include (1) metrics associated with the CCP of the control plane, (2) metrics associated with the host computer on which the CCP operates, (3) metrics associated with each of the LCP modules of the control plane, and (4) metrics associated with each host computer on which the LCP modules operate. Any suitable control-plane component metrics may be collected by the health analytics manager. The forwarding elements may include PFEs and/or LFEs.

In some embodiments, one or more metrics needed to compute a health score for a component cannot be collected by the health analytics manager, e.g., it is not found in the TSDB. In such embodiments, the normalized metric value for the unknown metric value is 0, and the composite component's health score is computed using 0 as that metric's normalized metric value. Then, the process 800 computes (at 810) a health score for the control-plane components. The health analytics manager computes this health score using the process 700 of FIG. 7. In some embodiments, the health analytics manager stores the control-plane health score in the TSDB of the HMS and reports it to the user to provide an indication of the health of the control plane.

Next, the process 800 collects (at 815) performance metrics of data-plane components including the forwarding elements. The health analytics manager collects these data-plane metrics from the TSDB of the HMS or some other database. In some embodiments, the data-plane metrics are associated with the PFEs in the SMN. In other embodiments, the data-plane metrics are associated with the LFEs implemented by the PFEs in the SMN. Still, in other embodiments, the data-plane metrics are associated with both PFEs and LFEs. The performance metrics of the data-plane components in some embodiments include metrics associated with the datapaths of the forwarding elements of the SMN (i.e., LFEs, PFEs, or both) and metrics associated with the data messages exchanged between the forwarding elements of the SMN. Then, the process 800 computes (at 820) a health score for the data-plane components. The health analytics manager may compute this health score using the process 700 of FIG. 7 to indicate the overall health of the data plane of the SMN.

Next, the process 800 collects (at 825) performance metrics of management-plane components that configure the control-plane components. The management-plane components may include a set of management servers and LMP modules operating on hosts in the SMN. The performance metrics of the management-plane components may be related to the management-plane servers, the LMP modules, the hosts on which the management-plane servers and LMP modules operate, the configuration data received by the management-plane components (e.g., from a user), and the configuration information sent by the management-plane components to the control-plane components to configure the control plane. Then, the process 800 computes (at 830) a health score for the management-plane components. Similar to the health score for the control-plane components and the health score for the data-plane components, the health analytics manager computes the management-plane component health score using the process 700 of FIG. 7 to indicate the overall health of the management plane of the SMN.

Then, the process 800 generates (at 835) one health score for the control-plane, data-plane, and management-plane components to express the overall health of the SMN. In some embodiments, the health analytics manager sums the health scores of the individual planes based on weights assigned to the planes to compute the overall health score of the SMN. In other embodiments, the health analytics manager sums the normalized metric values for the control-plane, data-plane, and management-plane metrics based on weights assigned to the metrics, if no weights are assigned to plane metric groups. Then, the process 800 ends. In some embodiments, the overall health score is provided in a report to indicate the health of the SMN, and is stored in the TSDB of the HMS. In other embodiments, the separate health scores for the control plane, data plane, and management plane are instead provided in the report to indicate the overall health of the planes individually, and are also stored in the TSDB of the HMS in order to monitor the planes individually and to understand which plane, if any, is causing a poor health of the SMN. Still, in other embodiments, the overall health score and the individual plane health scores are provided in the report and stored.

In some embodiments, the health analytics manager computes a health score based on metrics for distributed network elements, such as LFEs, or entire logical networks. As discussed previously, the control plane of an SMN configures PFEs to implement a conceptual data plane through which the PFEs exchange data messages. In some embodiments, the multiple PFEs are configured to implement one or more LFEs, and the data plane is implemented by an LFE or by a set of related LFEs (e.g., by a set of connected logical switches and routers). The LFEs implemented by the PFEs may be part of a logical network, and health scores can be computed to express the overall health of one distributed network element (i.e., one LFE) or of an entire logical network.

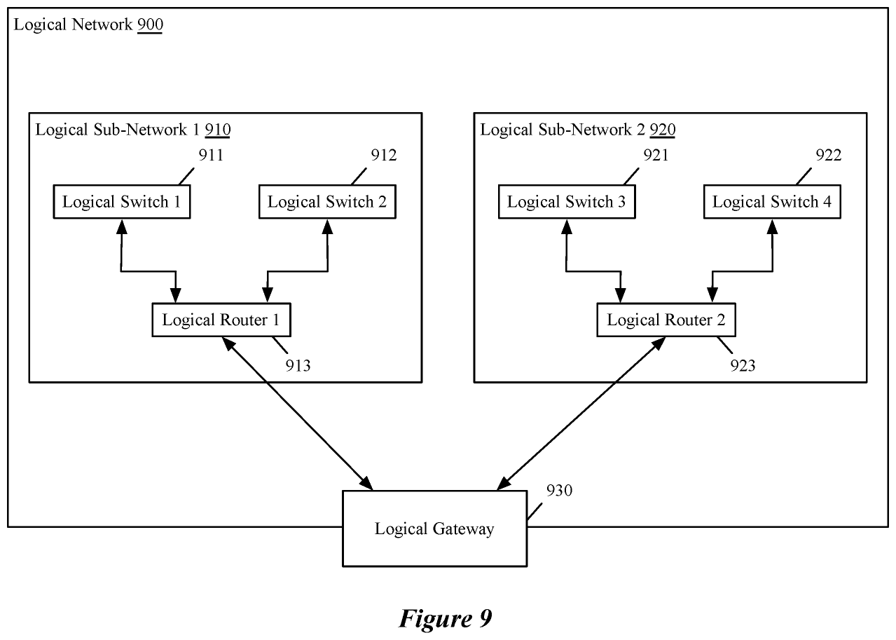

FIG. 9 illustrates an example logical network 900 for which an HMS may store metrics and compute health scores. The logical network 900 includes a first logical sub-network 910 that consists of two logical switches 911 and 912 and a logical router 913. The logical switches 911 and 912 communicate with each other through the logical router 913. The logical network 900 also includes a second logical sub-network 920, which includes logical switches 921 and 922 and a logical router 923. The logical switches 921 and 922 communicate with each other through the logical router 923. Logical switches in different logical sub-networks communicate through the logical gateway 930 of the logical network 900. All of these logical components of the logical network 900 are implemented by physical components of a physical network, such as components described in FIG. 1 and FIG. 2. For instance, the logical switch 911 may be implemented by two PFEs operating on one host, while the logical switch 921 may be implemented by three PFEs operating on separate hosts. Any number of physical components operating on any number of hosts may implement a logical component of a logical network.

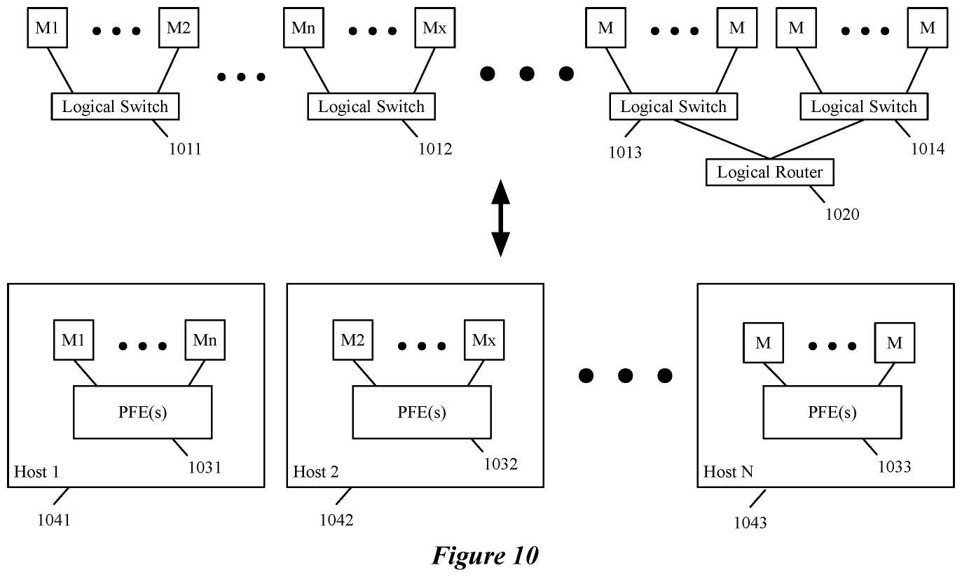

FIG. 10 illustrates an example of logical components 1011-1020 of logical networks defined across a shared set of physical forwarding elements 1031-1033. Specifically, this figure illustrates a number of machines that execute physical forwarding elements on several hosts. The shared physical forwarding elements 1031-1033 can implement any arbitrary number of logical switches and logical routers. One LFE can communicatively connect VMs on different hosts. For example, the logical switch 1011 connects machines M1 and M2 that execute on hosts 1041 and 1042, while the logical switch 1012 connects machines Mn and Mx that execute on these two hosts.

The logical forwarding element or elements of one logical network isolate the data message communication between their network's VMs from the data message communication between another logical network's VMs. In some embodiments, this isolation is achieved through the association of logical network identifiers (LNIs) with the data messages that are communicated between the logical network's VMs. In some of these embodiments, such LNIs are inserted in tunnel headers of the tunnels that are established between the shared network elements (e.g., the hosts, standalone service appliances, standalone forwarding elements, etc.).

In hypervisors, software switches are sometimes referred to as virtual switches because they are software, and they provide the VMs with shared access to the physical network interface cards (PNICs) of the host. However, in this document, software switches are referred to as physical switches because they are items in the physical world. This terminology also differentiates software switches from logical switches, which are abstractions of the types of connections that are provided by the software switches. There are various mechanisms for creating logical switches from software switches. Virtual Extensible Local Area Network (VXLAN) provides one manner for creating such logical switches. The VXLAN standard is described in Mahalingam, Mallik; Dutt, Dinesh G.; et al. (2013-05-08), “VXLAN: A Framework for Overlaying Virtualized Layer 2 Networks over Layer 3 Networks”, IETF. Host service modules and standalone service appliances (not shown) may also implement any arbitrary number of logical distributed middleboxes for providing any arbitrary number of services in the logical networks. Examples of such services include firewall services, load balancing services, DNAT services, etc.

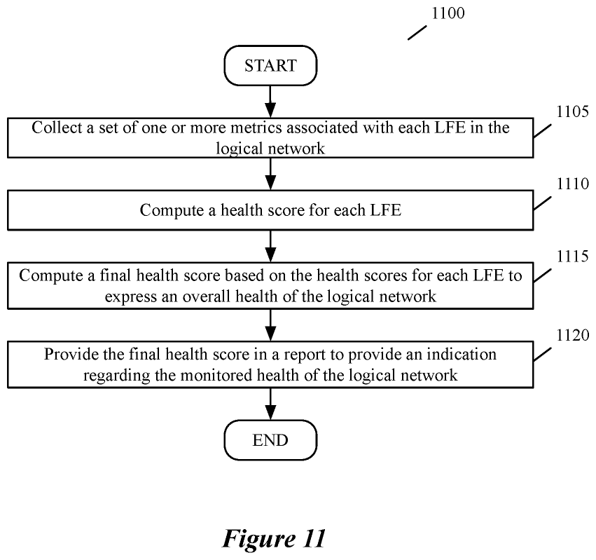

In some embodiments, an HMS of an SMN may compute a health score for a logical network. FIG. 11 conceptually illustrates a process 1100 of some embodiments for computing a health score for a logical network. This process 1100 may be performed by a health analytics manager of an HMS, such as the health analytics manager 640 of FIG. 6. In some embodiments, the logical network for which a health score is computed is the entire logical network, meaning that the health score is computed based on metrics for all LFEs of the logical network. In other embodiments, the logical network for which a health score is computed is a smaller first logical sub-network of a larger second logical network. In such embodiments, the health score for the logical sub-network only indicates the health of the LFEs in the logical sub-network, and not any other LFEs in the entire logical network. The process 1100 will be described below according to the logical network 900 of FIG. 9. However, the process 1100 may be performed for any logical network or any logical sub-network, such as for the logical sub-networks 910 or 920 of FIG. 9.

The process 1100 begins by collecting (at 1105) a set of one or more metrics associated with each LFE in the logical network. The health analytics manager collects metrics from the TSDB of the HMS, and/or a database related to the LFEs of the logical network. These metrics may be associated with the PFEs that implement the LFEs, the datapaths along which data messages are sent between the LFEs in the logical network, and the hosts on which the PFEs operate (for PFEs that are software forwarding elements operating on hosts).

Next, the process 1100 computes (at 1110) a health score for each LFE in the network. For each LFE, the health analytics manager computes normalized metric values for each metric related to the LFE and sums these values based on weights assigned to the metrics to generate the health score for that LFE. These secondary health scores computed for each LFE can be considered metric group health scores, with each LFE being defined as its own metric group. Examples of metric groups defined for metrics of an LFE include (1) a metric group including all metrics for a particular PFE implementing the LFE, (2) a metric group including all metrics associated with outgoing data messages associated with a particular PFE, (3) a metric group including all metrics associated with a particular host on which a PFE implementing the LFE operates, etc.

Then, the process 1100 computes (at 1115) a final health score for the logical network based on the health scores for each LFE in order to express the overall health of the logical network. The health analytics manager sums all health scores for all LFEs of the logical network based on weights assigned to the LFEs. For instance, if a user or administrator values logical gateways of the logical network over logical switches and routers, the user may assign a larger weight to the logical gateways. In doing so, the final health score for the logical network takes the health of the logical gateway(s) of the logical network into account more than any logical switches and logical routers in the network, which provides the user with a more customized health monitoring scheme for the logical network.

The process 1100 then provides (at 1120) the final health score in a report to provide an indication regarding the monitored health of the logical network. The report in some embodiments is provided through a text message, an email, and/or a UI. The report may also be provided through an API. For instance, the report may use a push model to provide the report. The health analytics manager pushes the report in an API to another program to provide the logical network's health score to the user. Alternatively, the report may use a pull model to provide the report. For example, another program may send an API request to the health analytics manager requesting the report, and the health analytics manager may send an API response providing the report. In some embodiments, the report includes only the final health score for the logical network. In other embodiments, the report includes additional information, such as the secondary health scores for each LFE (i.e., health scores for any metric groups), the normalized metric values for each metric used in computing the final health score, and the weights used in computing the health scores. The report may also include other information, which will be described further below. The process 1100 then ends.

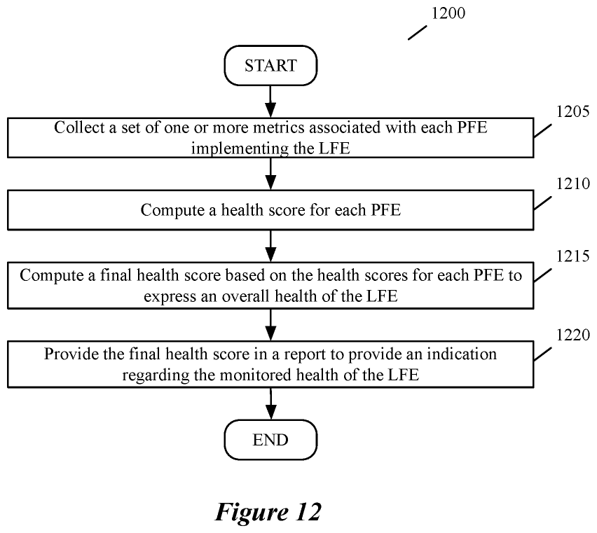

In some embodiments, the health analytics manager computes a health score for one LFE to provide to a user for monitoring the one LFE. FIG. 12 conceptually illustrates the process 1200 for computing a health score for one LFE. This process 1200 may be performed by the health analytics manager of an HMS similarly to computing a health score for a logical network. The process 1200 begins by collecting (at 1205) a set of one or more metrics associated with each PFE implementing the LFE. Like metrics for an entire logical network, these metrics can be collected by the health analytics manager from the TSDB of the HMS and/or from another database.

Next, the process 1200 computes (at 1210) a health score for each PFE implementing the LFE. The health analytics manager computes a secondary health score for each PFE in order to quantify the health of the PFEs individually. For each PFE, the health analytics manager computes normalized metric values for each of the PFE's metrics, and sums these values based on weights assigned to the metrics. For instance, for a particular PFE, the health analytics manager may compute normalized metric values of the particular PFE's metrics related to its latency, its number of packets processed per second, its connection status to other PFEs in the network, etc., to compute the health score for the PFE.

Then, the process 1200 computes (at 1215) a final health score for the LFE based on the health scores for each PFE to express an overall health of the LFE. Based on weights assigned to each PFE, the health analytics manager sums the secondary health scores for each PFE to compute the LFE's health score. In some embodiments, weights may not be assigned to PFEs and may only be assigned to individual metrics. In such embodiments, the health analytics manager computes the final health score using the normalized metric values and the weights for the individual metrics instead of using the secondary health scores of the PFEs. Alternatively, the health analytics manager can assume the weight for each PFE is the same (since the user did not assign more weight to one PFE over another), and sum the secondary health scores based on the same weight for each PFE. For example, if the LFE is implemented by 4 PFEs, and no weights were assigned to the PFEs by the user, the health analytics manager assumes each PFE has a weight of 0.25 to compute the final health score.

Once the final health score is computed, the process 1200 provides (at 1220) the final health score for the LFE in a report to provide an indication regarding the monitored health of the LFE. This report may include just the final health score, or may also include secondary health scores computed for PFEs, normalized metric values for individual metrics, and/or weights used in computing the health score. The process 1200 then ends.

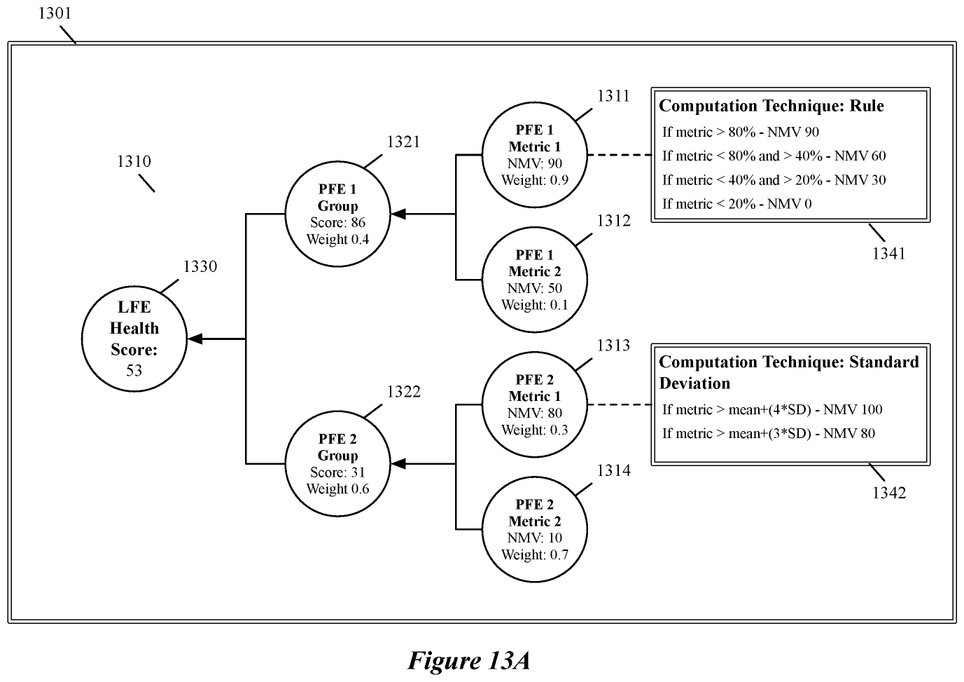

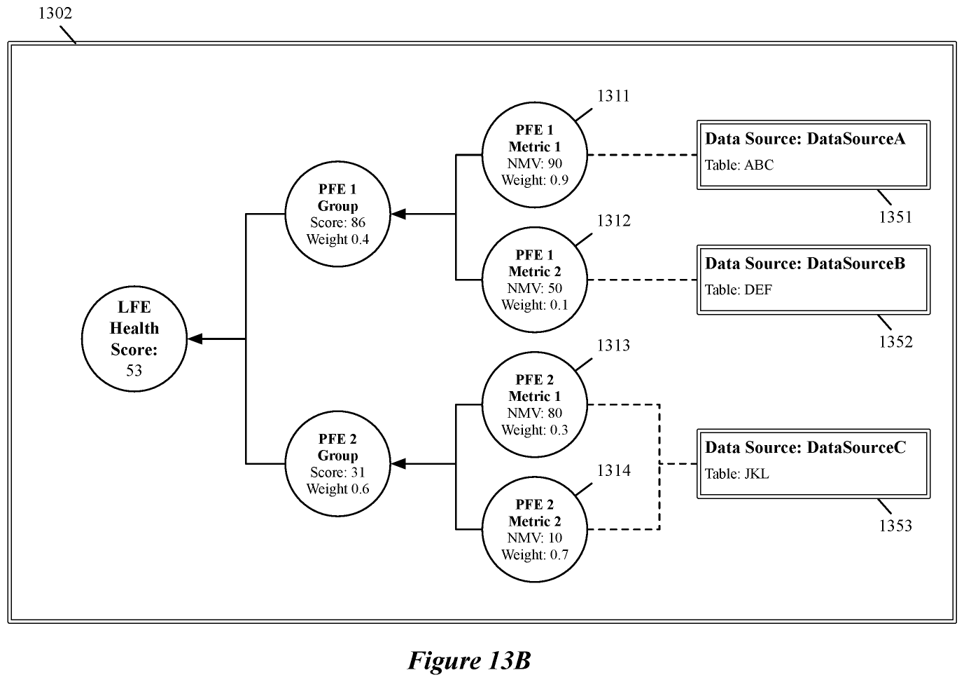

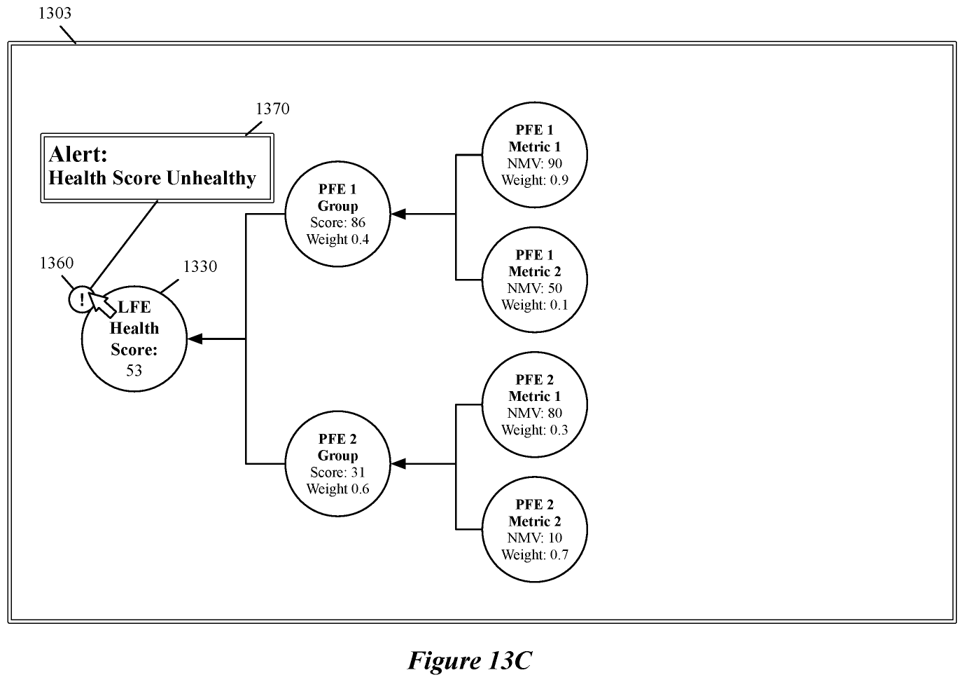

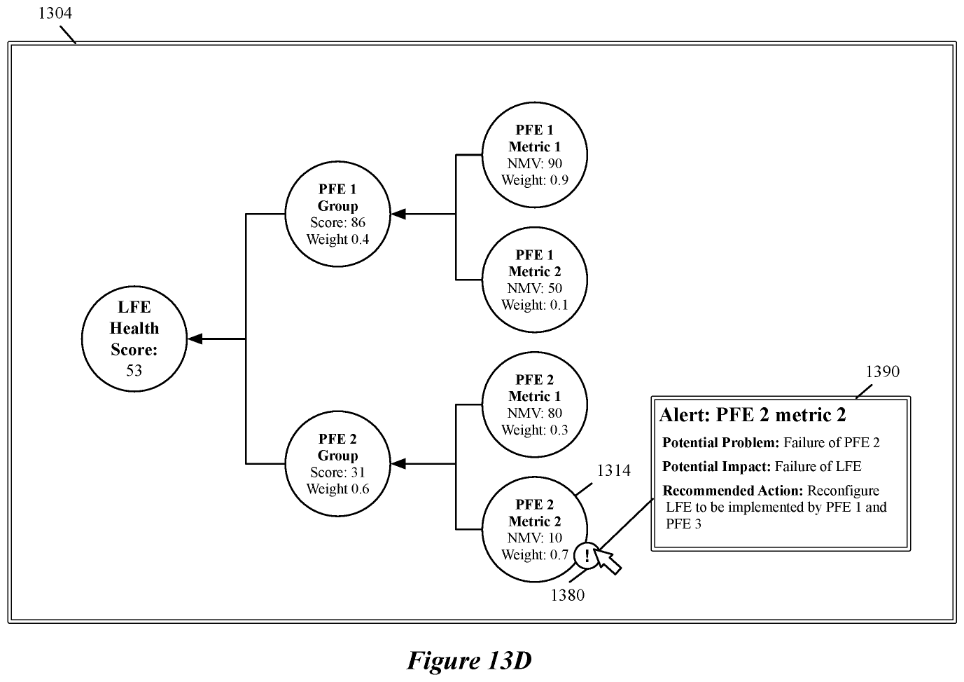

In some embodiments, a report for a composite component (e.g., an LFE, a logical network, an SMN, etc.) is presented in a UI for a user to view the computation of the composite component's health score and for the user to monitor the health of the composite component. These reports may be presented for any component's health score computation, such as for a logical network, a logical sub-network, an LFE, or an entire SMN. FIGS. 13A-D illustrate example UIs and information that can be presented to the user regarding health scores. FIG. 13A presents a UI 1301 with an example score tree 1310 for an LFE. The score tree 1310 is presented in the UI 1301 to illustrate the mapping between the individual metrics 1311-1314, the metric groups 1321-1322, and the final score 1330.

For each individual metric, the score tree 1310 provides the name of the metric, the normalized metric value for that metric, and the weight assigned to the metric. PFE 1 Metric 1 1311 has a normalized metric value of 90 and a weight of 0.9. PFE 1 Metric 2 1312 has a normalized metric value of 50 and a weight of 0.1. PFE 2 Metric 1 1313 has a normalized metric value of 80 and a weight of 0.3. PFE 2 Metric 2 1314 has a normalized metric value of 10 and a weight of 0.7. Arrows from the metrics 1311-1314 indicate which metric group 1321-1322 the metric belongs. PFE 1's metrics 1311-1312 are part of PFE 1 Group 1321, and PFE 2's metrics 1313-1314 are part of PFE 2 Group 1322. These two metric groups 1321-1322 have computed health scores and weights, which are used to compute the LFE's final health score 1330 of 53.

UIs in some embodiments provide further information related to the computation of the health scores, the metrics used in the health score computation, and the impact of the health score. The UI 1301 presents the windows 1341 and 1342 to provide further information to the user regarding how normalized metric values are computed. These windows 1341 and 1342 may be provided for each metric shown in the UI 1301, or may only be provided for a subset of the metrics. In this example, the windows 1341 and 1342 are presented for two of the metrics 1311 and 1313, respectively. The first window 1341 for PFE 1 Metric 1 1311 describes that this metric's normalized metric value was computed using a rule-based technique.

In computing the normalized metric value for this metric 1311, the health analytics manager used the following rules: (1) if the metric is more than 80%, the normalized metric value is 90; (2) if the metric is between 40% and 80%, the normalized metric value is 60; (3) if the metric is between 20% and 40%, the normalized metric value is 30; and (4) if the metric is less than 20%, the normalized metric value is 0. The second window 1342 for PFE 2 Metric 1 1313 describes that this metric's normalized metric value was computed using a standard deviation technique. In computing the normalized metric value for this metric 1313, the health analytics manager used the following computations: (1) if the measured metric is more than the mean (i.e., average) of this metric plus 4 times the standard deviation of this metric, the normalized metric value is 100; and (2) if the measured metric is more than the mean of this metric plus 3 times the standard deviation of this metric, the normalized metric value is 80. In some embodiments, the windows 1341 and 1342 are shown in the UI along with the score tree 1310. In other embodiments, the windows 1341 and 1342 are only shown in the UI 1301 upon receiving a selection from the user to view this information.

FIG. 13B illustrates a similar example UI 1302, with windows 1351-1353 to display information regarding which datasource from which each metric was collected. In some embodiments, all metrics are collected from a TSDB of the HMS. In other embodiments, different metrics are collected from different data stores in the network, such as from databases on hosts from which the metrics are measured and collected. In this example UI 1302, the first window 1351 describes that PFE 1 Metric 1 1311 was collected from a table ABC in a database DataSourceA. The second window 1352 describes that PFE 1 Metric 2 1312 was collected from a table DEF in a database DataSourceB. The third window 1353 describes that PFE 2 Metric 1 1313 and PFE 2 Metric 2 1314 were both collected from a table JKL in a database DataSourceC. In some embodiments, these windows 1351-1353 provide further information regarding the data source from which each metric was collected, such as which component/host on which the data source operates.

FIG. 13C illustrates another example UI 1303 that provides alerts related to the computed health score for the composite component. In some embodiments, when a component's health score falls below a particular threshold, the health analytics manager sends a notification to the user that the component is at risk. This notification may be in the form of a text message, an email, an alert in a UI, etc. In embodiments where anomaly scores are computed for components, the notification is sent when the anomaly score reaches a particular threshold. In the example of FIG. 13C, the LFE's final health score 1330 is valued at 53. In some embodiments, a component is considered “at risk” if the health score is above 40 and below 79, and “unhealthy” if the health score is below 40. Because the LFE's health score was computed to be 53, the UI 1303 presents an icon 1360 next to the LFE health score 1330 to notify the user of a possible problem with the LFE.

In some embodiments, upon selection of this icon 1360, the UI 1303 presents a window 1370 to alert the user of the at-risk/unhealthy component. In other embodiments, the window 1370 is presented in the UI 1303 without any user selection. The window 1370 of some embodiments also includes information regarding (1) a potential problem associated with the health score, (2) a potential impact the health score may have on the component, and (3) a recommended action to improve the health score. For example, for a final health score of 30 out of 100 for an LFE, the report may provide information regarding potential problems that may arise when the health score is this low, the impact on the LFE this score may have, and recommended actions to improve the health of the LFE. A recommended action may include reducing the amount of storage at a particular PFE implementing the LFE, if a storage usage metric for that PFE has a poor health score.

FIG. 13D illustrates a similar UI 1304 to display alerts regarding the normalized metric values of individual metrics. In this example, PFE 2 Metric 2 1314 has an alert icon 1380 to indicate to the user that there is a potential problem with this metric and/or with the component from which this metric was collected (i.e., PFE 2). The window 1390 presents the user with more detailed information regarding the alert of PFE 2 and the impact the metric has on the health of the entire LFE. In some embodiments, the window 1390 presents, to the user, (1) a potential problem that can arise if this metric does not improve, (2) a potential impact this metric may have on the composite component (e.g., the LFE) if not improved, and (3) a recommended action to improve the metric.

For example, if a number of data messages processed per second metric for a particular PFE is measured to be low (e.g., 10 data messages processed per second, instead of an average of 100 data messages per second), the normalized metric value for that metric will be low. The health analytics manager may alert the user of this low metric using an alert through a UI, and provide recommended actions to either improve the metric or to reconfigure the LFE such that it is not dependent on the particular PFE. For the metric 1314, the window 1390 identifies that (1) the potential problem is failure of PFE 2, (2) the potential impact is failure of the LFE, and (3) a recommended action is reconfiguring the LFE to be implemented by PFE 1 and PFE 3 instead of PFE 1 and PFE 2. In some embodiments, these alerts and information are displayed for any normalized metric values, secondary health scores, and final health scores presented in the UI 1304.

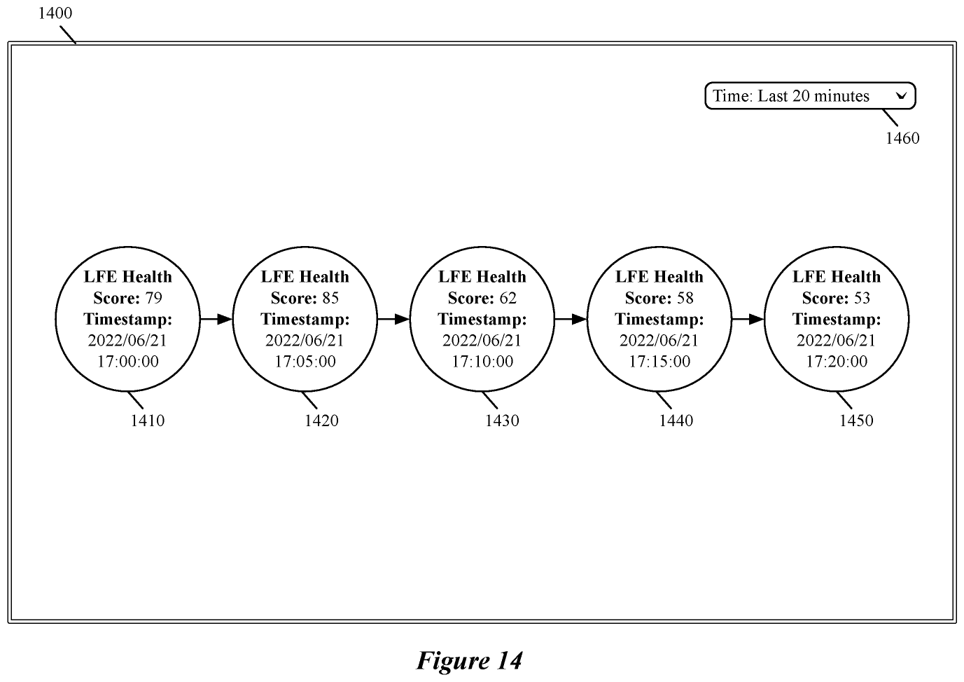

In some embodiments, a user utilizes a UI to view the health of a composite component over time. A user may call an API to the HMS to view health scores of a component over a specified period of time. FIG. 14 illustrates a UI 1400 to view a particular LFE's health over time. In some embodiments, an HMS stores all computed health scores for one component such that the health analytics manager of the HMS can present a historical view of the health scores in a UI. In this example, the UI 1400 displays five health scores 1410-1450 computed for one LFE. Each health score is presented along with a timestamp identifying the time at which the health analytics manager computed that health score. In some embodiments, the UI 1400 also provides the user with a filter 1460 to select a period of time for which to view health scores. In this example, the user has selected to view health scores computed for the LFE within the last 20 minutes.

Some embodiments generate a report for display (e.g., on a display screen through a UI or electronic communication (e.g., email, database query response, text message, etc.)) to show collected information regarding a component (such as an LFE, logical network, logical sub-network, data plane, control plane, or management plane). For example, a report in some embodiments specifies one or more health scores generated for the component, such as in FIGS. 13A-D and 14. In some embodiments, the report specifies various aspects of the component, such as (1) network performance issues, (2) malware, (3) vulnerabilities, (4) security issues, and (5) performance issues.

In some embodiments, the report is displayed to a network administrator for the network administrator to review the information specified in the report and perform one or more actions based on the information. The actions performed by the network administrator are performed to resolve any issues identified from the report information (e.g., any of the issues described above, such as network performance issues or security issues).

For example, the network administrator in some embodiments receives a report regarding a particular LFE. The network administrator uses UI tools (e.g., selectable items, popup windows) to examine the information compiled and/or generated for the LFE in order to identify the source or sources of a particular problem related to the LFE (e.g., a poor health score of the LFE due to a failure of a particular PFE, as shown in FIG. 13D). After identifying the source of the problem, the network administrator can take one or more actions to resolve the problem, such as reconfiguring the LFE to not be implemented by the failed PFE or to restart the failed PFE.

As another example, the network administrator in some embodiments examines a report regarding a logical switch, and identifies from the report that the logical switch is congested. After identifying the problem, the network administrator can add network resources (e.g., CPU, memory, etc.) to a set of one or more physical switches implementing the logical switch, or the network administrator can add more physical switches to the set of physical switches implementing the logical switch. Any suitable action to solve a problem identified from a report can be performed.

Conjunctively or alternatively to having a network administrator examine information in a report to perform actions based on the examination, some embodiments analyze collected data automatically by one or more automated software processes that, based on their analysis, either perform one or more actions to resolve any identified issues (e.g., network performance issues, vulnerabilities, security issues, etc.), or direct one or more other processes to perform the one or more actions to resolve the identified issues. For example, the automated software processes in some embodiments raise a flag, which causes the one or more other processes to perform one or more actions. Examples of the remediations or reconfigurations performed by the automated processes are similar to the examples of such remediations and reconfigurations performed by a network administrator (e.g., increasing the amount of resources (CPU, memory, etc.) for components such as PFEs, adding additional PFEs to a set of PFEs implementing an LFE, migrating the processing of a set of flows from one LFE to another LFE, etc.). In such embodiments, data analyzation and problem remediation operations are automated such that the network administrator does not have to manually examine data or perform actions based on any issues identified from examining data.

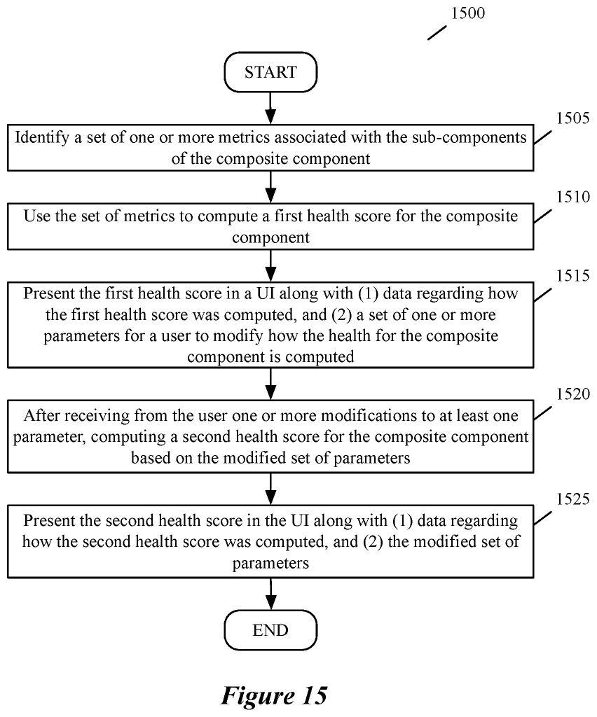

As discussed above, a UI may present to a user a composite component's health score and information regarding the computation of the health score. In some embodiments, the UI also provides the user with configurable parameters for modifying how the health score for a composite component is computed. FIG. 15 conceptually illustrates a process 1500 for monitoring the health of a composite component and modifying the computation of the composite component's health score. This process 1500 may be performed by a health analytics manager of an HMS, such as the health analytics manager 640 of FIG. 6, or may be performed by any suitable application or module. The process 1500 may be performed for health scores of any composite component, such as an SMN, a logical network or sub-network, or an LFE.

The process 1500 begins by identifying (at 1505) a set of one or more metrics associated with the sub-components of the composite component. The health analytics manager may identify these metrics from the TSDB of the HMS, or may identify them from any other data source. Next, the process 1500 uses (at 1510) the set of metrics to compute a first health score for the composite component. The health analytics manager may compute the first health score using the process 700 of FIG. 7, i.e., by computing normalized metric values and secondary health scores to compute the final health score (i.e., the first health score) for the component.

Next, the process 1500 presents (at 1515) the first health score in a UI along with (1) data regarding how the first health score was computed, and (2) a set of one or more parameters for a user to modify how the health for the composite component is computed. This information may be provided in a list, in a mapping or score tree, or in any suitable format. The health analytics manager provides this to a user in a UI for the user to view how the first health score was computed, and to modify any parameters used in computing the first health score. For example, the UI can display the weights used in the health score computation, and the UI can provide the user with parameters to modify the weights for future health score computations.

The UI can also display a list of the metrics used in computing the first health score, and the UI can provide the user with parameters to modify which metrics are included in the health score computation (e.g., adding or removing metrics from the computation). The UI may also provide parameters to modify the list of components considered for computing the health score. For example, the user can use the parameters to add or remove (1) components from an SMN health score computation (e.g., particular hosts, PFEs, etc.), (2) components from a logical network health score computation (e.g., particular logical switches, routers, gateways, etc.), and (3) components from an LFE health score computation (e.g., particular PFEs). Further information regarding the information displayed in the UI and the parameters will be described below.

After receiving from the user one or more modifications to at least one parameter, the process 1500 computes (at 1520) a second health score composite component based on the modified set of parameters. Upon reception of at least one modification to the set of parameters, the health analytics manager updates the parameters used in computing the composite component's health score and computes the second health score using those updated parameters. For instance, if the user modifies the weights assigned to the metrics, the health analytics manager computes the second health score using the new weights provided by the user. In some embodiments, the second health score is computed based on the same set of metrics used to compute the first health score. In other embodiments, the second health score is computed based on a different set of metrics. For example, if the HMS receives newly collected metrics from metrics collectors in the SMN after computing the first health score, the health analytics manager can use the new metrics to compute the second health score in order to better indicate the current health of the composite component.

Then, the process 1500 presents (at 1525) the second health score in the UI along with (1) data regarding how the second health score was computed, and (2) the modified set of parameters. The health analytics manager updates, in the UI, any parameters that the user modified to reflect the new parameters used in computing the second health score. The process 1500 then ends.

A user in some embodiments can use the UI to modify a variety of parameters used in computing the health score of a composite component. In some embodiments, all parameters used in computing a component's health score is able to be modified by the user. In other embodiments, only a subset of the parameters are able to be modified by the user. The parameters to be modified by the user can include any parameters related to a health score computation, such as (1) the weights used in the computation, (2) the techniques used to compute normalized metric values and health scores, (3) the metrics included in the computation, (4) the time interval at which the health score is periodically computed, (5) the threshold used to determine when the component is at risk and when to notify the user of a potential problem, etc.

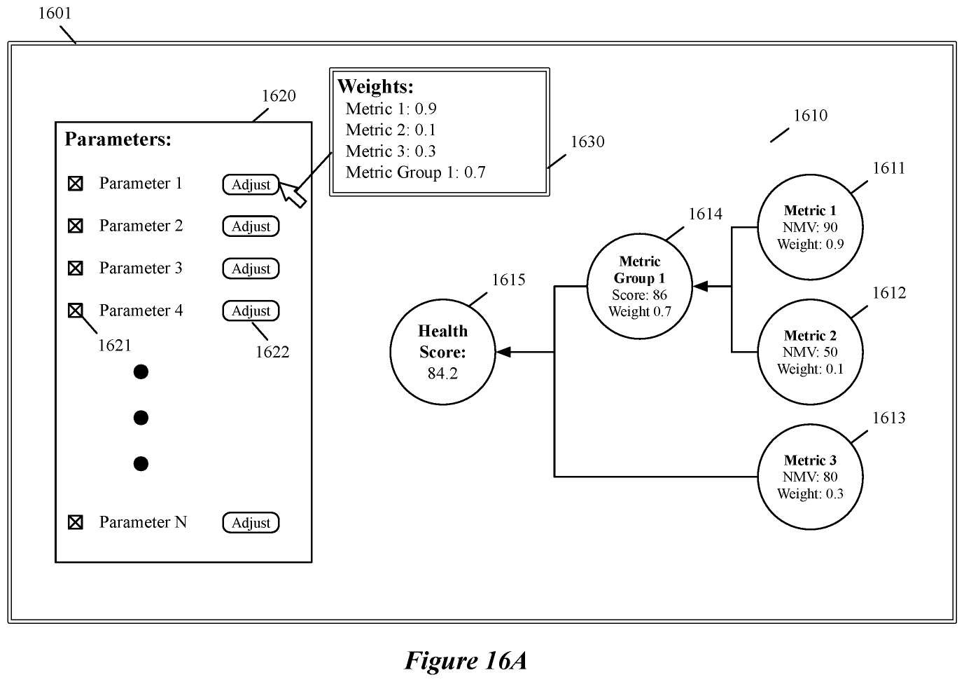

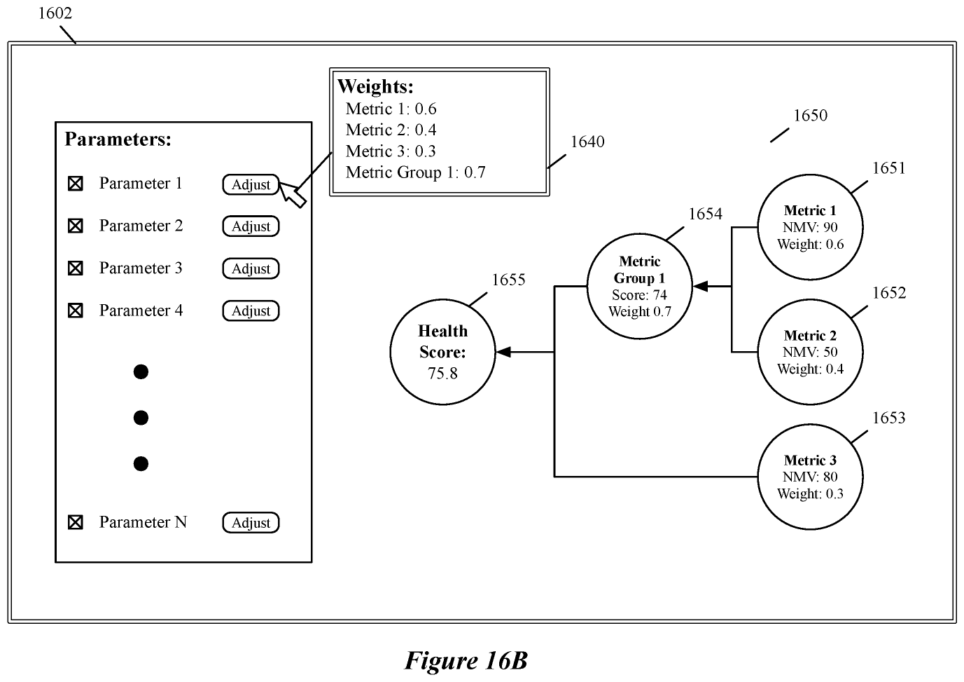

FIGS. 16A-B illustrate example UIs for modifying the weights used in the health score computation. In the example of FIG. 16A, the UI 1601 presents to the user a score tree 1610, with metric nodes 1611-1613, a metric group 1614, and a final health score 1615. The first metric node 1611 has a computed normalized metric value of 90 and an assigned weight of 0.9. The second metric node 1612 has a computed normalized metric value of 50 and an assigned weight of 0.1. The third metric node 1613 has a computed normalized metric value of 80 and an assigned weight of 0.3. The metric group 1614, which includes metrics 1611 and 1612, has a computed health score of 86 and an assigned weight of 0.7. The component's final health score, using the metric group 1614's health score and the third metric 1613's normalized metric value, has a computed value of 84.2.

Along with the score tree 1610, the UI 1601 also presents a list of parameters 1620 used in some embodiments for computing the component's health score. The UI 1601 may display any number of parameters 1-N used in computing health scores. For each parameter listed, a selectable item 1621 is presented, such that that user can control whether the parameter is included in the health score computation. For example, the list of parameters 1620 may list a parameter for creating and eliminating metric groups. When the selectable item 1621 for this parameter is selected (as denoted by an “X”), the health score computation will include any metric groups created by the user. When the selectable item 1621 is not selected (as denoted by an empty box), the health score will not be computed with any metric groups, meaning that the final health score will be computed based on the normalized metric values for all metrics based on their weights.

In some embodiments, the list of parameters 1620 also includes an “adjust” option 1622, for the user to adjust/modify any of the listed parameters 1620. Upon selection of a particular adjust option 1621, the UI 1601 displays a window 1630 to present the user with the details of the selected parameter and for the user to modify those parameters. In the example of UI 1601, the user has selected the weights parameter, and the window 1630 lists the weights assigned to the metrics 1611-1613 and to the metric group 1614. The user uses this window 1630 to change any of these weights.

FIG. 16B illustrates a UI 1602 after receiving a modification of the weights from the user. the window 1640 displaying the assigned weights now lists the updated weights provided by the user. After receiving an update of the weights from the user, the health analytics manager recomputes the health score using the updated weights and presents the new computation in the score tree 1650. The user has changed the weights assigned to Metric 1 1651 (from 0.9 to 0.6) and Metric 2 (from 0.1 to 0.4), which changes the secondary health score for Metric Group 1 1654 from 86 to 74, and the final health score 1655 from 84.2 to 75.8. The weight for Metric 3 1653 is unchanged, so this metric did not affect the updated health score 1655 differently than the previously computed health score.

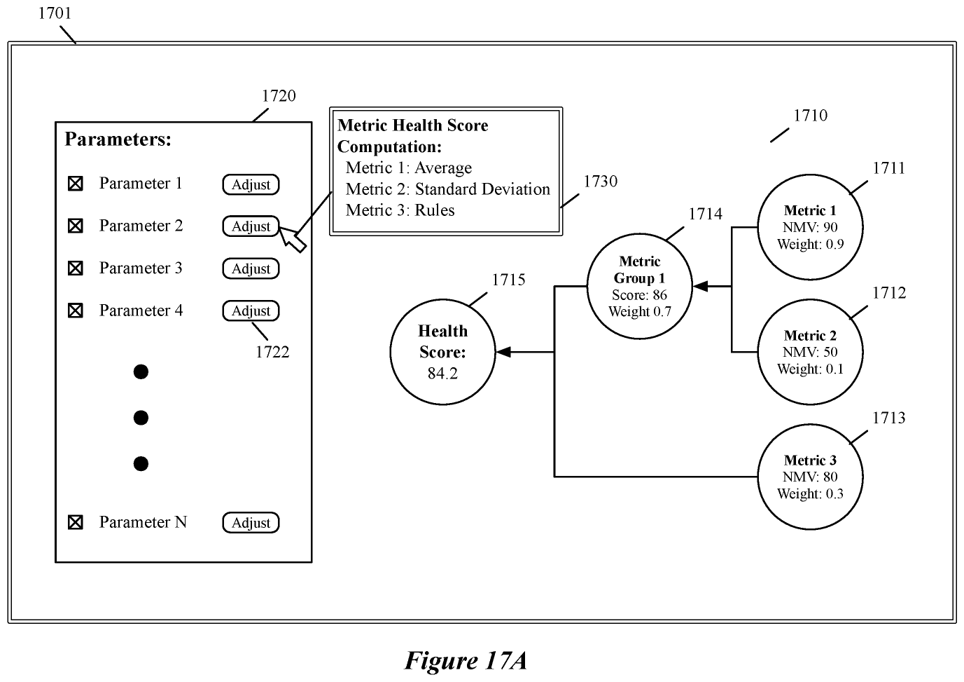

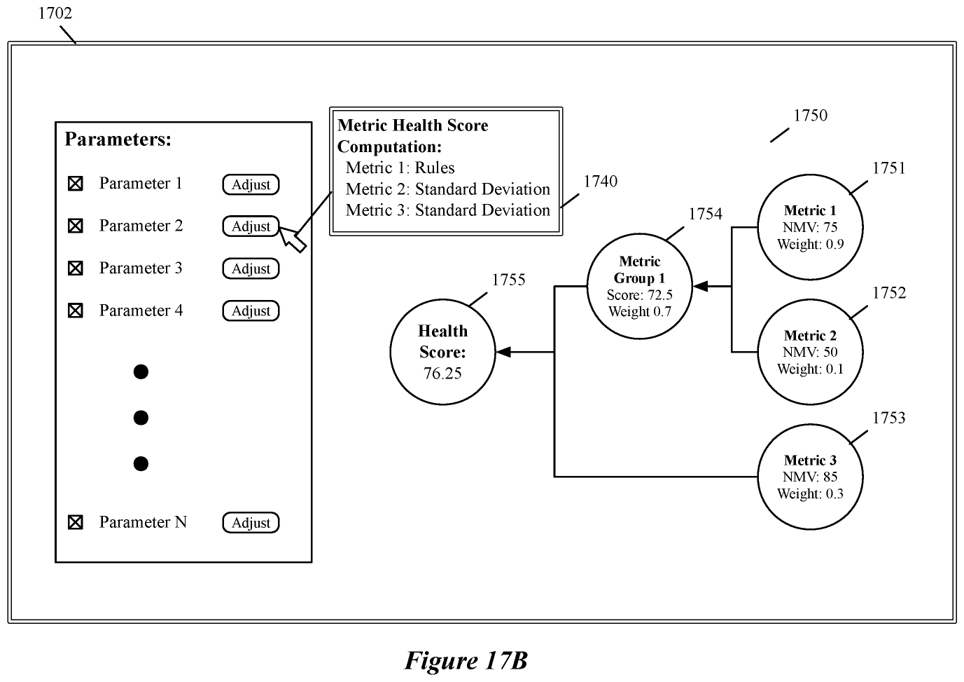

FIGS. 17A-B illustrate example UIs for modifying the techniques used in computing normalized metric values. FIG. 17A illustrates a UI 1701, with a score tree 1710 of metric nodes 1711-1713, a metric group node 1714, and a final health score 1715. Metric 1711 has a computed normalized metric value of 90 and an assigned weight of 0.9. Metric 2 1712 has a computed normalized metric value of 50 and an assigned weight of 0.1. Metric 3 1713 has a computed normalized metric value of 80 and an assigned weight of 0.3. Metric Group 1 1714 has a computed health score of 86 and an assigned weight of 0.7. The final health score 1715 is computed to be a value of 84.2.

In this example, a user has used the list of parameters 1720 and an adjust button 1722 of a parameter defining which technique is used in computing normalized metric values for each metric. The window 1730 displays the information regarding which technique was used for each of the three metrics, and lets the user modify which technique is used for each metric. In this example, Metric 1 1711 is associated with an averaging technique, which computes the metric's normalized metric value by dividing the collected metric by the metric's maximum value. Metric 2 1712 is associated with a standard deviation technique, which computes the metric's normalized metric values based on the metric's standard deviation. Metric 3 1713 is associated with a rules technique, which generates the metric's normalized metric value based on defined rules.

In some embodiments, the user can use the window 1730 to modify which technique is used for which metric. For example, Metric 1 1711 is listed to use an averaging technique. The window 1730 may let the user change Metric 1 1711's associated technique from the averaging technique to a rule technique. In some embodiments, the window 1730 also lets the user modify the specifics of each technique. For example, Metric 3 1713 is listed to use a rules technique, and the window 1730 may provide the user with the ability to modify the specific rules used in computing Metric 3 1713's normalized metric value.

FIG. 17B illustrates a UI 1702 after the user has modified these techniques. The window 1740 now lists Metric 1 1751 as being associated with a rules technique, and Metric 3 1753 as being associated with a standard deviation technique. The technique and the normalized metric value for Metric 2 1752 remains unchanged, meaning that the user did not modify this metric's parameter. After receiving the updated techniques, the health analytics manager recomputes the component's health score and displays the updated score tree 1750. The score tree 1750 now displays Metric 1 1751's normalized metric value as 75 (from 90), Metric 3 1753's normalized metric value as 85 (from 80), Metric Group 1 1754's health score as 72.5 (from 86), and the final health score 1755 as 76.25 (from 84.2). By changing the technique parameters, the final health score for the component has dropped, which the user can view using the UI 1702.

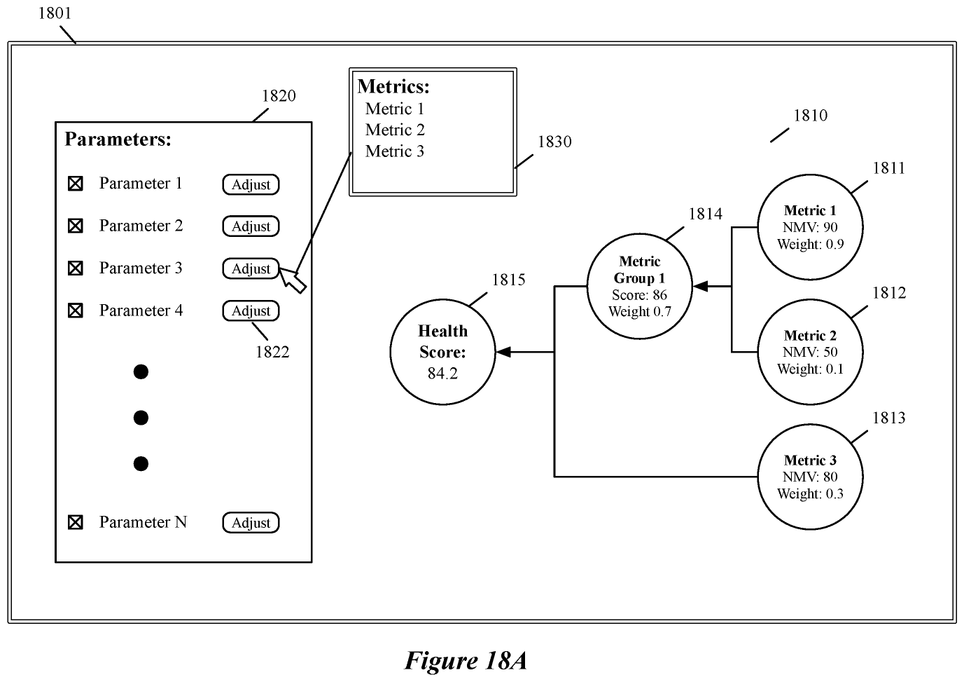

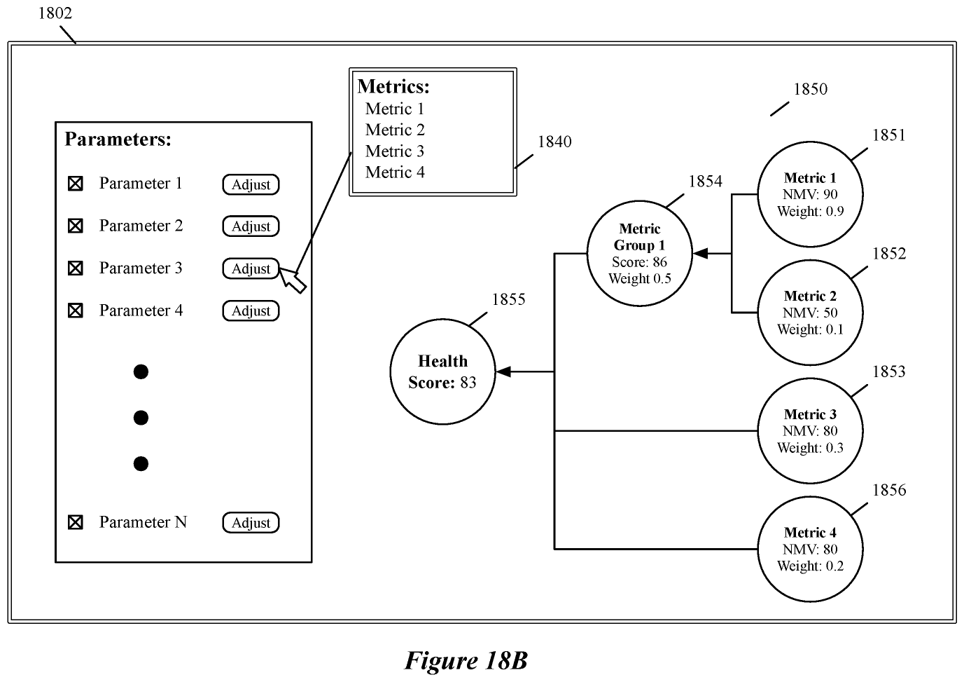

FIGS. 18A-B illustrate example UIs for modifying which metrics are included in a health score computation. FIG. 18A illustrates a UI 1801, which displays the score tree 1810 and the list of parameters 1820. The score tree 1810 includes three metric nodes 1811-1813, one metric group node 1814, and the final health score 1815. In this example, the user has used the list of parameters 1820 and an adjust button 1822 of a parameter defining which metrics are included in the health score computation. The window 1830 displays the list of metrics used in computing the component's health score, and the user may use this window 1830 to modify this list of metrics. For instance, the user can add metrics to or remove metrics from the health score computation. For example, for a logical network health score computation, if an LFE is removed from the logical network, the user can use this window 1830 to remove the metrics associated with that LFE so that the logical network's health score is not affected by metrics of the removed LFE. If a new LFE is added to the logical network, the user can use this window 1830 to add metrics associated with the new LFE so that the health of the new LFE is reflected in the final health score.

FIG. 18B illustrates a UI 1802 after the user has modified the list of metrics. The window 1840 now lists four metrics, indicating that the user added a new fourth metric to the health score computation. After receiving this modification, the health analytics manager computes the health score for the component using the new list of metrics and displays the updated score tree 1850. The first three metrics 1851-1853 and Metric Group 1 1854 remain unchanged. A new fourth metric 1856 is added to the health score computation, with a normalized metric value of 80 and an assigned weight of 0.2. As a result of this new metric 1856, the final health score 1855 has changed from 84.2 to 83.

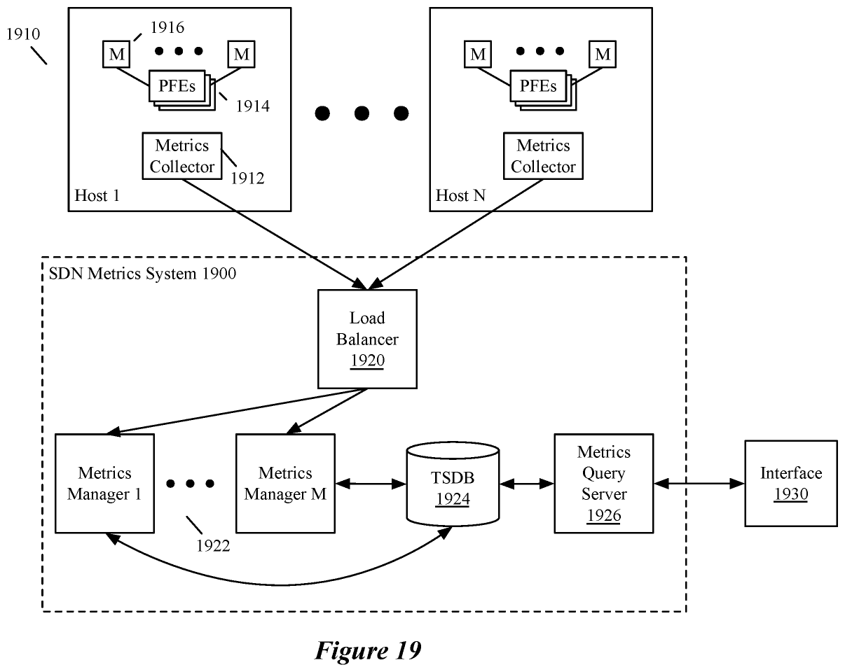

As discussed previously, metrics used for computing health scores are collected and stored by a health metrics server. These metrics can also be collected and stored to display in a UI upon user request. FIG. 19 illustrates an example SDN metrics collection system 1900 for collecting and storing metrics. This SDN metrics collection system 1900 collects metrics from metrics collectors, network managers, and/or other applications and modules for various SDN components, such as physical network elements, logical network elements, control plane components, data plane components, management plane components, etc. As shown, hosts 1910 each include a metrics collector 1912 for collecting metrics of the host and the host's components, i.e., the PFEs 1914 and machines 1916. In some embodiments, metrics collectors 1912 are referred to as data collectors that collect operational data. Any number of host computers hosting any number of PFEs and machines may include a metrics collector for collecting metrics for the SDN metrics system 1900. In some embodiments, hardware forwarding elements (HFEs) execute in the SDN. In such embodiments, a metrics collector of an SDN manager or controller cluster (not shown) collects the metrics for the HFEs.

Alternatively or conjunctively, one or more metrics collectors 1912 operating on one or more host computers 1910 are configured to collect metrics for the HFEs of the SDN. Still, in other embodiments, HFEs, such as edge devices, may have a metrics collector installed as a plugin to collect its metrics. The metrics collected for the SDN in some embodiments are collected periodically. For example, each metrics collector 1912 can collect metrics every five seconds, which are all provided to the SDN metrics system 1900. Some embodiments also or instead collect metrics using a push model, such as for event driven metrics. For instance, metrics collectors 1912 can be notified of new or changed metrics each time that metric's value changes. For example, a notification can be sent to a metrics collector when the connection status of the CCP changes instead of the metrics collector periodically checking the connection status of the CCP. By collecting metrics for the SDN, a user or administrator can query for metrics stored by the SDN metrics system 1900 over a particular period of time to view how one or more metrics have changed during that time period.

In some embodiments, the metrics collectors 1912 provide all metric data to the metrics collection system 1900 using Google Remote Procedure Calls (gRPC). In such embodiments, metrics are provided using the gRPC standard instead of using REST API calls because gRPC can overcome issues related to speed and weight, offering greater efficiency when providing the metrics to the metrics collection system 1900. The metrics are provided in some embodiments using a protocol buffer (Protobuf) format as opposed to a JSON format (used for REST API calls). Protocol buffers provide the efficiency and speed of using gRPC for sending metrics because data is compressed.

Metrics collected by the metrics collectors 1912 are provided in some embodiments to a load balancer 1920 of the SDN metrics system 1900. In some embodiments, the metrics collectors 1912 report metrics to the load balancer 1920 at periodic intervals specified by a user or administrator (e.g., every minute). The load balancer 1920 is a service that distributes the collected metrics among one or more metrics managers 1922. The metrics system 1900 may include any number of metrics managers 1922. In some embodiments, the metrics collectors 1912 provide the metrics along with entity universally unique identifiers (UUIDs) identifying the entity/resource/network element that is associated with it.

The load balancer 1920 of some embodiments equally distributes the metrics among the metrics managers 1922 in order to help prevent a metrics manager from being overloaded while one or more other metrics managers are being underutilized. In some embodiments, the load balancer 1920 provides different sets of the metrics to the different metrics managers 1922, such that all metrics for each particular SDN component (e.g., a particular LFE, a particular host computer 1910, etc.) are only provided to one metrics manager 1922. By doing so, one metrics manager of the metrics manager set 1922 receives all metrics for a particular component, rather than metrics for the particular component being distributed to different metrics managers. The load balancer 1920 of some embodiments receives metrics collected at regular intervals, so the load balancer 1920 must send related metrics collected at different times to the same metrics manager to ensure that only one metrics manager is handling these related metrics.

In some embodiments, one metrics manager of the set 1922 is designated as a primary metrics manager, while the other metrics managers of the set 1922 are designated as secondary metrics managers. In such embodiments, the primary metrics manager may receive metrics designated as critical metrics by a user or administrator, while the secondary metrics managers receive the rest of the collected metrics for the SDN. Alternatively, the primary metrics manager may receive all metrics collected for the SDN, and upon failure or congestion of the primary metrics manager, the load balancer 1920 would provide the SDN's metrics to one or more secondary metrics managers.

Each metrics manager 1922 receives metrics collected for the SDN and stores them in a TSDB 1924. In some embodiments, the metrics managers 1922 perform periodic rollups on the metrics. For example, a metrics manager 1922 may receive the same latency metric for a particular network element every five seconds. These metrics are stored in the TSDB 1924 until an aggregation timer fires, however, in some embodiments, the raw (i.e., collected) metrics are stored in a local memory until the aggregation timer fires. Once the timer fires, the metrics manager 1922 aggregates (i.e., averages) all of these latency metrics up to five minutes, and stores the five-minute level metrics in the TSDB 1924. For example, a metrics manager may average 20 memory usage metrics for a host collected at five-second intervals into one memory usage metric for that host. In some embodiments, the metrics managers 1922 aggregate metrics even further, and retrieve metrics from the TSDB 1924 once a second aggregation timer fires. For example, the metrics manager 1922 may aggregate five-minute metrics up to one-hour metrics, and then one-hour metrics up to one day. In doing so, the TSDB 1924 does not have to store lower aggregation-level metrics for an extended period of time, saving storage space in the TSDB 1924.

The metrics managers 1922 of some embodiments aggregate metrics across one or more dimensions, such as time, reporters, entities, etc. The TSDB 1924 stores the metrics (and/or the aggregated metrics) from the metrics managers 1922 in a set of tables. In some embodiments, where periodic rollups of metrics are performed, the TSDB 1924 deletes smaller increment metrics after they have been aggregated. For instance, if a set of five-minute metrics are aggregated to one-hour metrics, the TSDB 1924 may delete the five-minute metrics. In some embodiments, the TSDB 1924 stores different aggregation level metrics in separate tables, such that, when lower aggregation-level metrics are to be deleted, the TSDB 1924 deletes the entire table instead of individual rows of one larger table. Further information regarding storing metrics in a TSDB will be described below.

In some embodiments, a user can request certain metrics for the SDN from a metrics query server 1926. Through the interface 1930, a user sends a REST API request to the metrics query server 1926, which retrieves the metrics from the TSDB 1924 and provides the requested metrics back through the interface 1930. In some embodiments, metrics are only provided to a user upon request for the metrics. In other embodiments, the metrics are pushed to the user without having to receive a request. A user of some embodiments has role-based access control (RBAC) access to a specific entity, meaning that the user has read access to it. In such embodiments, the user can request the metrics for that entity along with any other entities for which the user has access. In some embodiments, a user requests from the metric query server 1926 the available metrics for an object type instead of metrics associated with a particular network element. For example, the user may request all available CPU utilization metrics. A user may also request all metrics collected during a specific period of time. Regardless of what types of metrics the user requests, metrics are all provided with timestamps in some embodiments.

Although the above-described embodiments discuss collection operational data regarding SDN network elements (e.g., managed forwarding elements such as managed software switches and routers, or standalone switches and routers), one of ordinary skill in the art will realize that other embodiments collect operational data regarding the machines (e.g., VMs or Pods) that run on the host computers of an SDDC or the applications that operate on such machines in the SDDC.

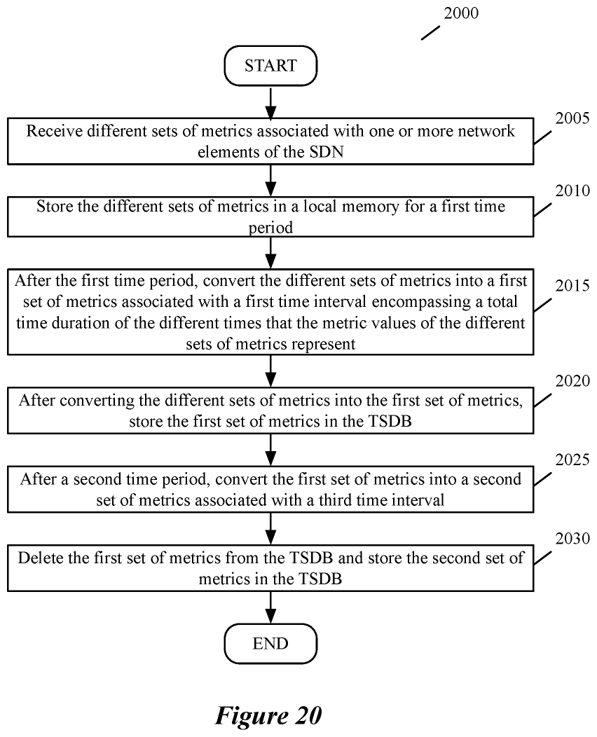

As discussed previously, metrics collected for an SDN are in some embodiments stored in a TSDB. FIG. 20 illustrates a process 2000 for collecting and storing metrics associated with an SDN. This process 2000 may be performed by a metrics manager of a set of metrics managers, such as the metrics managers 1922 of FIG. 19. The process 2000 begins by receiving (at 2005) different sets of one or more metrics associated with one or more network elements of the SDN. In some embodiments, each received set of metrics includes metrics of a same set of one or more metrics types, and different sets of metrics represent metric values for the set of metric types at different times. For instance, the metrics manager can receive different latency metrics for a particular network element with the latency metric measuring the latency of the particular network element at a different time.

These different sets of metrics are received by the metrics manager from a load balancer, such as the load balancer 1920, which distributes different sets of metrics among the different metrics managers. In some embodiments, the received sets of metrics include metrics for only one network element, such as for one LFE of the SDN or for the control plane of the SDN. In other embodiments, the received sets of metrics include metrics for multiple network elements. The different sets of metrics in some embodiments include metrics that were collected for a first time duration. For example, each metric in the sets may be collected by metrics collectors operating in the SDN at five-second time intervals, such that a particular type of metric for a particular network element is collected every 5 seconds.

Next, the process 2000 stores (at 2010) the different sets of metrics in a local memory for a first time period. In some embodiments, each metrics manager stores received metrics in a local memory until they have been aggregated, and the aggregated metrics are stored in a TSDB. This is performed such that the TSDB does not store too many low level metrics, namely metrics that represent a short time duration and do not represent a value of that metric over a long period of time. In some embodiments, instead of storing the different sets of metrics in a local memory, the metrics manager does store them in the TSDB along with any aggregated metrics. The first time period is in some embodiments proportional to the time duration associated with the metrics. For example, the received sets of metrics can include metrics that represent values for that metric for five-second time intervals, so the first time period is five minutes. If the received sets of metrics include metrics that represent values for that metric for five-minute time intervals, the first time period would be one hour.

After the first time period has passed, the process 2000 converts (at 2015) the different sets of metrics into a first set of metrics associated with a first time interval encompassing a total time duration of the different times that the metric values of the different sets of metrics represent. Once the first time period has passed since the metrics manager received the different sets of metrics, the metrics manager converts the metrics in the sets so that they represent average values of the metrics for the first time interval. For instance, if the sets of metrics include five-second metrics, after five minutes, the metrics manager averages the values of the metrics to represent the average value of each metric over a five-minute interval of time. For each metric type in the set of metric types and for each network element associated with the sets of metrics, the metrics manager averages each metric of the metric type for the network element into a single metric to represent an average value of the metric type for the network element during the first time interval. For example, if the different sets of metrics include 60 separate latency metrics collected for a particular PFE, after 5 minutes, the metrics manager averages those 60 metrics into a single metric to represent the average latency of the particular PFE during the five total minutes the 60 metrics were collected.

After converting the different sets of metrics into the first set of metrics, the process 2000 stores (at 2020) the first set of metrics in the TSDB. The TSDB stores all metrics that were converted into aggregated metrics by the metrics managers. These metrics are stored in the TSDB for a metrics query server, such as the metrics query server 1926, to retrieve the metrics upon user request. The metrics can be stored in the TSDB for use by a user. The user can request these metrics for a variety of reasons, such as to monitor the performance of the SDN and/or its components, to monitor the health of the SDN or its components, to predict future metrics of the SDN or its components, etc.

After a second period of time has passed, the process 2000 converts (at 2025) the first set of metrics into a second set of metrics associated with a second time interval. The second period of time is in some embodiments longer than the first period of time because the second period of time is related to the first time interval of the first set of metrics. For example, after one hour, the metrics manager retrieves the five-minute metrics from the TSDB and converts them to represent the average value of each metric over a 24-hour period of time. Using the example given above, the metrics manager retrieves any five-minute latency metrics stored in the last hour for the particular PFE and converts them into a single latency metric averaging the latency of the PFE over the last day.

Once the second set of metrics has been created, the process 2000 deletes (at 2030) the first set of metrics from the TSDB and stores the second set of metrics in the TSDB. Once lower-aggregation level metrics have been converted into higher-aggregation level metrics, the lower-aggregation level metrics are not necessary to be stored. Hence, the metrics manager deletes the first set of metrics from the TSDB and replaces it with the second set of metrics. In different embodiments, the metrics managers are configured to convert metrics sets as described above for more or less than two iterations. Once the metrics have been converted into the highest aggregation level, the process 2000 ends.

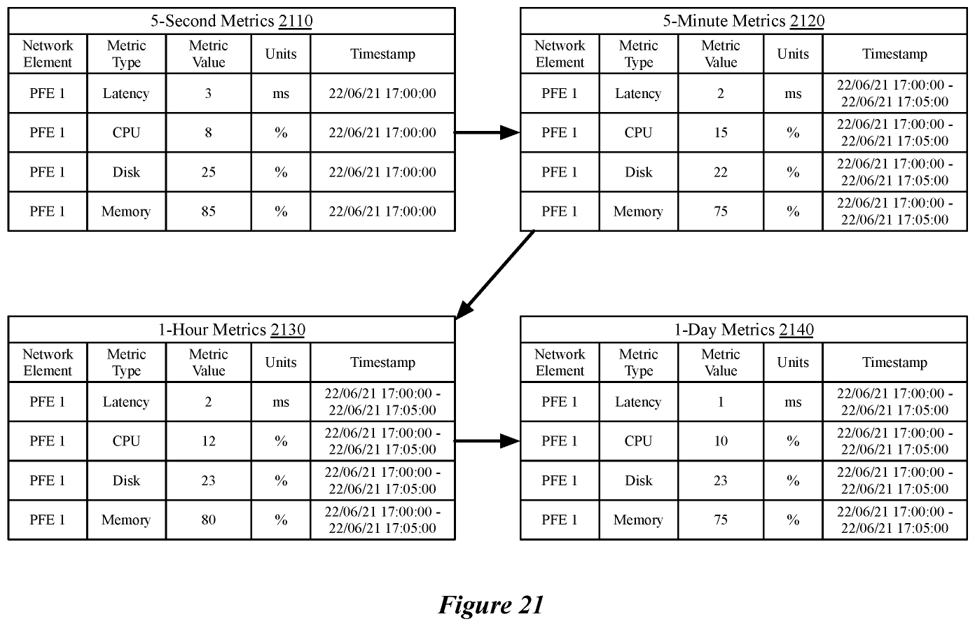

FIG. 21 illustrates example tables 2110-2140, stored in a TSDB, that store metrics regarding a particular PFE. In some embodiments, these metrics are all collected and aggregated by one metrics manager. In other embodiments, different types of metrics for the particular PFE are collected and aggregated by different metrics managers. For example, a first metrics manager can collect and aggregate latency metrics for the PFE, while a second metrics manager collects and aggregates disk usage metrics for the PFE. In this example, each table 2110-2140 is organized to include only metrics for the particular PFE (and not any other network elements) collected or aggregated for a particular time period. By organizing tables this way, as metrics are aggregated and stored at a higher aggregation level, lower-aggregation level metrics can be deleted by entire rows of tables, or by entire tables completely. In some embodiments, a table storing metrics includes an identifier to identify the network element (e.g., the network element name or an entity UUID), the metric type, the metric value, the units of the metric, and the timestamp associated with the metric. In other embodiments, the table also includes an identifier for the node or host on which the network element resides (i.e., a node ID).

In this figure, a first table 2110 includes raw five-second metrics collected for the PFE. These metrics include values for the PFE's latency, CPU utilization, disk utilization, and memory utilization. Each of these metrics were collected at the same time, as identified by the timestamp. In some embodiments, one or more metrics managers retrieve these metrics along with other five-second metrics of the same metric type of the PFE to aggregate them into five-minute metrics. After five minutes and once the metrics have been aggregated to this second aggregation level, the first table 2110 can be deleted from the TSDB. The second table 2120 includes average metrics for the PFE computed from metrics collected during the specified timestamp, spanning five minutes. As shown, the PFE's average latency, disk usage, and memory utilization during this time period are lower than the raw metrics shown in table 2110. However, the PFE's average CPU utilization metric is higher than the raw metric shown in table 2110. This shows that the PFE's CPU utilization has increased since the first raw metric was collected.

After one hour and once these aggregated metrics are averaged with other metrics of the same metric type for the PFE, one or more metrics managers can store one-hour metrics in table 2130 and can delete table 2120. This table 2130 shows the average metrics for the PFE over the specified one-hour time period. As shown, the average latency has not changed, while the average CPU utilization has decreased and the average disk utilization and memory utilization have increased. In some embodiments, this table 2130 storing one-hour average metrics for the PFE is deleted after one day, after one or metrics managers have aggregated one-hour metrics for the PFE into one-day metrics.

Table 2140 includes average metrics for the PFE for the specified one-hour time period. As shown, the PFE's average latency during this one-day period is a value of 1 ms (millisecond), the average CPU utilization is 10%, the average disk usage is 23%, and the average memory utilization is 75%. In some embodiments, tables storing one-day metrics, such as table 2140, are stored in the TSDB for one year. In other embodiments, they are stored until they are deleted by a user or administrator.

In some embodiments, each table stored in a TSDB is assigned a timeout age related to the metrics' time period length. For example, 5-second metric tables are assigned a one-hour timeout age, five-minute metric tables are assigned a one-hour timeout age, one-hour metric tables are assigned a one-day timeout age, and one-day metric tables are assigned a one-year timeout age. Time periods associated with metrics and timeout ages for metric tables can vary in different embodiments.

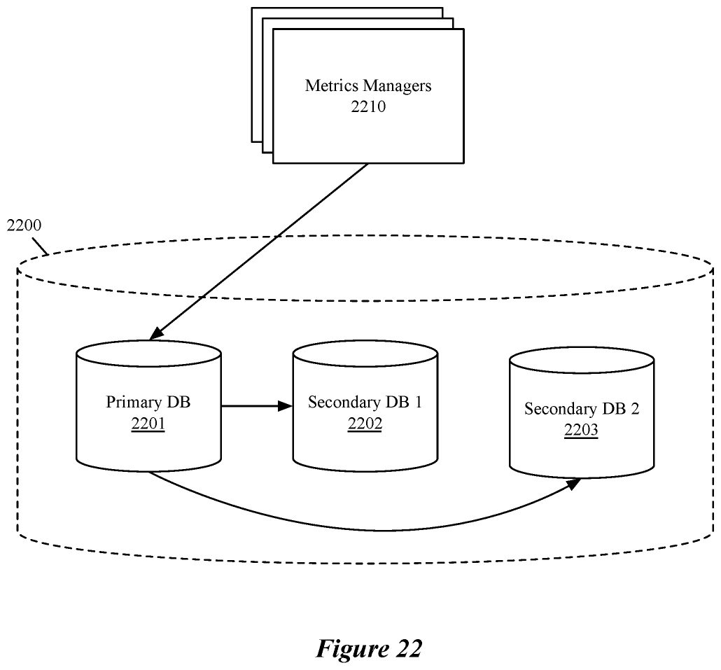

In some embodiments, a TSDB includes a cluster of databases where metrics managers store the metrics. FIG. 22 illustrates an example TSDB 2200 that includes three instances 2201-2203 (also referred to as nodes of the TSDB 2200). A set of one or more metrics managers 2210, similarly to the metrics managers 1922, store metrics in the TSDB 2200. However, in this example, the instances 2201-2203 of the TSDB 2200 are configured in a high-availability (HA) format, with a first instance 2201 designated as the primary database and second and third instances 2202 and 2203 designated as secondary databases. Here, the metrics managers 2210 store all metrics in the primary database 2201. The secondary instances 2202 and 2203 are treated as replicas of the primary database 2201, so the primary database 2201 replicates all data that it stores to the second and third instances 2202 and 2203. Organizing the TSDB 2200 in this HA configuration ensures that metrics are not lost due to database failure or accidentally deleted completely.

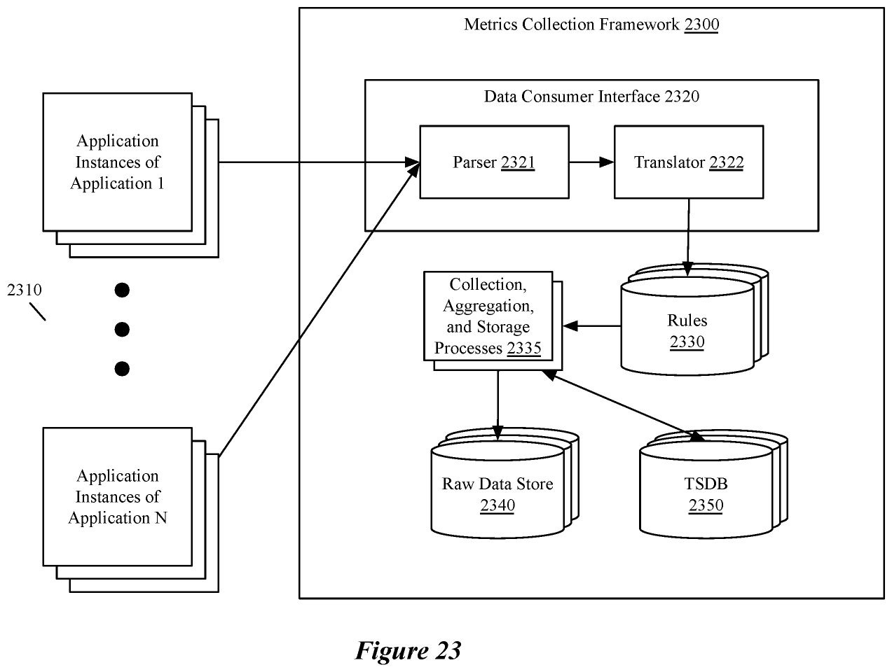

In some embodiments, metrics can be aggregated for different applications (i.e., different consumers) based on different aggregation criteria. FIG. 23 illustrates an example metrics collection framework 2300 for collecting, aggregating, and storing metrics for different application instances of applications 2310 of a set of SDDCs. A set of SDDCs can include any number of application instances for any number of client applications (also referred to as consumers, vendors, application developers, administrators, etc.). In different embodiments, different client applications can require (1) different collection criteria for collecting different types of operational data for the different client applications, (2) different aggregation criteria for aggregating the operational data differently for the different client applications, (3) different storage criteria for storing aggregated operational data for the different client applications, or (4) a combination thereof.

For example, the framework deployed for collecting, aggregating, and storing operational data for these client applications can allow different client applications to only specify different aggregation criteria. Alternatively, the framework can allow the different client applications to specify both different aggregation criteria and different storage criteria. In some embodiments, collection, aggregation, and/or storing criteria is the same for all client applications, meaning that client applications cannot specify different criteria for each of collecting, aggregating, and storing. For example, the framework can allow different client applications to specify different collection and aggregation criteria, but aggregated operational data for each client application is stored according to a same set of storing criteria.

Different collection criteria can include different types of operational data to collect for different network elements in the SDN. For instance, while a particular metric type is required for collecting for a first client application, it may not be required for a second client application. Hence, the first client application would have requirements to collect metrics of that particular type, while the second client application would not require that metrics of that particular type be collected for it. Different aggregation criteria can include different ways or methods of aggregating collected operational data. For example, one client application can require that all metrics be averaged over a specific time period, while a different client application can require that all metrics are taken to be the maximum value of that metric over a specific period of time (e.g., of three metrics collected during a particular time period are valued at 20, 30, and 50, the aggregated metric for these three values would be 50 since the requirements require using the maximum value). different storage criteria can include different time periods for storing different aggregation levels of operational data, or different databases for storing different aggregation levels of operational data. For example, a first client application can require that three particular aggregation levels of the operational data are stored for three particular time periods, while a second client application can require that the same three particular aggregation levels of operational data be stored for three different particular time periods than required by the first client application.

In some embodiments, a client application can include several application instances that implement the client application. Requirements of the different client applications in some embodiments includes functional requirements (also referred to as operational requirements) of the different client applications. In some embodiments, the network elements of the SDN for which operational data is being collected for the different client applications are managed network elements that are managed by at least one of a set of network managers and a set of network controllers of the SDN. These network managers and network controllers can manage and control the entire SDN and its network elements. The managed network elements in some embodiments include at least one of managed software network elements executing on host computers and managed hardware network elements in the SDN. For example, the set of network elements can include LFEs implemented on host computers, software PFEs implemented on host computers, and/or hardware standalone PFEs (e.g., edge devices or appliances) in the SDN. In some embodiments, data collectors are deployed as plugins on the host computers and hardware PFEs in the SDN to collect operational data for the SDN.

In some embodiments, each client application requires different criteria for aggregating metrics associated with one or more network elements in an SDN. For instance, a first client application may require a first set of aggregation criteria for the network elements, while a second client application requires a different, second set of aggregation criteria for the network elements. For example, the first consumer may require that all metrics be aggregated according to metric type in order to generate average metrics of each metric type, while the second consumer requires that all metrics be aggregated to indicate the maximum values for each metric of each metric type. Any suitable criteria for aggregating, combining, or analyzing metrics may be used.

Collection, aggregation, and/or storage criteria is provided for each application instance 2310 to a data consumer interface 2320 of the metrics collection framework 2300. In some embodiments, this interface 2320 is deployed for different client applications to use in order to configure the framework to collect and aggregate operational data based on their different criteria that satisfies different requirements of the different client applications. In different embodiments, the criteria is specified differently, such as database rules, database queries, data expressed in high level intent-based code, etc. In some embodiments, the criteria is provided in an API request. This API request may be an intent-based hierarchical API request that needs to be parsed by the data consumer interface 2320. A parser 2321 of the data consumer interface 2320 receives the API request, and parses the API request to extract the criteria for each application instance 2310. In some embodiments, the parser 2321 provides the criteria to a translator 2322 in order to define collection, aggregation, and storage rules based on the criteria. These rules can be stored by the metrics collection framework 2300 in a rule store 2330 to use to collect, aggregate, and store metrics for the application instances of each application 2310. In some embodiments, the framework 2300 includes one rule store 2330 for storing all rules for each application instance 2310. In other embodiments, the framework 2300 includes a separate rule store 2330 for each set of rules for each application instance 2310.

In some embodiments, collection, aggregation, and storage processes 2335 use the rules stored in the store 2330 to collect, aggregate, and store metrics of the SDN's network elements for the application instances 2310 based on their specified criteria. These processes 2335 may be similar to the metrics collectors and metrics managers as described above, which collect raw metrics and aggregate them into aggregated metrics for storing. The processes 2335 include metrics collectors operating on one or more host computers and/or hardware physical forwarding elements (e.g., edge devices) in the SDN. In some embodiments, a metrics collector is deployed as a plugin on each host computer and/or each hardware physical forwarding element (e.g., an edge device) in the SDN to collect metrics for the host computer or edge device on which it is deployed.

These raw metrics are stored in a raw data store 2340, which is a volatile memory of the metrics collection framework 2300. This local memory 2340 of the framework 2300 stores raw metrics until they are aggregated. In some embodiments, the framework 2300 includes one raw data store 2340 for storing all raw metrics. In other embodiments, the framework 2300 includes a set of raw data stores 2340 for storing different sets of raw metrics in different stores. For example, one client application may require a first set of operational data to be collected, while a second client application requires a different, second set of operational data. The framework 2300 can store these different sets of operational data in different stores 2340 in order to organize the raw metrics by client application.

Once the aggregation processes 2335 have aggregated metrics up at least one aggregation level, the aggregated metrics are stored in the TSDB 2350, which is a non-volatile memory of the framework 2300. The rules in some embodiments are also stored in the TSDB 2350 along with the aggregated metrics. In some embodiments, the framework 2300 includes one TSDB 2350 for storing all aggregated metrics for all application instances 2310. In such embodiments, the TSDB 2350 can be organized such that each aggregation level of operational data for each client application is stored in its own separate table. In other embodiments, the framework 2300 includes a separate TSDB for each client application in order to efficiently organize the data.

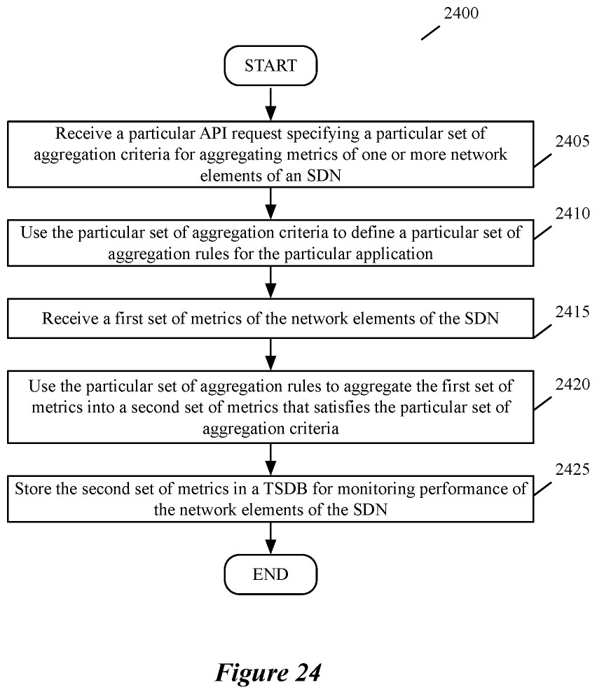

As discussed previously, a metrics collection framework, such as the framework 2300, aggregates metrics of network elements in an SDN for multiple client applications. FIG. 24 conceptually illustrates a process 2400 for aggregating metrics at a metrics collection framework in an SDN. This process 2400 may be performed for client applications associated with different aggregation criteria for aggregating metrics. A metrics collection framework can perform this process 2400 for any client application that it aggregates and stores metrics for, and will be described for a particular client application of the SDN.

The process 2400 begins by receiving (at 2405) a particular API request specifying a particular set of aggregation criteria for aggregating metrics of one or more network elements of an SDN. The metrics collection framework parses the particular API request to extract the particular set of aggregation criteria. In some embodiments, the framework can receive collection, aggregation, and/or storage criteria for the application. Next, the process 2400 uses (at 2410) the particular set of aggregation criteria to define a particular set of aggregation rules for the particular application. The metrics collection framework of some embodiments translates the extracted set of aggregation criteria into the particular set of aggregation rules.

In some embodiments, the metrics collection framework has a data consumer interface that includes a parser and a translator for parsing and translating API requests regarding criteria for applications. The parser receives the particular API request and extracts the particular set of aggregation criteria. Then, the translator uses the particular set of aggregation criteria to define the particular set of aggregation rules. This set of aggregation rules is stored by the metrics collection framework to use to aggregate metrics for the particular application. The aggregation rules can define rules for aggregating metrics based on time, host computer (or node), entity, object, or any suitable dimension for aggregating metrics. These different aggregations can be performed to compute an average, sum, maximum, or minimum value for the specified dimension. For aggregations performed for dimensions other than time, some embodiments aggregate metrics first across time and then across the specified dimension. In some embodiments, multiple aggregation rules can reference a single metric such that one collected metric can be used for multiple aggregations.

In some embodiments, the particular set of aggregation criteria includes criteria for aggregating metrics of a same metric type associated with a particular network element in the SDN. For example, the particular network element can be a particular LFE implemented by several PFEs executing in the SDN. In some embodiments, this LFE can be implemented by PFEs executing on one host computer. In other embodiments, this LFE can be implemented by PFEs executing on multiple host computers. In these embodiments, the multiple host computers can operate in one or more datacenters, or can operate in one or more physical sites.

For the particular LFE, the metrics of the same metric type can include performance metrics for each PFE such that the particular set of aggregation criteria requires the performance metrics for each PFE to be averaged into one or more performance metrics to represent an overall performance of the LFE. For example, if the first set of metrics includes five memory utilization metrics for five different PFEs that implement the particular LFE, the aggregation criteria can require that these five memory utilization metrics be averaged into a single value to represent the average memory utilization for the particular LFE. Metrics for the particular LFE can include one or more of (1) latency metrics, (2) memory usage metrics, (3) central processing unit (CPU) metrics, (4) throughput metrics, (5) packet processing usage metrics for each PFE, and any metrics suitable for a PFE.

As another example, the particular network element can be a distributed firewall implemented across a set of one or more host computers in the SDN. In some embodiments, a firewall is implemented on at least two host computers, and metrics associated with that firewall are collected at these multiple host computers. Hence, there are several metrics of a same type for the distributed firewall because the same type of metric is collected at different host computers. In such embodiments, the particular set of aggregation criteria can require the metrics for the distributed firewall at each of the set of host computers to be averaged into one or more metrics to represent an overall performance of the distributed firewall. By doing so, the second set of metrics can include one metric of each metric type for the distributed firewall overall, instead of several metrics of each metric type for each host on which the distributed firewall is implemented. The method for a distributed firewall can include one or more of (1) a number of data messages allowed by the distributed firewall at each host computer, (2) a number of data messages blocked by the distributed firewall at each host computer, (3) a number of data messages rejected by the distributed firewall at each host computer, or any suitable metrics for a firewall.

The process 2400 receives (at 2415) a first set of metrics of the network elements of the SDN. Metrics collectors operating as plugins on host computers and/or hardware physical forwarding elements in the SDN collect metrics and provide them to the metrics collection framework. These metrics collectors collect the raw metrics and provide them for aggregation and storage by the framework. After receiving the first set of metrics, the process 2400 uses (at 2420) the particular set of aggregation rules to aggregate the first set of metrics into a second set of metrics that satisfies the particular set of aggregation criteria. In order to create different representations of the collected raw metrics according to the aggregation criteria, the metrics collection framework uses the aggregation rules to create the second set of metrics. For example, if the first set of metrics includes metrics regarding total CPU cycles, idle cycles, and busy cycles, and the aggregation criteria requires that the average usage percentage, the top used core, the mean usage of a core, the lifetime sum, and/or an aggregate value be computed from the raw metrics, the framework computes these values.

As discussed previously, aggregation criteria can specify aggregating metrics across time, node, entity, object, or any other suitable dimension, and for multiple types of values, such as an average, sum, maximum, or minimum. For example, if metrics for two nodes valued at 112.5 and 75 are collected, and the aggregation rules specify that the aggregation for these metrics is a sum of the average across time for all nodes, the resulting aggregated metric would be 187.5. If metrics collected for two objects are valued at 250 and 200, and the aggregation rules specify that the aggregation for these objects is the maximum, the resulting aggregated metric for the two objects is 250.

After creating the second set of metrics, the process 2400 stores (at 2425) the second set of metrics in a TSDB for monitoring performance of the network elements of the SDN. The aggregated metrics are stored in a non-volatile memory of the metrics collection framework in order to be requested for and viewed by a user. By computing different representations of raw metrics and storing them in the TSDB, the framework can provide the different representations to users so the users can view these values without having to compute them in real-time. After the second set of metrics is stored in the TSDB, the process 2400 ends.

In some embodiments, the API request specifying the aggregation criteria is a first API request, and the metrics collection framework receives a second API request from a user through an interface or a UI requesting to view at least a subset of the second set of metrics in the UI. This second API request may be received by a data consumer interface of the framework, or a metrics query server, which retrieves the requested metrics from the TSDB, and presents the requested metrics in the UI for the user to monitor the performance of the particular application. The second API request from the user in some embodiments specifies a name of the particular application, and retrieving the at least subset of the second set of metrics includes retrieving a UUID associated with the name of the particular application from a data storage to use to retrieve the subset of the second set of metrics from the TSDB.

This data storage in some embodiments stores several names and their associated UUIDs in order to perform this mapping lookup. In some embodiments, an API request specifies the name of the network element for which metrics are requested, but does not specify the UUID necessary for retrieving those metrics. In such embodiments, a lookup is performed to map the network element's name with its associated UUID, and the metrics for that network element can then be retrieved using the UUID. In some embodiments, the first API request specifying the aggregation criteria also specifies the network element's name and a UUID lookup is performed in order to associate the aggregation criteria with the correct application.

In some embodiments, raw metrics are collected and aggregated, and the aggregated metrics are stored for monitoring and/or analyzing of the network elements associated with the metrics. A user can request to view any of the stored aggregated metrics in a UI. The UI can present these metrics in various representations, as requested by the user or as configured by an administrator. Further information regarding presenting metrics will be described below. Although the above-described embodiments discuss collection operational data regarding SDN network elements (e.g., managed forwarding elements such as managed software switches and routers, or standalone switches and routers), one of ordinary skill in the art will realize that other embodiments collect operational data regarding the machines (e.g., VMs or Pods) that run on the host computers of an SDDC or the applications that operate on such machines in the SDDC.

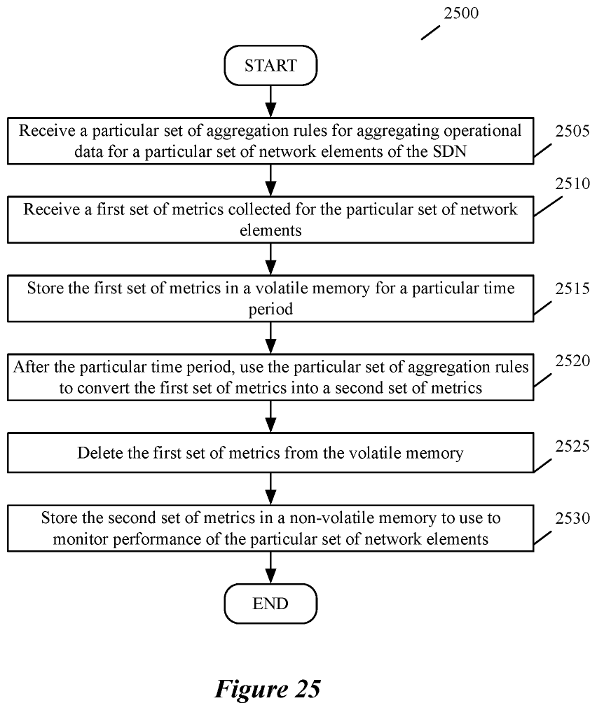

In some embodiments, in order to optimize storage of a TSDB, a metrics collection framework only stores aggregated metrics for network elements. FIG. 25 conceptually illustrates a process 2500 for storing operational data for network elements in an SDN. This process 2500 may be performed by an aggregation process of a metrics collection framework, such as a metrics manager of a set of metrics managers. In some embodiments, a first metrics manager aggregates metrics for a first set of network elements, while a second metrics manager aggregates metrics for a second set of network elements. In some embodiments, the first metrics manager also aggregates metrics for a third set of network elements. The process 2500 will be described below for a particular metrics manager of a framework for a particular set of network elements.

The process 2500 begins by receiving (at 2505) a particular set of aggregation rules for aggregating operational data for the particular set of network elements of the SDN. In some embodiments, the particular set of aggregation rules is received from an interface that defines the particular set of aggregation rules from a particular set of aggregation criteria for a particular client application. As discussed previously, an API request can be sent to a data consumer interface specifying the aggregation criteria, and a parser and translator can parse the API request to extract the aggregation criteria and translate it into the aggregation rules. These aggregation rules are used by the metrics managers of the metrics collection framework. In some embodiments, the translator sends the aggregation rules directly to the metrics managers. In other embodiments, the translator stores the aggregation rules in a data store, and the metrics managers retrieve any aggregation rules it needs to aggregate metrics associated with applications from the data store.

Next, the process 2500 receives (at 2510) a first set of metrics collected for the particular set of network elements. The metrics manager of some embodiments receives the first set of metrics from a set of one or more metrics collectors operating on at least one of host computers and edge devices in the SDN. As discussed previously, a metrics collector may be deployed as a plugin on each host computer and/or each hardware physical forwarding element (e.g., an edge device) in the SDN to collect metrics for the host computer or edge device on which it is deployed. In some embodiments, a first subset of the first set of metrics is received from a first metrics collector and a second subset of the first set of metrics is received from a second metrics collector. This first metrics collector may operate on a particular host computer while the second metrics collector operates on another host computer or a particular edge device. In other embodiments, the first set of metrics is entirely received from a particular metrics collector operating on either a host computer or an edge device.

At 2515, the process 2500 stores the first set of metrics in a volatile memory for a particular time period. By storing the first set of metrics (i.e., raw metrics collected for the particular application) in the volatile memory, space is saved in the non-volatile memory and the metrics collection framework works more efficiently. The time periods for which raw metrics are stored in the volatile memory are specified in the aggregation rules. For example, the particular time period is specified in the particular set of aggregation rules. This time period specifies how long the metrics manager is to store the raw metrics in the volatile memory and how long the metrics manager is to wait to aggregate the metrics according to the aggregation rules.

After the particular time period, the process 2500 uses (at 2520) the particular set of aggregation rules to convert the first set of metrics into a second set of metrics. Based on aggregation criteria for the particular client application, the metrics manager aggregates the raw metrics in the first metric set into aggregated metrics in the second metric set to be stored in the non-volatile memory of the framework. This second set of metrics includes different representations of the metric values in the first metric set as defined by the aggregation rules. By computing different representations of raw metrics and storing them in a non-volatile TSDB, the metrics collection framework can provide the different representations to users to view these values without having to compute them in real-time.

Next, the process 2500 deletes (at 2525) the first set of metrics from the volatile memory. Once the second set of metrics has been created, the first set of metrics is no longer needed to be stored, so the metrics manager deletes it from the local memory of the framework. The process 2500 also stores (at 2530) the second set of metrics in a non-volatile memory to use to monitor performance of the particular set of network elements. After the second set of metrics is stored in the non-volatile memory, the process 2500 ends. In some embodiments, the first set of metrics is deleted from the volatile memory after the second set of metrics has been created. In other embodiments, the first set of metrics is deleted after the second set of metrics has been stored. The second set of metrics is stored in the non-volatile memory for use by a user to view in a UI in order to monitor the performance of the particular set of network elements. As discussed previously, a user can request to view metrics in a UI in order to analyze the metrics and monitor the performance of the particular set of network elements.

In some embodiments, a metrics manager can aggregate and store metrics for network elements of an SDN according to multiple sets of criteria for multiple client applications. In such embodiments, the particular client application is a first client application, the particular set of aggregation rules is a first set of aggregation rules, the particular set of network elements is a first set of network elements, the particular set of aggregation criteria is a first set of aggregation criteria, and the particular time period is a first time period. The metrics manager receives a second set of aggregation rules for aggregating operational data for a second set of network elements of the SDN. This second set of aggregation rules in some embodiments satisfies a second set of aggregation criteria for a second client application. The metrics manager receives a third set of metrics collected for the second set of network elements, and stores the third set of metrics in the volatile memory for a second time period. After the second time period, the metrics manager uses the second set of aggregation rules to convert the third set of metrics into a fourth set of metrics, deletes the third set of metrics from the volatile memory, and stores the fourth set of metrics in the non-volatile memory to use to monitor performance of the second set of network elements.

While the above-described process 2500 has been described for receiving and using aggregation rules for client applications, one of ordinary skill in the art will realize that metrics managers can receive and use storage rules for different client applications. A metrics manager can receive storage rules for storing metrics of network elements of the SDN according to storage criteria required by a client application, and the metrics manager can store metrics according to these rules. Although the above-described embodiments discuss collection operational data regarding SDN network elements (e.g., managed forwarding elements such as managed software switches and routers, or standalone switches and routers), one of ordinary skill in the art will realize that other embodiments collect operational data regarding the machines (e.g., VMs or Pods) that run on the host computers of an SDDC or the applications that operate on such machines in the SDDC.

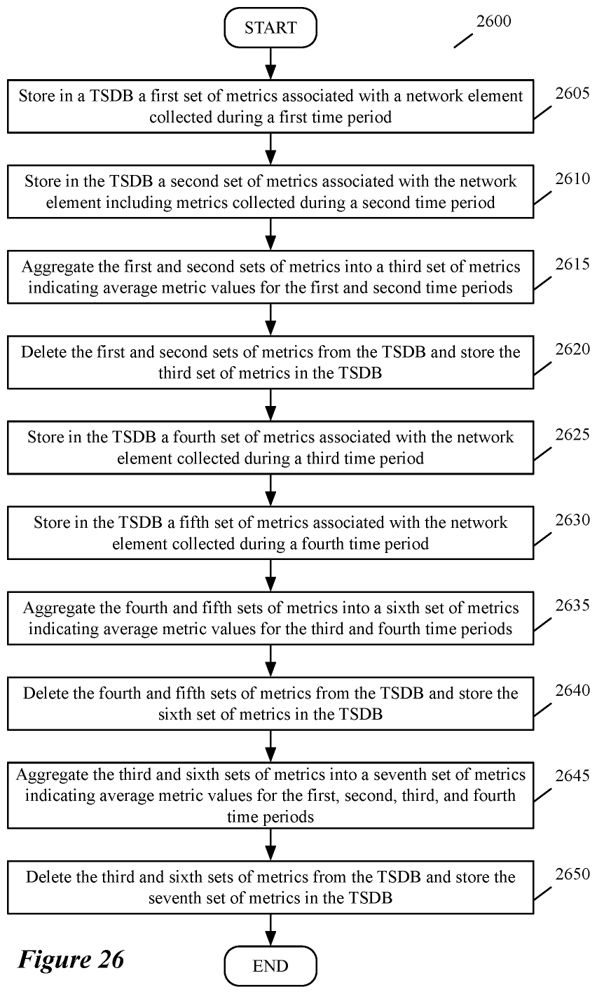

As discussed previously, a metrics manager of some embodiments can perform periodic rollups on aggregated metrics stored in a TSDB. FIG. 26 conceptually illustrates a process 2600 of some embodiments for efficiently storing metrics for an SDN that includes several network elements. This process 2600 may be performed by an aggregation process of a metrics collection framework, such as a metrics manager. The process 2600 begins by storing (at 2605), in a TSDB, a first set of metrics associated with a particular network element of the SDN. The first set of metrics includes metrics of a particular set of one or more metric types collected during a first period of time. In some embodiments, the first set of metrics has already been aggregated from raw metrics collected for the particular network element, since raw metrics are only stored in a local memory and not the TSDB.

The process 2600 also stores (at 2610), in the TSDB, a second set of metrics associated with the particular network element. The second set of metrics includes metrics of the particular set of metric types collected during a second period of time. This second set of metrics can also be aggregated from raw metrics collected for the particular network element. In some embodiments, the first and second sets of metrics are received at the metrics manager by a load balancer that distributes different sets of metrics to different metrics managers in the set of metrics managers. These different sets of metrics are received at the load balancer by a set of one or more metrics collectors operating on at least one of host computers and/or edge devices in the SDN. In some embodiments, the load balancer receives all collected metrics for the SDN, and distributes the metrics among the metrics managers such that all metrics for a particular network element are provided to the same metrics manager. This ensures that the same metrics manager aggregates all metrics of the same metric type for the same network element.

After storing the first and second sets of metrics for a first time interval, the process 2600 aggregates (at 2615) the first and second sets of metrics into a third set of metrics associated with the particular network element of the SDN. The third set of metrics indicates average metric values for the particular network element for the first and second periods of time. To aggregate the first and second sets of metrics into the third set of metrics, the metric manager in some embodiments averages, for each metric type in the set of metric types, each metric of the metric type in the first and second sets of metrics into a single metric to indicate an average metric value of the metric type for the particular network element for the first and second periods of time.

After creating the third set of metrics, the process 2600 deletes (at 2620) the first and second sets of metrics from the TSDB and stores the third set of metrics in the TSDB in order to efficiently utilize space in the TSDB. In order to consolidate the metrics of each type for the particular network element stored in the TSDB, the metrics manager computes an average of each metric type for storing. By storing the higher aggregation level metrics (i.e., the third set of metrics) and deleting the lower aggregation level metrics (i.e., the first and second metrics) from the TSDB, the metrics manager saves space in the TSDB.

The process 2600 also stores (at 2625), in the TSDB, a fourth set of metrics associated with the particular network element. The fourth set of metrics includes metrics of the particular set of metric types collected during a third period of time. The process 2600 also stores (at 2630) in the TSDB a fifth set of metrics associated with the particular network element. The fifth set of metrics includes metrics of the particular set of metric types collected during a fourth period of time. These fourth and fifth sets of metrics include metrics of the same metric types for the particular network element as the first and second sets of metrics, but were collected by metrics collectors and provided to the metrics manager at a later time. The metrics manager of some embodiments periodically receives metrics for the particular network element, and periodically aggregates these metrics.

After storing the fourth and fifth sets of metrics for a second time interval, the process 2600 aggregates (at 2635) the fourth and fifth sets of metrics into a sixth set of metrics associated with the particular network element of the SDN. This sixth set of metrics indicates average metric values for the particular network element for the third and fourth periods of time. The first, second, third, and fourth time periods associated respectively with the first, second, fourth, and fifth sets of metrics in some embodiments each include a same length of time. The metrics collectors are configured to periodically collect metrics for the network elements with which they are associated, and each metric collected by the metrics collector is collected for the same length of time. The first and second time intervals associated with storing the first, second, fourth, and fifth sets of metrics also each include a same length of time. For example, if metrics collectors collect five-second metrics, the time interval for storing them is five minutes.

After creating the sixth set of metrics, the process 2600 deletes (at 2640) the fourth and fifth sets of metrics from the TSDB and stores the sixth set of metrics in the TSDB. This sixth set of metrics provides average metric values for the same length of time as the third set of metrics, but indicates the average metric values at a later time than the third set of metrics. In some embodiments, after storing the third and sixth sets of metrics for a third time interval, the process 2600 aggregates (at 2645) the third and sixth sets of metrics into a seventh set of metrics indicating average metric values for the particular network element for the first, second, third, and fourth periods of time. The metrics manager is able to perform “rollups” for metrics of the same metric type in order to store less metrics in the TSDB while being able to provide values for these metrics at previous points in time. The third time interval in some embodiments is a longer time interval than the first and second time intervals such that the third and sixth sets of metrics are stored in the TSDB longer than the first, second, fourth, and fifth sets of metrics. Using the example described above, if metrics stored for five minutes are aggregated, the aggregated metrics are then stored for one hour.

After creating the seventh set of metrics, the process 2600 (at 2650) deletes the third and sixth sets of metrics from the TSDB and stores the seventh set of metrics in the TSDB. By aggregating the third and sixth sets of metrics into a seventh set of metrics, the TSDB can store average metric values that combine the metric values provided in the first, second, fourth, and fifth sets of metrics without having to store all of these individual sets. In some embodiments, after storing the seventh set of metrics for a fourth time interval, the metrics manager deletes the seventh set of metrics from the TSDB. This fourth time interval is a longer time interval than the third time interval such that the seventh set of metrics is stored in the TSDB longer than the third and sixth sets of metrics. Using the example above, the fourth interval can be one day such that the seventh set of metrics are stored for one day. The highest aggregation-level metrics in some embodiments is stored indefinitely in the TSDB until a metrics manager is directed to delete it. In other embodiments, the highest aggregation-level metrics are stored for a period of time and are deleted after that period of time has passed. After the seventh set of metrics is stored in the TSDB, the process 2600 ends.

By efficiently storing and deleting different aggregation levels of metrics, the TSDB can save space while still storing historical metrics for the SDN. Alternatively, in some embodiments, several aggregation levels are performed on a same set of metrics and are all stored for various periods of time. A set of metrics that is aggregated at different aggregation levels provides visibility into varying granular views of the metrics. For instance, metrics representing values over a five-minute period are a less granular view of these metrics than metrics representing values over a one-day period. By storing multiple aggregation levels for metrics with varying granularity, different aggregation levels for a same set of metrics can be queried and analyzed to identify bottlenecks or issues related to the metrics. However, as aggregation processes are performed over time, a user can roll back through the various aggregation levels of the metrics, but the farther the user wishes to roll back, the less sets of aggregated metrics are stored. These aggregated views of metrics are dynamically generated based on aggregated data sets that are continuously and iteratively performed, but are also in some embodiments stored and deleted according to their aggregation level.

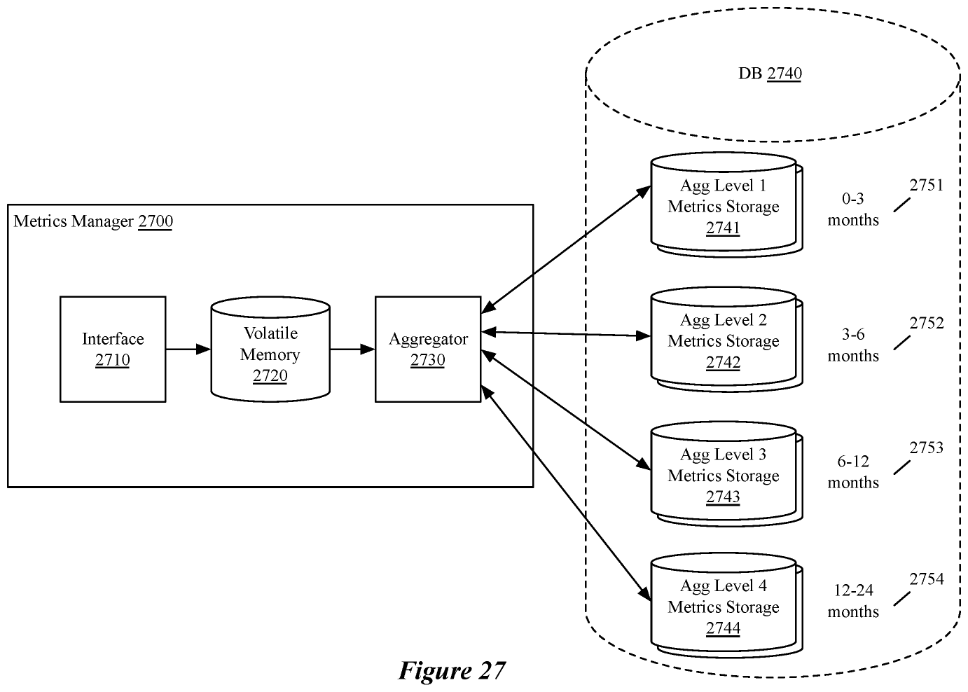

FIG. 27 illustrates a metrics manager 2700 that receives raw metrics for one or more network elements of an SDN for aggregating at various aggregation levels across time. In some embodiments, the metrics manager 2700 is one of a set of metrics managers that computes different aggregation levels for metrics for network elements of the SDN. The metrics manager 2700 of some embodiments includes an interface 2710, a volatile memory 2720, and an aggregator 2730. The interface 2710 receives raw metrics from metrics collectors operating in the SDN. In some embodiments, the raw metrics are received from one metrics collector operating on a host or edge device in the SDN. In other embodiments, the raw metrics are received from multiple metrics collectors operating on multiple hosts and/or edge devices in the SDN. The interface 2710 of some embodiments requests for (or fetches) metrics from the metrics collectors (i.e., in a pull model), while, in other embodiments, the interface 2710 receives the metrics without requesting for the metrics (i.e., a push model).

The interface 2710 stores all raw metrics in the volatile memory 2720. These raw, collected metrics are first stored in the volatile memory 2720 until a specified period of time passes. For example, the metrics manager 2700 may be configured to store the raw metrics in the volatile memory 2720 for five minutes. This time period may be specified in aggregation rules that the metrics manager 2700 uses to aggregate all metrics it receives. In some embodiments, the metrics manager 2700 also records this time period in the volatile memory 2720 along with the raw metrics. After this time period passes, the aggregator 2730 of the metrics manager 2700 retrieves the raw metrics from the volatile memory 2720 to use for computing a first aggregation level of the metrics. The metrics manager 2700 may include any suitable aggregation process that executes on a server in an SDN for generating different aggregation representations for metrics associated with network elements of an SDN or a set of one or more SDDCs. After creating a set of first aggregation-level metrics from the raw metrics, the aggregator 2730 stores it in a non-volatile database 2740. As shown, the aggregator 2730 stores the first aggregation-level metric set in a first metrics storage 2741. As specified at 2751, the first aggregation-level metrics are stored in the storage 2741 for up to three months.

Using the first aggregation-level metrics, the aggregator 2730 also computes a set of second aggregation-level metrics to store in a second metrics storage 2742, which is stored for up to six months. Using the second aggregation-level metrics, the aggregator 2730 computes a set of third aggregation-level metrics to store in a third metrics storage 2743, which is stored for up to one year. Using the third aggregation-level metrics, the aggregator 2730 computes a set of fourth aggregation-level metrics to store in a fourth metrics storage 2744, which is stored for up to two years. Different aggregation-level metrics can be stored in a non-volatile memory for any suitable period of time. In some embodiments, these storages 2741-2744 are separate databases or storages for storing the different aggregation-level metrics. In other embodiments, the metrics storages 2741-2744 are separate tables of a shared database 2740 for storing the different aggregation-level metrics.

As discussed previously, different aggregation levels of metrics can be computed from raw metrics in order to express the average, sum, maximum, or minimum value for each metric over different lengths of time. For example, four aggregation levels can be computed across time for raw metrics to represent the average of each metric for a one-hour period, a one-day period, a one-week period, and a one-month period. Each aggregation level expresses a different granularity such that the different aggregation levels for the same raw metrics can be viewed to identify bottlenecks or issues associated with the metrics. This can be used to drill down through metric data to identify problems find solutions to these problems.

In some embodiments, different aggregation levels are stored in the database 2740 for different periods of time. For instance, lower aggregation-level metrics are stored for a shorter period of time than higher aggregation-level metrics. In the example of FIG. 27, the set of first aggregation-level metrics are specified to be stored for 0-3 months at 2751, the set of second aggregation-level metrics are specified to be stored for 3-6 months at 2752, the set of third aggregation-level metrics are specified to be stored for 6-12 months at 2753, and the set of fourth aggregation-level metrics are specified to be stored for 12-24 months at 2754. In some embodiments, the aggregator 2730 of the metrics manager 2700 records the specified time periods for each aggregation level of metrics in the database 2740 along with each metrics storage 2741-2744 with which it is associated. For example, if each metrics storage 2741-2744 is a separate table in the database 2740, the aggregator 2730 can create a column in each table specifying how the specific time period (e.g., the start and ending timestamp) each metric is to be stored. In other embodiments, the aggregator 2730 keeps a record of these time periods along with the aggregation rules used to compute these sets of aggregated metrics.

Because different aggregation levels of metrics are stored for varying periods of time, requesting metrics from the database 2740 at different times can result in receiving varying sets of metrics. For instance, since all different aggregation levels of the metrics are stored for the first week after they have been created by the aggregator 2730, a user can request to view all four sets of aggregated metrics during that first week. In some embodiments, a user specifically requests to view each aggregation level of the metrics. In other embodiments, the user requests to view metrics, and all available aggregation levels of the requested metrics are provided.

In some embodiments, at a particular time, a user requests metrics associated with a particular network element. The request can be made to a metrics query server through a UI, as described above. This particular time is the timestamp at which the user makes the request, and indicates which aggregation level of metrics are currently being stored at that particular time. For example, if the user makes the request at a first time, and four aggregation levels of metrics are being stored at that time, then those four aggregation levels of metrics can be provided for that request. Alternatively, if the user makes the request at a second time, and only one aggregation level of metrics is being stored at that time, then only that one aggregation level of metrics is provided. In some embodiments, the user requests metrics at a third time, and no aggregated metrics are currently stored for the specified network element. In such embodiments, the user is given an error message notifying the user that no metrics associated with the user's request are currently stored.

Once it is known which sets of metrics are being stored during the particular time of the user's request, the user can be provided all sets of metrics at any of the aggregation levels. The metrics query server of some embodiments directs the metrics manager 2700 to retrieve all metrics for the requested network element for all aggregation levels currently being stored. In some embodiments, the metrics are provided along with identification of their aggregation level and the timestamps or time range associated with the metrics. For example, if the user is provided aggregated metrics specifying the average latency of a PFE during a particular time period at a first level of aggregation, the user also receives the start and end time of the time period for which the average latency measures for the PFE and specification that the metric is aggregated at a first aggregation level. Being notified of the aggregation level lets the user know if the metrics were aggregated directly from the raw metrics (i.e., first aggregation-level metrics) or have been aggregated from another set of aggregated metrics (i.e., second and further aggregation-level metrics). By providing the user with multiple aggregation-level metrics available at the time the user requests, the user can analyze each aggregation level to identify any issues associated with any of the metrics and modify the associated network element accordingly.

After the first three months have passed, the aggregator 2730 deletes the set of first aggregation-level metrics from the metrics storage 2741. After this, until it has been six months since the aggregated metric sets have been created, only the second, third, and fourth aggregation-level metrics are stored and can be provided to a user. After the six-month mark, the set of second aggregation-level metrics is deleted from the metrics storage 2742, and only the third and fourth aggregation-level metrics are stored from the six-month mark until the 12-month mark. Then, after the 12-month mark, the set of third aggregation-level metrics is deleted from the metrics storage 2743, and only the fourth aggregation-level metrics set is stored. After 24 months (i.e., two years) since the set of fourth aggregation-level metrics was computed by the aggregator 2730, this set is then deleted from the metrics storage 2744. Once the highest aggregation level of the metrics has been deleted, a user cannot request to view any of the aggregated metrics computed from the raw metrics. However, in other embodiments, the highest aggregation level of metrics is stored indefinitely until the aggregator 2730 is directed to delete it. This direction may come from a consumer that deploys the network elements associated with the metrics, or may come from a network manager that manages the aggregator 2730.

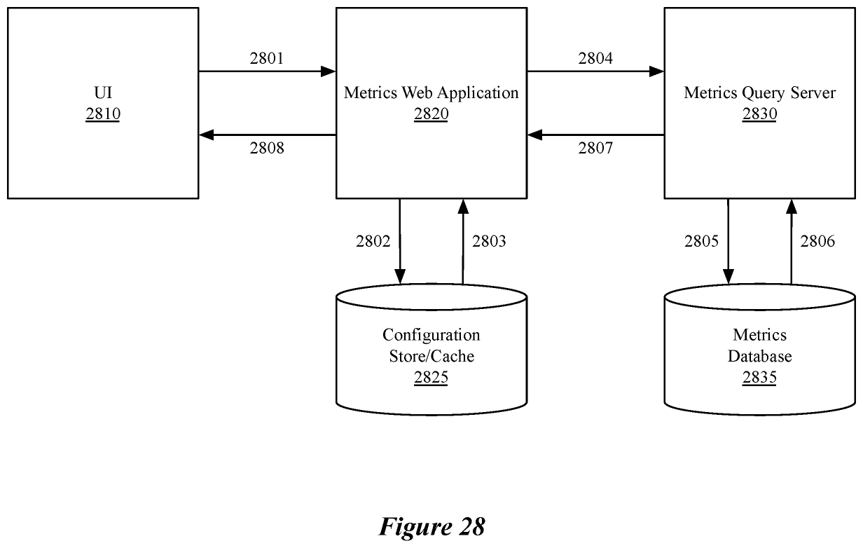

A user can request to view metrics in order to monitor performance of an SDN or any of its components. As discussed previously, a user can request to view these stored metrics from a metrics query server. FIG. 28 illustrates the communication between a user requesting metrics through a UI and a metrics query server that provides the metrics. These metrics may be any requested for any component of an SDN. First, at 2801, the user sends a REST API request through the UI 2810 for lifecycle management (LCM). This API request is querying for metrics for a particular entity resource in a specified time range. For example, the user can request metrics for a particular VM of the SDN collected during the last month.

This API request is received by a metrics web application 2820, which can be a spring boot application. In some embodiments, the API request specifies the metric keys identifying the requested metrics, the start and end times of the requested time period, the granularity (i.e., how many granular data points requested), the maximum number of data points to return, one or more object identifiers, and/or one or more node (e.g., machine, host, etc.) identifiers. In some embodiments, a metric key for a particular network element includes (1) an identifier identifying the network element (e.g., an entity UUID), (2) an identifier identifying the node or host on which the network element resides (e.g., a node ID), (3) an identifier identifying the object within the network element (e.g., an object ID identifying the subject object ID within the entity), (4) an identifier identifying which metric table it is (or is to be) stored in, and (5) an identifier identifying the metric.

In some embodiments, the API interactions are based on entity UUIDs. In these embodiments, a policy intent store would have to store the UUIDs, so the user can request metrics using the UUIDs. In other embodiments the API interactions are based on a secure hash algorithm (SHA) that has multiple APIs to fine tune plugins. In these embodiments, the SDN needs to proxy the API. Still, in other embodiments, the API interactions with the user through the UI 2810 are based on the intent-path, as seen or known to the user. An intent-path is also referred to as the name of the entity or object. In such embodiments, the API requests to return metrics to the user are for all realized entities (i.e., resources) for this intent-path. For these API requests, the intent-path needs to be converted to the UUID (also referred to as a realization ID) to query for the metrics.

At 2802, the metrics web application 2820 queries for a intent-path to UUID mapping from the configuration store/cache 2825. The metrics web application 2820 performs a lookup to map the entity's name specified in the API request with the entity's UUID. Once this UUID is found, the metrics for the entity can be retrieved. At 2803, the configuration store/cache 2825 returns the UUID or UUIDs for the intent-path specified in the API request. In embodiments where UUIDs are specified in the API request, steps 2802 and 2803 are not performed.

At 2804, the metrics web application 2820 fetches the requested metrics by sending a Remote Procedure Call (RPC) message to the metrics query server 2830. In some embodiments, this RPC message includes inputs for the UUID, an identifier for the object (i.e., the resource with which the metrics are associated), and any metric keys identifying the requested metrics. Upon receiving this RPC message, the metrics query server 2830 queries the metrics database 2835 at 2805. This database 2835 may be a TSDB that stores all metrics collected for the SDN. At 2806, the metrics database 2835 returns the requested metrics to the metrics query server 2830, which then returns the metrics back in a response to the metrics web application 2820 at 2807. Once the metrics web application 2820 receives the metrics at 2807, the metrics are provided to the user through the UI 2810 at 2808. In some embodiments, the metrics are first converted to an output data transfer object (DTO) before being provided to the user. Converting the metrics to an output DTO aggregates the data that would have been transferred using several APIs into a single API.

In some embodiments, the metrics provided to the user each include (1) a metric key identifying the metric, (2) the unit of the metric (e.g., percent, packets per second, bits per second, etc.), (3) the actual start and end times or a timestamp for the metric, and (4) any details about the metric. In other embodiments, if the user requests object information through the API to get information regarding a particular metric key and resource identifier, the provided response includes the requested information, and, in some embodiments, identifiers of the nodes (i.e., machines, hosts, etc.) where the objects were discovered. Using this information, the user can filter metrics by node and object information.

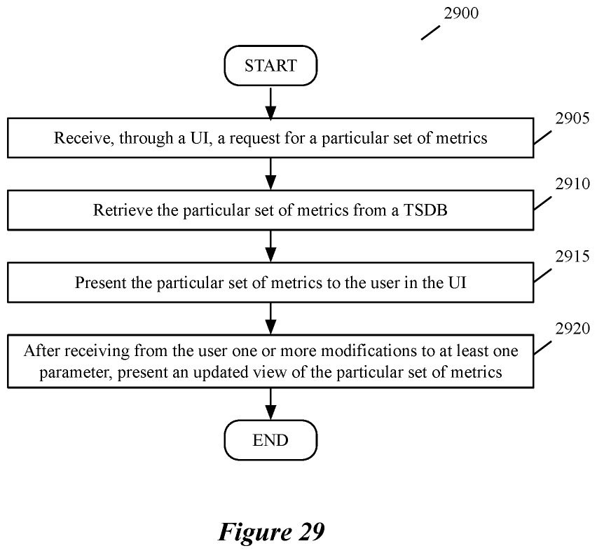

A metrics query server of some embodiments provides a user metrics upon request for the user to view and monitor the performance of an SDN and/or its components. FIG. 29 conceptually illustrates a process 2900 of some embodiments for providing, through a UI, metrics to a user for monitoring the performance of an SDN. In some embodiments, the metrics provided to the user includes data-plane core metrics, such as packet processing usage, packets per second seen by an edge core, drops seen per second by each core and its reasons, per-protocol drops for each core, throughput, micro and mega flow cache, and queue usage per port per core. Metrics can also include data-plane memory pools, which are logical abstractions that compartmentalize all resources in a cluster. For edge fast-path interfaces, metrics can include receiving and transmitting packets per second, receiving and transmitting bits per second, drops, misses, and errors. For kernel network interfaces, metrics can includes receiving and transmitting packets per second, and receiving and transmitting bits per second. Metrics provided can also be related to data-plane threat liveliness. By providing metrics such as these described above, a user is able to determine any performance issues or drops back in time, and can take any actions to resolve the determined performance issues or drops back in time.

The process 2900 begins by receiving (at 2905), through a UI, a request for a particular set of metrics from a user. This request may be a REST API request sent from the user through the UI querying for metrics for a particular entity or resource in a specified time range. For example, the user can request metrics for a particular VM of the SDN collected during the last month. The user can also request a particular type of metrics collected for all components of the SDN, such as memory utilization, during a particular time period. The request is received by the metrics query server. In some embodiments, the API request specifies the metric keys identifying the requested metrics, the start and end times of the requested time period, the granularity (i.e., how many granular data points requested), the maximum number of data points to return, one or more object identifiers, and/or one or more node (e.g., machine, host, etc.) identifiers.

Next, the process 2900 retrieves (at 2910) the particular set of metrics from a TSDB. As discussed previously, metrics are collected by metrics collectors, and stored in a TSDB by one or more metrics managers for the metrics query server to retrieve any metrics requested by a user. At 2915, the process 2900 presents the particular set of metrics to the user in the UI. In some embodiments, the metrics are shown to the user in the UI for the user to monitor the performance of the SDN or the one or more components associated with the metrics. By viewing the requested metrics that were collected during the specified time range, the user can understand how the metrics changed during that time period and modify anything about the SDN accordingly. For example, if the user is viewing latency for an LFE, and the LFE is experiencing a large latency value, the user can reduce the number of data messages exchanged through that LFE.

In some embodiments, the metrics query server provides the particular set of metrics to the user in the UI for the user to view how the metrics have changed over the particular time period, and to modify how the particular set of metrics is presented in order to build different representations as the user might need. For example, if metrics have been stored regarding total CPU cycles, idle cycles, and busy cycles, the user can request to view the average usage percentage, the top used core, the mean usage of a core, the lifetime sum, and/or an aggregate value across nodes reporting metrics for a particular entity. In some embodiments, these different representations have already been computed by the metrics managers and stored in the TSDB, as described above.

After receiving from the user one or more modifications to at least one parameter, the process 2900 presents (at 2920) an updated view of the particular set of metrics in the UI. In some embodiments, the UI presents an average metric value for all network elements in the SDN. The user can modify one or more parameters to remove one or more network elements' metric values from this average metric in order to view what the average metric is without those network elements. For example, if the user is viewing an average memory utilization, and wishes to remove the memory utilization of the control plane from the average, the user can modify the parameters in the UI to remove the control plane's memory utilization metric from the computation of the average memory utilization. This way, the user can see the average memory utilization of the SDN without factoring in the control plane. Then, the process 2900 ends.

A user in some embodiments can use the UI to modify a variety of parameters used in presenting metrics in a UI. In some embodiments, all parameters used in presenting metrics are able to be modified by the user. In other embodiments, only a subset of the parameters are able to be modified by the user. The parameters to be modified by the user can include any parameters related to presenting the metrics, such as (1) which metrics are included in the presentation, (2) which metrics are included in any computed values presented in the UI (e.g., an average metric across multiple network elements), (3) the time period the user wishes to view metrics from, and any other suitable parameters.

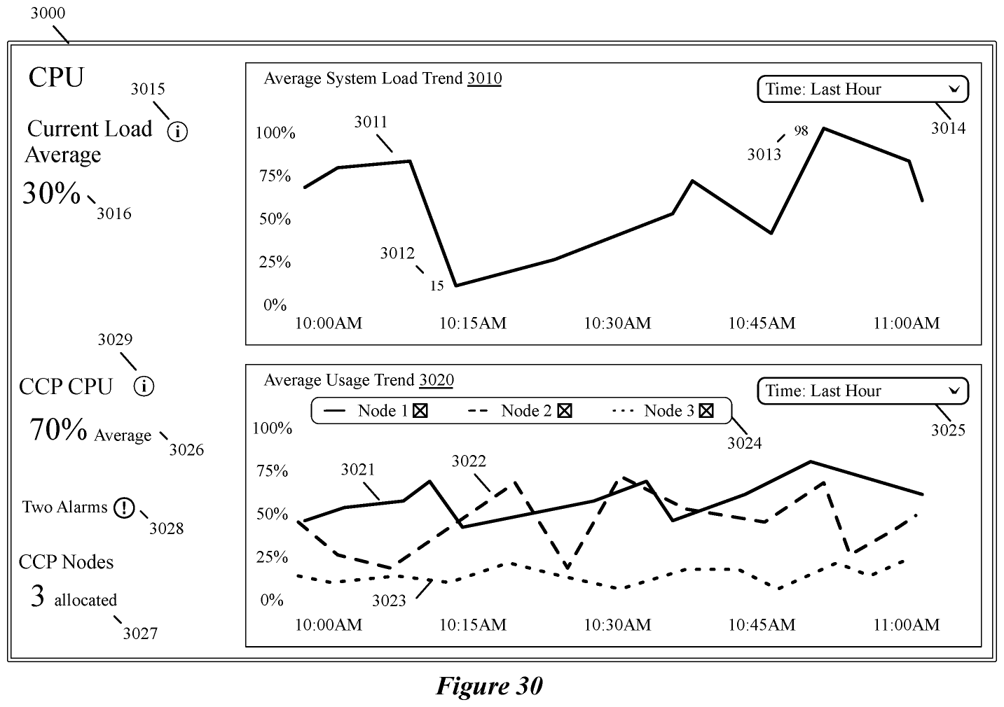

FIG. 30 illustrates an example UI 3000 that displays metrics for an SDN. In this example, a user has sent a metrics query server a REST API requesting to view the entire system's CPU usage and the SDN's CCP CPU usage over the last hour. A first window 3010 illustrates a line 3011 mapping the system's CPU utilization metrics over the last hour. On this line 3011, the lowest CPU utilization measured at 15% at 10:13 AM is noted at 3012, and the highest CPU utilization measured at 98% at 10:47 AM is noted at 3013. In some embodiments, the line 3011 is a GUI selectable item, and as a user hovers a cursor over the line, the UI displays the numerical value of the CPU-measured utilization metric at that point on the line 3011.

The window 3010 also includes a time filter 3014 for the user to modify the time period for displaying the metrics. As shown, because the user requested to view metrics from the last hour, the time filter reads “Last Hour.” The user can use this filter 3014 to change the time period (e.g., to the last day or to a particular past time range). After receiving a modification to this parameter, the UI updates the window 3010 to show an updated view of the SDN's CPU utilization metrics collected during the new time period. In some embodiments, the UI 3000 also displays the current average value of the requested metric. For the SDN's entire CPU utilization, the UI 3000 displays 30% at 3016.

In this example, the user has also requested to view the SDN's CCP CPU utilization metrics. These metrics are shown in the window 3020. As discussed previously, a CCP in some embodiments operates as three separate CCP nodes. Hence, three lines 3021-3023 are shown to display the CPU utilization of each node. In some embodiments, the lines 3021-3023 are shown using different appearances for the user to visually understand which line corresponds to which CCP node. In this example, the lines 3021-3023 are respectively shown as solid, long dashed, and short dashed lines. In some embodiments, a node selection filter 3024 is provided for the user to select which nodes' metrics to view in the window 3020. As shown, the user has selected all CCP nodes to be viewed in the window 3020, so a line is shown for all three nodes.

The window 3020 also includes a time filter 3025 for the user to modify the time period for displaying the CCP's CPU utilization metrics. In some embodiments, as in this example, different time filters 3014 and 3025 are displayed for each metric type presented so the user can select a different time period for viewing each metric type. In other embodiments, only one time filter is presented in the UI for all displayed metrics, and the user can only specify one time period for viewing the different types of metrics in the UI 3000. In some embodiments, instead of presenting separate time filters 3014 and 3025 for different view of metrics, the UI 300 can present a single time control for the user to select and modify the time period for viewing all metrics in the UI. Any presented time filter or control can include a drop down menu for the user to select a time period (e.g., previous day, previous month, previous quarter, previous year, previous five years, previous 10 years, etc.) prior to the current time. The time control can also or instead allow the user to select or input a custom time range. For example, the user can input start and end timestamps for which the user wishes to view metrics. In some embodiments, the UI 3000 presents a time filter or control before any metrics are presented so that the user can specify the time period for viewing metrics.

As shown, the UI 3000 also displays the current average CPU usage of the CCP at 3026, which is currently 70%, and the total number of CCP nodes of the CCP at 3027. The UI 3000 also displays an alarm icon 3028 and indicates that there are two alarms associated with the CCP CPU utilization metrics. In some embodiments, metrics are collected for an SDN and/or its components for a UI to alert to a user potential or realized problems associated with any of the collected metrics. Here, the UI 3000 alerts to the user that there are two problems associated with the CCP's CPU utilization. For instance, in some embodiments, threshold values for each metric are specified (e.g., by a user or administrator), and if a collected metric exceeds that threshold, an alarm can be displayed in the UI 3000 to notify the user. Upon selection of the icon 3028, the UI 3000 of some embodiments displays an additional window to display to the user the potential problem associated with the threshold exceeding metric. In the example of CCP CPU utilization, a threshold may be specified that an alarm is displayed once the CCP's CPU utilization exceeds a particular percentage, e.g., 65%. Because the CCP's average CPU utilization is displayed at 3026 as 70%, an alarm is presented in the UI 3000. In some embodiments, a recommended action is also displayed to the user in the additional window recommending possible actions to take to obviate the potential problem caused by the threshold exceeding metric.

The UI 3000 also includes information icons 3015 and 3029 for a user to view additional information regarding the displayed metric types. For example, upon user selection of the icon 3015, the UI 3000 may display additional information regarding the entire SDN and the entire SDN's CPU utilization. The additional information may also include a summarization of the associated metric type. Upon user selection of the icon 3029, the UI 3000 may display additional information regarding the CCP, such as identifiers of one or more hosts on which each CCP node operates. It may also display additional information regarding the components or operations of the CCP and how much CPU each component or operation is utilizing.

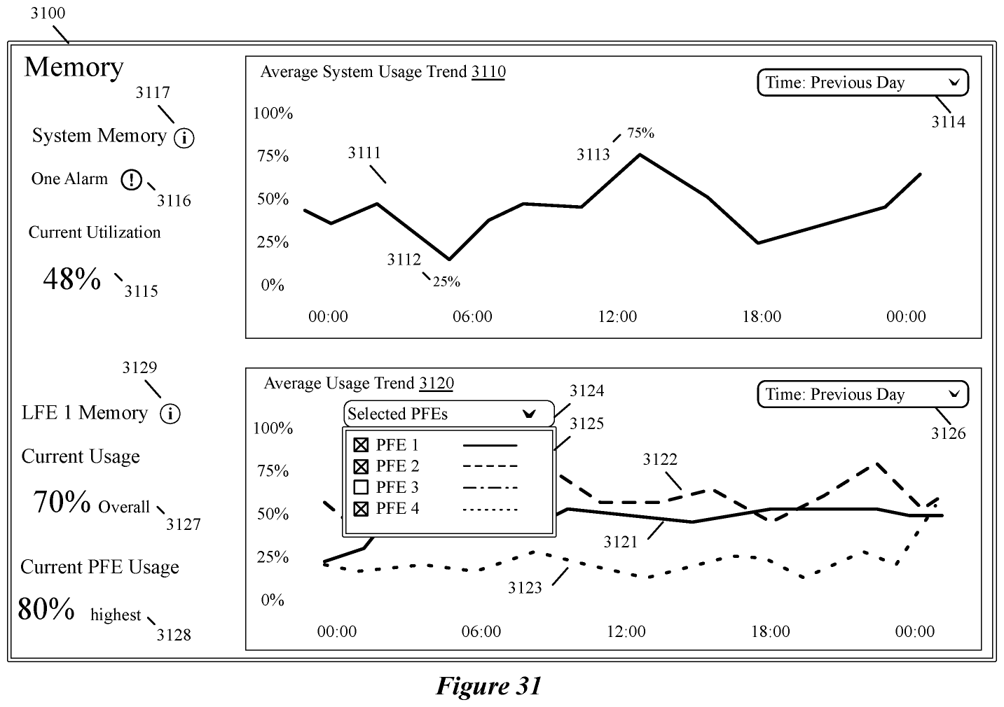

FIG. 31 illustrates another example UI 3100 displaying memory metrics upon user request. In this figure, the user has requested to view the entire system's memory usage and a particular LFE's memory usage during the previous day. A first window 3110 is displayed to show a line 3111 mapping the SDN's memory usage over the specified time period. Similar to the line 3011 of FIG. 30, the line 3111 indicates the minimum and maximum values for this metric at 3112 and 3113 and specifies the numerical values for each. The window 3110 also includes a time filter 3114 for the user to modify the time range for displaying the SDN's memory usage metrics.

The UI 3100 is displaying an alarm icon 3116, notifying the user of one potential or realized problem associated with the SDN's memory usage. This potential problem may be associated with the current memory utilization displayed at 3115, such as the current utilization exceeding a specified threshold percentage. The potential problem may instead be associated with a particular component of the SDN using a percentage of the system's memory exceeding a threshold's percentage assigned to it. For example, if the data plane of the SDN is specified to use no more than 15% of the system's total memory, but the measured memory usage of the data plane is 25%, the alarm would indicate this potential problem. Upon selection of the icon 3116, the UI 3100 can display an additional window specifying the potential problem and providing a recommended action to obviate the potential problem.

A second window 3120 is also displayed in the UI 3100 to display the memory usage metrics of a particular LFE, as requested by the user. In this window 3120, three lines 3121-3123 are shown to map memory usage metrics collected for three different PFEs that implement the LFE. In some embodiments, a line is displayed for all PFEs that implement the LFE. In other embodiments, a user may select which PFE's metrics to display in the window 3120 using a selection filter 3124. In this example, a user has selected the selection filter 3124, and an additional window 3125 has been displayed in the UI 3100. Using this additional window 3125, the user can select and deselect which PFEs implementing the LFE the user wants to view in the window 3120. Here, the user has selected to view first, second, and fourth PFEs that implement the LFE. Hence, the first PFE's metrics are displayed using a solid line 3121, the second PFE's metrics are displayed using a long dashed line 3122, and a fourth PFE's metrics are displayed using a short dashed line 3123. However, the user has not selected to view a third PFE's metrics using the additional window 3125, so there is no line displayed for this PFE.

The second window 3120 also includes a time filter 3126 to modify the time period for viewing the LFE's memory usage metrics. The UI 3100 in some embodiments also displays the current memory usage metric for the entire LFE at 3127, which in this example, is measured to be 70%. In some embodiments, the UI 3100 also displays (at 3128) the highest current memory usage of a PFE implementing the LFE, which in this example is 80%. This indicates to the user that one PFE implementing the LFE is currently using 80% of its memory.

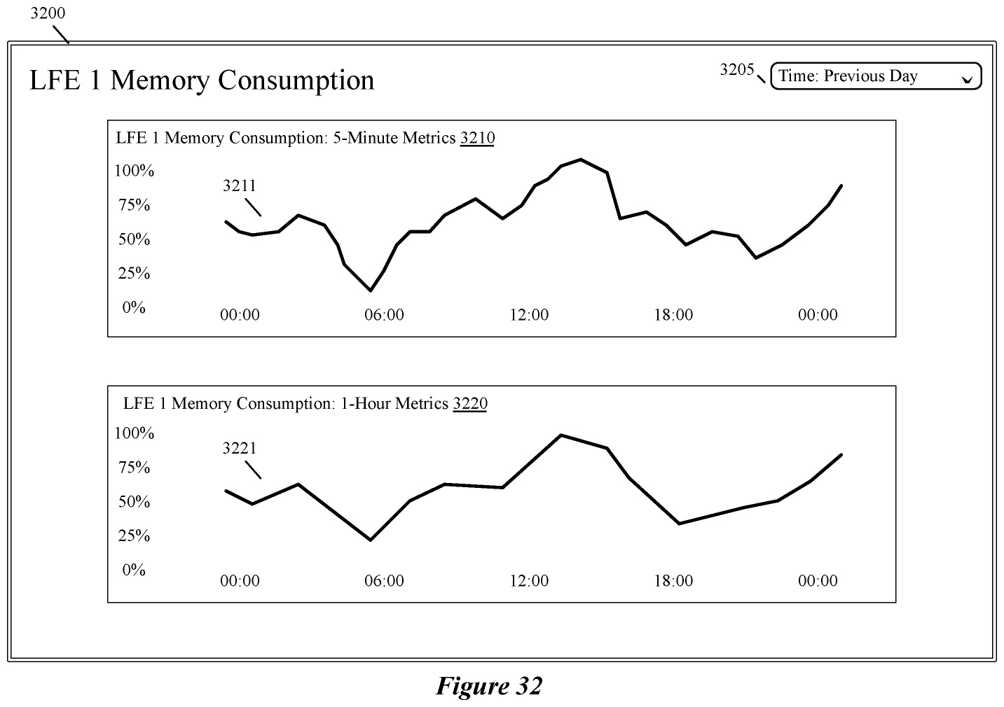

As discussed previously, a UI can allow a user to view different sets of aggregated metrics that are based on each other and based on raw metric data collected for network elements of an SDN. FIG. 32 illustrates an example UI 3200 displaying different aggregation-level metrics upon user request. In this example, a user has requested to view all stored aggregated metrics for a particular LFE's memory consumption metrics. Using the time control 3205, the user has selected to view all stored memory consumption metrics for the particular LFE for the previous day. At the time the user makes the request, there are five-minute memory consumption metrics and one-hour memory consumption metrics stored for the LFE, so the UI 3200 presents a view of these two aggregation levels. A first window 3210 presents the five-minute metrics for the LFE, presenting the metrics as a line 3211 plotting the five-minute memory consumption metrics for the LFE over the previous day. A second window 3220 presents the one-hour metrics for the LFE, presenting these metrics as a line 3221 plotting the one-hour memory consumption metrics for the LFE over the previous day. As shown, the line 3211 representing the five-minute metrics shows a less granular view of the LFE's memory consumption over time.

Using the UIs displayed in FIGS. 30-32, a user is able to examine metrics and perform actions based on the examination of the metrics. For example, the user in some embodiments determines, from the UI 3200 of FIG. 32, that the LFE's memory is reaching a high level of consumption. After determining this, the user can take actions to decrease the memory consumption of the LFE, such as having a different LFE forward one or more flows that were previously forwarded by the LFE. Conjunctively or alternatively, the user can add additional PFEs to the set of PFEs implementing the LFE. Any suitable action to decrease memory consumption of the LFE can be performed.

Rather than having the user examine the metrics shown in FIGS. 30-32, some embodiments automatically examine the metrics (e.g., using automated software processes) and perform actions based on the examination of the metrics.

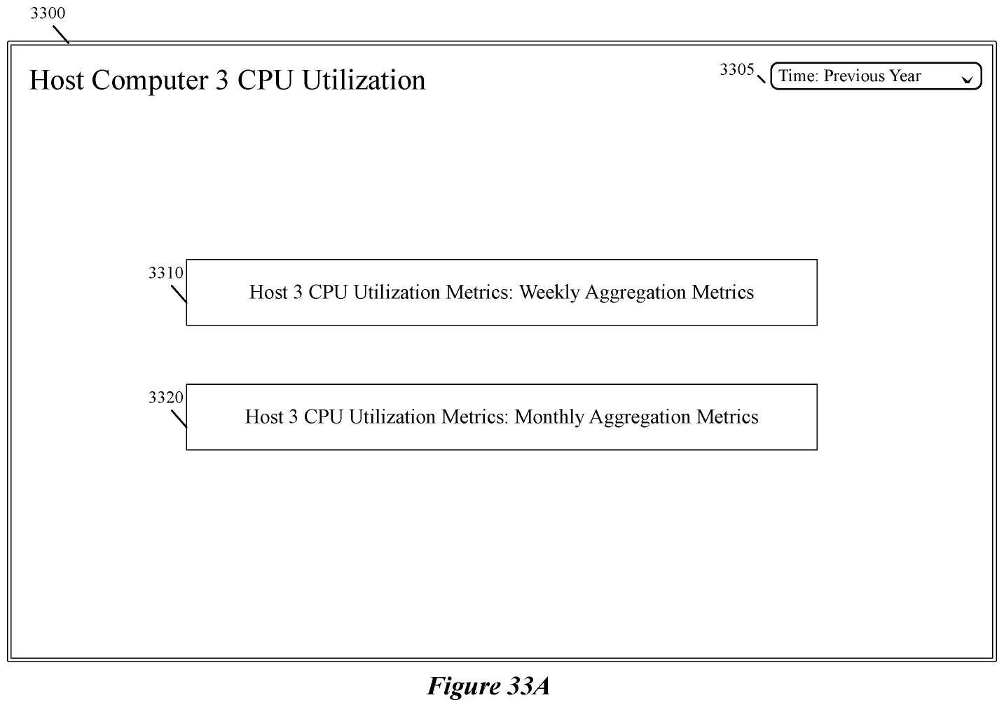

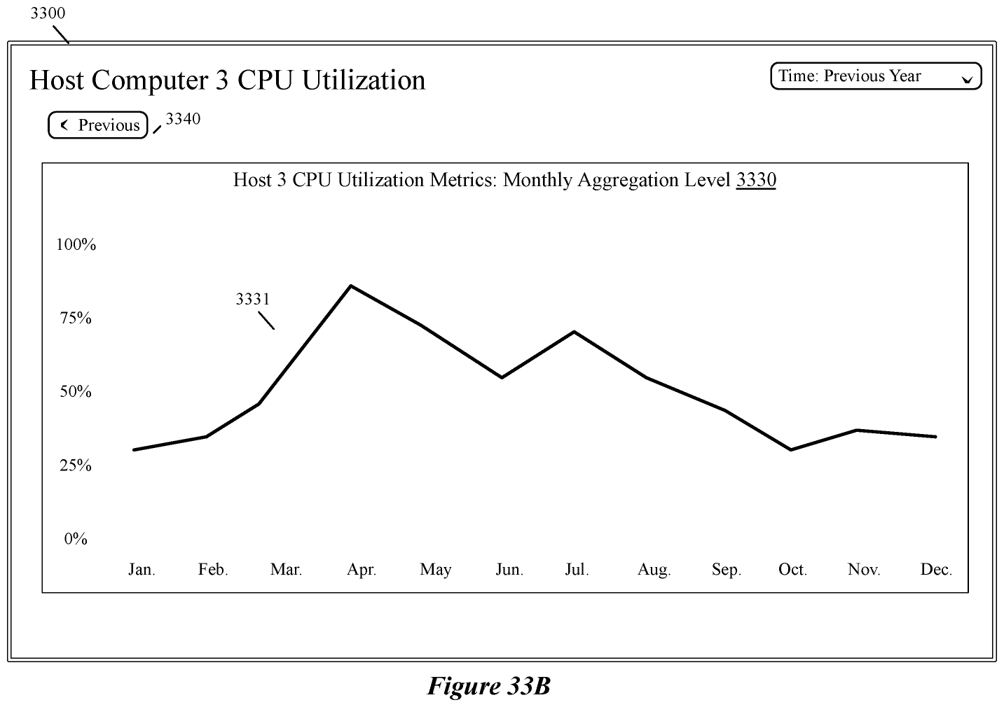

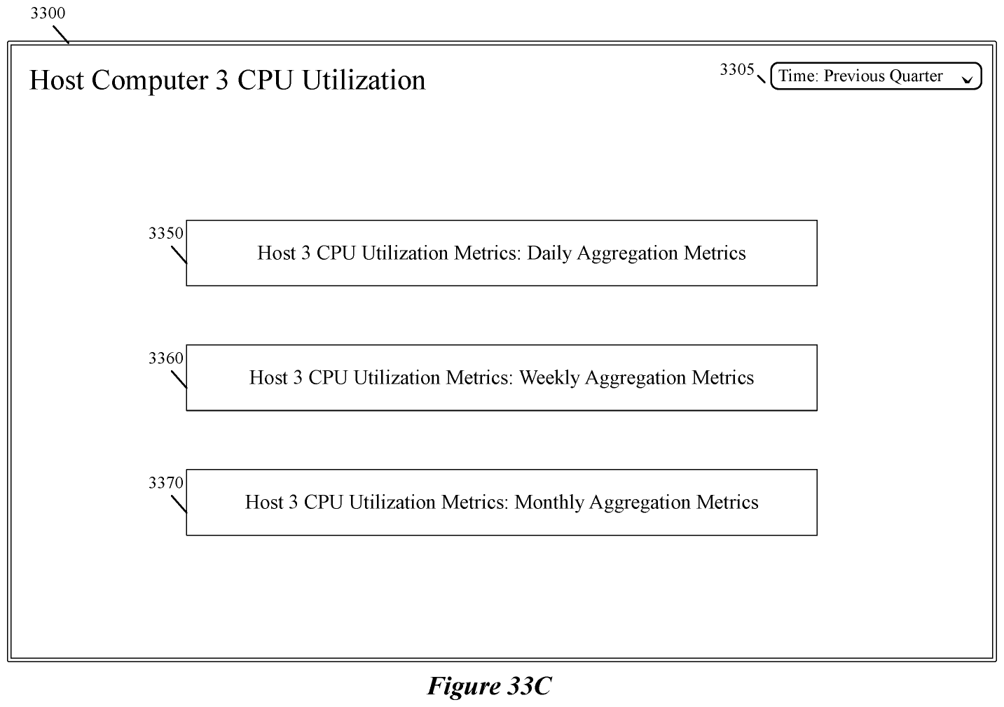

In some embodiments, a UI presents one selectable control for each presented set of aggregated metrics. FIGS. 33A-B illustrate a UI 3300 that presents various aggregation-level metrics upon user request for a specified time period. In this example, the user has used the time control 3305 to request to view all stored CPU utilization metrics for a particular host computer for the previous year. In FIG. 33A, after the user specified the time period using the time control 3305, the UI 3300 presents selectable controls 3310 and 3320 for each set of aggregated metrics currently being stored for the previous year (i.e., for the user-specified time period). Upon selection of one of the selectable controls 3310 or 3320, the UI 3300 can present the selected operational data. For example, if the user selects the control 3310, the UI 3300 will present all stored daily CPU utilization metrics for the host computer over the previous year. If the user selects the control 3320, the UI 3300 will present all stored monthly CPU utilization metrics for the host computer over the previous year.

FIG. 33B illustrates the UI 3300 after the user used selectable control 3320 to view the host computer's monthly aggregation metrics. Upon selection of this selectable control 3350, the UI 3300 removes the selectable controls 3310 and 3320 and displays a window 3330 for presenting the selected aggregated metrics. The selected monthly metrics are presented as a line 3331 plotting the monthly CPU utilization metrics for the host computer over the previous year. As shown, the UI 3300 of some embodiments presents another selectable control 3340 for returning to the previous view presenting the selectable controls 3310 and 3320 so the user can select to view other aggregation levels of the metrics. In other embodiments, the UI 3300 presents a drop down menu for the user to select which aggregation level of metrics to view. Using this drop down menu, the UI 3300 can modify the window 3330 to present any aggregation level of metrics that the user requests for the specified time period.

In some embodiments, because different aggregation granularities of metrics are stored for different periods of time, when they ser modifies the time period in the UI, the UI presents more or less selectable controls for different aggregation levels of metrics. FIG. 33C illustrates the UI 3300, and the user has used the time control 3305 to modify the time period from the previous year to the previous quarter. This time period, unlike the one-year time period, stores daily, weekly, and monthly aggregation metrics, as opposed to just weekly and monthly. Hence, for this user-specified time period, the UI 3300 displays selectable controls 3350-3370 for the user to select to view the host computer's daily, weekly, or monthly CPU utilization metrics over the previous quarter. Different embodiments can store different aggregation levels of metrics for different periods of time, which may be configured for the system or specified by a network administrator or user.

Although the above-described embodiments discuss collection operational data regarding SDN network elements (e.g., managed forwarding elements such as managed software switches and routers, or standalone switches and routers), one of ordinary skill in the art will realize that other embodiments collect operational data regarding the machines (e.g., VMs or Pods) that run on the host computers of an SDDC or the applications that operate on such machines in the SDDC.

Many of the above-described features and applications are implemented as software processes that are specified as a set of instructions recorded on a computer readable storage medium (also referred to as computer readable medium). When these instructions are executed by one or more processing unit(s) (e.g., one or more processors, cores of processors, or other processing units), they cause the processing unit(s) to perform the actions indicated in the instructions. Examples of computer readable media include, but are not limited to, CD-ROMs, flash drives, RAM chips, hard drives, EPROMs, etc. The computer readable media does not include carrier waves and electronic signals passing wirelessly or over wired connections.

In this specification, the term “software” is meant to include firmware residing in read-only memory or applications stored in magnetic storage, which can be read into memory for processing by a processor. Also, in some embodiments, multiple software inventions can be implemented as sub-parts of a larger program while remaining distinct software inventions. In some embodiments, multiple software inventions can also be implemented as separate programs. Finally, any combination of separate programs that together implement a software invention described here is within the scope of the invention. In some embodiments, the software programs, when installed to operate on one or more electronic systems, define one or more specific machine implementations that execute and perform the operations of the software programs.

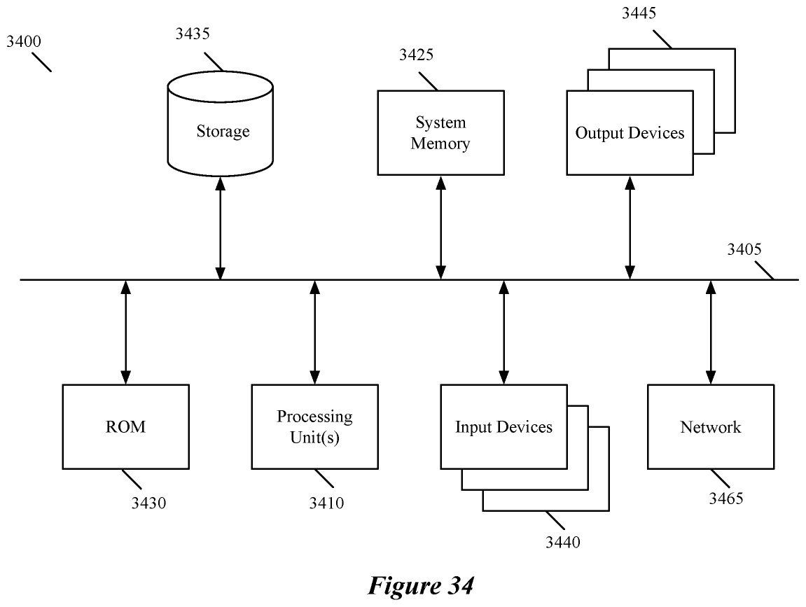

FIG. 34 conceptually illustrates a computer system 3400 with which some embodiments of the invention are implemented. The computer system 3400 can be used to implement any of the above-described computers and servers. As such, it can be used to execute any of the above described processes. This computer system includes various types of non-transitory machine readable media and interfaces for various other types of machine readable media. Computer system 3400 includes a bus 3405, processing unit(s) 3410, a system memory 3425, a read-only memory 3430, a permanent storage device 3435, input devices 3440, and output devices 3445.

The bus 3405 collectively represents all system, peripheral, and chipset buses that communicatively connect the numerous internal devices of the computer system 3400. For instance, the bus 3405 communicatively connects the processing unit(s) 3410 with the read-only memory 3430, the system memory 3425, and the permanent storage device 3435.

From these various memory units, the processing unit(s) 3410 retrieve instructions to execute and data to process in order to execute the processes of the invention. The processing unit(s) may be a single processor or a multi-core processor in different embodiments. The read-only-memory (ROM) 3430 stores static data and instructions that are needed by the processing unit(s) 3410 and other modules of the computer system. The permanent storage device 3435, on the other hand, is a read-and-write memory device. This device is a non-volatile memory unit that stores instructions and data even when the computer system 3400 is off. Some embodiments of the invention use a mass-storage device (such as a magnetic or optical disk and its corresponding disk drive) as the permanent storage device 3435.

Other embodiments use a removable storage device (such as a flash drive, etc.) as the permanent storage device. Like the permanent storage device 3435, the system memory 3425 is a read-and-write memory device. However, unlike storage device 3435, the system memory is a volatile read-and-write memory, such a random access memory. The system memory stores some of the instructions and data that the processor needs at runtime. In some embodiments, the invention's processes are stored in the system memory 3425, the permanent storage device 3435, and/or the read-only memory 3430. From these various memory units, the processing unit(s) 3410 retrieve instructions to execute and data to process in order to execute the processes of some embodiments.

The bus 3405 also connects to the input and output devices 3440 and 3445. The input devices enable the user to communicate information and select commands to the computer system. The input devices 3440 include alphanumeric keyboards and pointing devices (also called “cursor control devices”). The output devices 3445 display images generated by the computer system. The output devices include printers and display devices, such as cathode ray tubes (CRT) or liquid crystal displays (LCD). Some embodiments include devices such as a touchscreen that function as both input and output devices.

Finally, as shown in FIG. 34, bus 3405 also couples computer system 3400 to a network 3465 through a network adapter (not shown). In this manner, the computer can be a part of a network of computers (such as a local area network (“LAN”), a wide area network (“WAN”), or an Intranet, or a network of networks, such as the Internet. Any or all components of computer system 3400 may be used in conjunction with the invention.

Some embodiments include electronic components, such as microprocessors, storage and memory that store computer program instructions in a machine-readable or computer-readable medium (alternatively referred to as computer-readable storage media, machine-readable media, or machine-readable storage media). Some examples of such computer-readable media include RAM, ROM, read-only compact discs (CD-ROM), recordable compact discs (CD-R), rewritable compact discs (CD-RW), read-only digital versatile discs (e.g., DVD-ROM, dual-layer DVD-ROM), a variety of recordable/rewritable DVDs (e.g., DVD-RAM, DVD-RW, DVD+RW, etc.), flash memory (e.g., SD cards, mini-SD cards, micro-SD cards, etc.), magnetic and/or solid state hard drives, read-only and recordable Blu-Ray® discs, ultra-density optical discs, and any other optical or magnetic media. The computer-readable media may store a computer program that is executable by at least one processing unit and includes sets of instructions for performing various operations. Examples of computer programs or computer code include machine code, such as is produced by a compiler, and files including higher-level code that are executed by a computer, an electronic component, or a microprocessor using an interpreter.

While the above discussion primarily refers to microprocessor or multi-core processors that execute software, some embodiments are performed by one or more integrated circuits, such as application specific integrated circuits (ASICs) or field programmable gate arrays (FPGAs). In some embodiments, such integrated circuits execute instructions that are stored on the circuit itself.

As used in this specification, the terms “computer”, “server”, “processor”, and “memory” all refer to electronic or other technological devices. These terms exclude people or groups of people. For the purposes of the specification, the terms display or displaying means displaying on an electronic device. As used in this specification, the terms “computer readable medium,” “computer readable media,” and “machine readable medium” are entirely restricted to tangible, physical objects that store information in a form that is readable by a computer. These terms exclude any wireless signals, wired download signals, and any other ephemeral or transitory signals.

While the invention has been described with reference to numerous specific details, one of ordinary skill in the art will recognize that the invention can be embodied in other specific forms without departing from the spirit of the invention. In addition, a number of the figures (including FIGS. 5, 7, 8, 11, 12, 15, 20, 24, 25, 26, and 29) conceptually illustrate processes. The specific operations of these processes may not be performed in the exact order shown and described. The specific operations may not be performed in one continuous series of operations, and different specific operations may be performed in different embodiments. Furthermore, the process could be implemented using several sub-processes, or as part of a larger macro process. Thus, one of ordinary skill in the art would understand that the invention is not to be limited by the foregoing illustrative details, but rather is to be defined by the appended claims.

1. A method of presenting operational data collected from a plurality of network elements in a software-defined network (SDN), the method comprising:
at an operational data aggregator of the SDN:
receiving a first request to view metric data for a first time period prior to a current time;
presenting a first plurality of sets of aggregated metrics created for the first time period;
receiving a second request to view metric data for a second time period prior to the current time;
presenting a second plurality of sets of aggregated metrics created for the second time period,
wherein the first plurality of sets of aggregated metrics has at least one aggregated metric set that is at a different aggregation granularity than all other sets of aggregated metrics in the second plurality of sets of aggregated metrics.

2. The method of claim 1, wherein before the receiving and presentation operations, presenting a set of one or more time controls in a user interface (UI) to allow a user to specify a time period for which the user requests to view the metric data.

3. The method of claim 2, wherein presenting the first plurality of sets of aggregated metrics comprises presenting the first plurality of sets of aggregated metrics after the user specifies the first time period using the set of time controls.

4. The method of claim 2, wherein presenting the second plurality of sets of aggregated metrics comprises presenting the second plurality of sets of aggregated metrics after the user specifies the second time period using the set of time controls.

5. The method of claim 1, wherein presenting the first plurality of sets of aggregated metrics comprises first presenting one selectable control for each set of aggregated metrics in the first plurality of sets of aggregated metrics, wherein a user's selection of any particular selectable control for any particular set of aggregated metrics in the first plurality of sets of aggregated metrics results in presenting operational data for the particular set of aggregated metrics.

6. The method of claim 1, wherein the first and second requests are received successively, and the first and second time periods are defined by reference to current times at which the first and second requests are received.

7. The method of claim 6, wherein:
the first and second requests are received within one hour of each other,
the first time period specifies a one month period from the current time at which the first request is received, and the second time period specifies a one week period from the current time at which the second request is received.

8. The method of claim 1, wherein the operational data aggregator of the SDN comprises (i) a metrics query server for receiving the first and second requests and presenting the first and second pluralities of sets of aggregated metrics, and (ii) a set of one or more metrics managers for creating different sets of aggregated metrics based on each other and based on raw metric data collected for the plurality of network elements in the SDN.

9. The method of claim 8, wherein the raw metric data is collected by a set of one or more metrics collectors operating on at least one of host computers and edge devices in the SDN.

10. The method of claim 9, wherein at least a subset of the raw metric data is collected periodically such that for a first metric type for a particular network element, a new raw metric of the first metric type is collected by a particular metrics collector for the particular network element at regular intervals.

11. The method of claim 10, wherein for a second metric type for the particular network element, the particular metrics collector receives a new raw metric of the second metric type each time the second metric type for the particular network element changes in value.

12. The method of claim 11, wherein the particular network element is a particular edge device of the SDN, and the particular metrics collector operates on the particular edge device to collect the raw metric data associated with the particular edge device.

13. The method of claim 1, wherein the first and second pluralities of sets of aggregated metrics are stored in a time-series database (TSDB) such that different sets of aggregated metrics aggregated at different aggregation granularities are stored in the TSDB for different lengths of time according to their aggregation granularity.

14. The method of claim 13, wherein at least a subset of the first and second sets of aggregated metrics is aggregated from collected raw metric data, and the raw metric data is stored in a volatile memory separate from the TSDB.

15. The method of claim 1, wherein different sets of aggregated metrics in the first and second pluralities of sets of aggregated metrics are stored in different time-series databases (TSDBs) according to their aggregation granularity.

16. A non-transitory machine readable medium storing a program for execution by at least one processing unit for presenting operational data collected from a plurality of network elements in a software defined network (SDN), the program comprising sets of instructions for:
at an operational data aggregator of the SDN:
receiving a first request to view metric data for a first time period prior to a current time;
presenting a first plurality of sets of aggregated metrics created for the first time period;
receiving a second request to view metric data for a second time period prior to the current time;
presenting a second plurality of sets of aggregated metrics created for the second time period,
wherein the first plurality of sets of aggregated metrics has at least one aggregated metric set that is at a different aggregation granularity than all other sets of aggregated metrics in the second plurality of sets of aggregated metrics.

17. The non-transitory machine readable medium of claim 16, wherein before the receiving and presentation operations, the program comprises a set of instructions for presenting a set of one or more time controls in a user interface (UI) to allow a user to specify a time period for which the user requests to view the metric data.

18. The non-transitory machine readable medium of claim 16, wherein the set of instructions for presenting the first plurality of sets of aggregated metrics comprises a set of instructions for first presenting one selectable control for each set of aggregated metrics in the first plurality of sets of aggregated metrics, wherein a user's selection of any particular selectable control for any particular set of aggregated metrics in the first plurality of sets of aggregated metrics results in presenting operational data for the particular set of aggregated metrics.

19. The non-transitory machine readable medium of claim 16, wherein the first and second requests are received successively, and the first and second time periods are defined by reference to current times at which the first and second requests are received.

20. The non-transitory machine readable medium of claim 16, wherein the first and second pluralities of sets of aggregated metrics are stored in a time-series database (TSDB) such that different sets of aggregated metrics aggregated at different aggregation granularities are stored in the TSDB for different lengths of time according to their aggregation granularity.
